(19) United States
(12) Patent Application Publication
(10) Pub. No.: US 2009/0176034 A1
(43) Pub. Date: Jul. 9, 2009

(54) Surface Treatment Technique and Surface Treatment Apparatus Associated With Ablation Technology

(75) Inventors: Jari Ruuttu, Billnas (FI); Reijo Lappalainen, Hiltulanlahti (FI); Vesa Myllymaki, Helsinki (FI); Lasse Pulli, Helsinki (FI); Juha Makitalo, Tammisaari (FI)

Correspondence Address: BIRCH STEWART KOLASCH & BIRCH, PO BOX 747, FALLS CHURCH, VA, 22040-0747, US

(73) Assignee: Picodeon Ltd. Oy, Helsinki (FI)

(21) Appl. No.: 12/224,286

(22) PCT Filed: Feb. 23, 2007
(86) PCT No.: PCT/FI2007/000045

§ 371 Date: Feb. 10, 2009

(30) Foreign Application Priority Data
Feb. 23, 2006 (FI) 20060182

(51) Int. Cl. B05D 3/06; C23F 1/08; B44C 1/22; B28B 17/00

(52) U.S. Cl. 427/566; 156/345.51; 264/400; 425/174.4

(57) ABSTRACT

The invention relates to a surface-treatment technique in association with ablation, a surface-treatment apparatus and a turbine scanner. The invention also relates to a method of producing a coating, a radiation transmission line, a copying unit and a printing unit. The invention further relates to an arrangement for adjusting the radiation power of a radiation source in a radiation transmission line and a laser apparatus.

### FIELD OF THE INVENTION

The invention relates in general to ablation technology in association with surface treatment. In particular the invention relates to a surface treatment technique in the manner defined in the preamble of the independent claim directed to a surface treatment method. The invention further relates to a surface treatment apparatus in the manner defined in the preamble of the independent claim directed to a surface treatment apparatus. The invention further relates to a turbine scanner in the manner defined in the preamble of the independent claim directed to a turbine scanner. The invention further relates to a method for producing a coating, in the manner defined in the preamble of the independent claim directed to a method for producing a coating. The invention further relates to a radiation transmission line in the manner defined in the preamble of the independent claim directed to a radiation transmission line. The invention further relates to a copying unit, in the manner defined in the preamble of the independent claim directed to a copying unit. The invention further relates to a printing unit in the manner defined in the preamble of the independent claim directed to a printing unit. The invention further relates to an arrangement for controlling the radiation power of a radiation source on a radiation transmission line, in the manner defined in the preamble of the independent claim directed to the arrangement. The invention further relates to a laser apparatus in the manner defined in the preamble of the independent claim directed to the laser apparatus.

### BACKGROUND

Laser technology has advanced significantly in the recent years and now it is possible to produce fiber based semiconductor laser systems with a tolerable efficiency which can be used in cold ablation, for example.

The optical fibers in fiber lasers for transmitting the laser beam are not, however, suitable for transmitting high-power, pulse-compressed laser beams to the work spot. The fibers simply cannot withstand the transmission of the high-power pulse. One reason as to why optical fibers have been introduced in laser beam transmission is that the transmission of a laser beam from one place to another through free air space by means of mirrors to the work spot is in itself extremely difficult and fairly impossible to accomplish with precision on an industrial scale. Furthermore, impurities in the air and, on the other hand, scattering and absorption mechanisms in the component parts of the air may bring about losses in the laser power which will affect the beam power at the target in a manner difficult to predict. Naturally, laser beams propagating in free air space also pose a significant safety risk.

Competing with the fully fiber based diode pumped semiconductor laser is the lamp pumped laser source in which the laser beam is first conducted into the fiber and thence further-to the work spot. According to the information available to the applicant on the priority date of the present application these fiber based laser systems are at the moment the only way to bring about laser ablation based production on an industrial scale.

The fibers of present-day fiber lasers and, hence, the limited beam power impose limitations as to which materials can be vaporized. Aluminum as such can be vaporized using a reasonable pulse power, whereas materials more difficult to vaporize, such as copper, tungsten etc., require a pulse power considerably higher.

The same applies into situation in which new compounds were in the interest to be brought up with the same conventional techniques. Examples to be mentioned are for instance manufacturing diamond directly from carbon or alumina production straight from aluminium and oxygen via the appropriate reaction in the vapour-phase in post-laser-ablation conditions.

There are other problems, too, associated with the fiber laser technology. For example, large amounts of energy cannot be transmitted through optical fiber without the fiber melting and/or breaking or without substantial degradation of the laser beam quality as the fiber becomes deformed due to the high power transmitted.

Already a pulse energy of 10 μJ may damage the fiber if it has even the slightest structural or qualitative weaknesses. In fiber technology, especially prone to damage are the fiber optic couplers, which, for example, connect together a plurality of power sources, such as diode pumps.

The shorter the pulse, the bigger the amount of energy in it, so therefore this problem becomes more aggravated as the laser pulse gets shorter. The problem manifests itself already in nanosecond pulse lasers.

When employing novel cold-ablation, both qualitative and production rate related problems associated with coating, thin film production as well as cutting/grooving/carving etc. has been approached by focusing on increasing laser power and reducing the spot size of the laser beam on the target. However, most of the power increase was consumed to noise. The qualitative and production rate related problems were still remaining although some laser manufacturers resolved the laser power related problem. Representative samples for both coating/thin film as well as cutting/grooving/carving etc could be produced only with low with repetition rates, narrow scanning widths and with long working time beyond industrial feasibility as such, highlighted especially for large bodies.

The pulse duration decrease further to femto or even to atto-second scale makes the problem almost irresolvable. For example, in a pico-second laser system with a pulse duration of 10-15 ps the pulse energy should be 5 μJ for a 10-30 μm spot, when the total power of the laser is 100 W and the repetition rate 20 MHz. Such a fibre to withstand such a pulse is not available at the priority date of the current application according to the knowledge of the writer at the very date.

In laser ablation, which is an important field of application for the fiber laser, it is, however, quite important to achieve a maximal and optimal pulse power and pulse energy. Considering a situation where the pulse length is 15 ps and the pulse energy is 5 μJ and the total power 1000 W, the power level of the pulse is about 400,000 W (400 kW). According to the information available to the applicant on the priority date of the application, no-one has succeeded in manufacturing a fiber which would transmit even a 200-kW pulse with a 15-ps pulse length and with the pulse shape remaining optimal.

Nevertheless, if unlimited facilities are desired for plasma production from any substance available, the power level of the pulse should be freely selectable, for instance between 200 kW and 80 MW.

The problems associated with present-day fiber lasers are not, however, solely limited to the fiber, but also to the coupling of separate diode pumps by means of optical couplers in order to achieve a desired total power, the resulting beam being conducted through one single fiber to the work spot.

The applicable optical couplers also should withstand as much power as the optical fiber which carries the high power pulse to the work spot. Furthermore, the pulse shape should remain optimal in all stages of transmission of the laser beam. Optical couplers that withstand even the current power values are extremely expensive to manufacture, they have rather a poor reliability, and they constitute a part susceptible to wear, so they require periodic replacing.

The production rate is directly proportional to the repetition rate or repetition frequency. On one hand the known mirror-film scanners (galvano-scanners or back and worth wobbling type of scanners), which do their duty cycle in way characterized by their back and forth movement, the stopping of the mirror at the both ends of the duty cycle is somewhat problematic as well as the accelerating and decelerating related to the turning point and the related momentary stop, which all limit the utilizability of the mirror as scanner, but especially also to the scanning width. If the production rate were tried to be scaled up, by increasing the repetition rate, the acceleration and deceleration cause either a narrow scanning range or uneven distribution of the radiation and thus the plasma at the target when radiation hit the target via accelerating and/or decelerating mirror.

If trying to increase the coating/thin film production rate by simply increasing the pulse repetition rate, the present above mentioned known scanners direct the pulses to overlapping spot of the target area already at the low pulse repetition rates in kHz-range, in an uncontrolled way.

The same problem applies to nano-second range lasers, the problem being naturally even more severe because of the long lasting pulse with high energy. Thus, even one single nano-second range pulse erodes the target material drastically.

Prior art hardware solutions based on laser beams and ablation involve problems relating to power and quality, for example and especially in association with scanners, whereby, from the point of view of ablation, the repetition frequency cannot be raised to a level that would enable a large-scale mass production of a product of good and uniform quality. Furthermore, prior art scanners are located outside the vaporizer unit (vacuum chamber) so that the laser beam has to be directed into the vacuum chamber through an optical window which will always reduce the power to some extent.

According to the information available to the applicant, the effective power in ablation, when using equipment known at the priority date of the present application, is around 10 W. Then the repetition frequency, for instance, may be limited to only a 4-MHz chopping frequency with laser. If one attempts to increase the pulse frequency further, the scanners according to the prior art will cause a significant part of the pulses of the laser beam being directed uncontrollably onto the wall structures of the laser apparatus, and also into the ablated material in the form of plasma, having the net effect that the quality of the surface to be produced will suffer as will also the production rate and, furthermore, the radiation flux hitting the target will not be uniform enough, which may affect the structure of the plasma, which thus may, upon hitting the surface to be coated, produce a surface of uneven quality.

Then, in machining, too, where the target is a piece and/or part thereof to be machined, the surface of which is to be shaped, it easily happens that both the cutting efficiency and the quality of the cut are affected. Furthermore, there is a significant risk of spatters landing on the surfaces around the point of cut as well as on the very surface to be coated. In addition, with prior art technology, it takes time to achieve several layers with repeated surface treatment, and the quality of the end result is not necessarily uniform enough. For example, the applicant is not aware of any technology published by the priority date of the application which could be used to produce strong three-dimensional objects on a printer.

With known scanners of which the applicant is aware at the priority date of the present application the scanning speeds remain at about 3 m/s, and even then, the scanning speed is not really constant but varies during the scanning. This is because scanners according to the prior art are based on fixed turning mirrors which stop when the scanning distance has been traveled, and then move in the opposite direction, repeating the scanning procedure. Mirrors are also known which move back and forth, but these have the same problem with the non-uniformity of the movement. An ablation technique implemented with planar mirrors is disclosed in patent publications U.S. Pat. No. 6,372,103 and U.S. Pat. No. 6,063,455. Since the scanning speed is not constant, due to the acceleration, deceleration and stopping of the scanning speed, also the yield of plasma generated through vaporization at the work spot is different at different points of the target, especially at the extremities of the scanning area, because the yield and also the quality of the plasma completely depend on the scanning speed. In a sense, one could consider it as a main rule that the higher the energy level and the number of pulses per time unit, the bigger this drawback when using prior art devices. In successful ablation, matter is vaporized into atomic particles. But when there is some disturbance, target material will be released/become detached in fragments which may be several micrometers in size, which naturally affects the quality of the surface to be produced by ablation.

Since the present-day scanner speeds are low, increasing the pulse frequency would result in energy levels so high being directed onto the mirror structures that present-day mirror structures would melt/bum if the laser beam were not expanded prior to its arrival at the scanner. Therefore, a separate collecting lens arrangement is additionally needed between the scanner and the ablation target.

The operating principle of present-day scanners dictates that they have to be light. This also means that they have a relatively small mass to absorb the energy of the laser beam. This fact further adds to the melting/burning risk in present ablation applications.

In the prior art techniques, the target may not only ware out unevenly, but may also fragment easily and degrade the plasma quality. Thus, the surface to be coated with such a plasma can also suffers the detrimental effects of the plasma, as well as the fragments-flying-through-the-plasma originating anomalies in it. The surfaces as well as the cut lines may comprise fragments, plasma may be not evenly distributed to form such a coating etc. which are problematic in accuracy demanding application, but may be not experienced severly problematic, with coatings like ink, paint or decorative pigments, for instance, provided that the defects keep below the detection limit of the very application.

The present methods ware out the target in a single use so that same target is not available for a further use from the same surface again. The problem has been tackled by utilising only a virgin surface of the target, by moving target material and/or the beam spot accordingly.

In machining or work-related applications the left-overs or the debris comprising some fragments also can make the cut-line uneven and thus inappropriate, as the case could for instance in flow-control drillings. Also the surface could be formed to have a random bumpy appearance caused by the released fragments, which may be not appropriate in certain semiconductor manufacturing, for instance.

In addition, the mirror-film scanners moving back and forth generate inertial forces that load the structure it self, but also to the bearings to which the mirror is attached and/or which cause the mirror movement. Such inertia little by little may loosen the attachment of the mirror, especially if such mirror were working nearly at the extreme range of the possible operational settings, and may lead to roaming of the settings in long time scale, which may be seen from uneven repeatability of the product quality. Because of the stoppings, as well as the direction and the related velocity changes of the movement, such a mirror-film scanner has a very limited scanning width so to be used for ablation and plasma production. The effective duty cycle is relatively short to the whole cycle, although the operation is anyway quite slow. In the point of view of increasing the productivity of a system utilising mirror-film scanners, the plasma making rate is in prerequisite slow, scanning width narrow, operation unstable for long time period scales, but yield also a very high probability to get involved with unwanted particle emission in to the plasma, and consequently to the products that are involved with the plasma via the machinery and/or coating.

One problem in prior-art solutions is the scanning width. These solutions use line scanning in mirror film scanners whereby, theoretically, one could think that it is possible to achieve a nominal scan line width of about 70 mm, but in practice the scanning width may problematically remain even around 30 mm, whereby the fringe regions of the scanning area may be left non-uniform in quality and/or different from the central regions. Scanning widths this small also contribute to the fact that the use of present-day laser equipment in surface treatment applications for large and wide objects is industrially unfeasible or technically impossible to implement.

FIG. 18 illustrates a situation in accordance with the prior art, where the laser beam is out of focus and the resulting plasma thus has rather a low quality. The plasma which is released may also contain fragments 116 of the target. At the same time, the target material to be vaporized may be damaged to such an extent that it cannot be used anymore. This situation is typical in the prior art when using a material preform 114, a target, which is too thick. In order to keep the focus optimal, the material preform 114 should move 117, z movement, in the direction of incidence of the laser beam 111 for a distance equivalent to the extent to which the material preform 114 is consumed. Unsolved is, however, the problem that even if the material preform 114 could be brought into focus, the surface structure and composition of the material preform 114 already will have changed, the extent of the change being proportional to the amount of material vaporized off the target 114.

The surface structure of a thick target according to the prior art will also change as it wears. For instance, if the target is a compound or an alloy, it is easy to see the problem.

In arrangements according to the prior art, a change in the focus of the laser beam in the middle of ablation, relative to the material to be vaporized, will immediately affect the quality of the plasma, because the energy density of the pulse on the surface of the material will (normally) decrease, whereby vaporization/generation of plasma is no longer complete. This results in low-energy plasma and unnecessarily large amounts of fragments/particles as well as a change in the surface morphology, and possible changes in the adhesion of the coating and/or coating thickness.

Attempts have been made to alleviate the problem by adjusting the focus. When in equipment according to the prior art the repetition frequency of the laser pulses is low, say below 200 kHz, and the scanning speed only 3 m/s or less, the speed of change of the intensity of plasma is low, whereby the equipment has time to react to the change of the intensity of plasma by adjusting the focus. A so-called real-time plasma intensity measurement system can be used when a) the quality of the surface and its uniformity are of no importance or b) when the scanning speed is low.

Then, according to the information available to the applicant at the priority date of the present application, it is not possible to produce high-quality plasma using prior-art technology. Thus quite many coatings cannot be manufactured as high-quality products in accordance with the prior art.

Systems according to the prior art include complex adjustment systems which must be used in them. In current known methods the material preform is usually in the form of a thick bar or sheet. A zoom focusing lens must be used or the material preform must be moved toward the laser beam as the material preform gets consumed. Even an attempt to implement this is already extremely difficult and expensive, if at all possible in a manner sufficiently reliable, and even then the quality varies greatly, whereby precise control is almost impossible, the manufacture of a thick preform is expensive and so on.

As publication U.S. Pat. No. 6,372,103 B1 teaches, current technology can direct the laser pulse to the ablation target only as either predominately S polarized or, alternatively, predominately P polarized or circularly polarized light, and not as random polarized light.

### GENERAL DESCRIPTION OF EMBODIMENTS OF INVENTION

An object of the invention is to introduce a surface treatment apparatus by means of which it is possible to solve the problems associated with the prior art or at least to alleviate them. Another object of the invention is to introduce a method, an apparatus and/or an arrangement for coating an object more efficiently and with a better-quality surface than can be done using prior-art technology known at the priority date of the application. Yet another object of the invention is further to introduce a three-dimensional printing unit implementable through the technology of the surface treatment apparatus for coating an object repeatedly more efficiently and with a better-quality surface than can be done using prior-art technology known at the priority date of the application. The objects relate to the objectives in the following:

A first objective of the invention is to provide at least a new method and/or related means to solve a problem how to provide available such high quality, fine, plasma practically from any target, so that the target material do not form into the plasma any particulate fragments either at all, i.e. the plasma is pure plasma, or the fragments, if exist, are rare and at least smaller in size than the ablation depth to which the plasma is generated by ablation from said target.

A second objective of the invention is to provide at least a new method and/or related means to solve a problem how, by releasing such fine plasma, to produce a fine cut-path in for such a cold-work method, that removes material from the target to said ablation depth, so that the target to be cold-worked accordingly keeps without any particulate fragments either at all, or the fragments if exist, are rare and at least smaller in size than the ablation depth to which the plasma is generated by ablation from said target.

A third objective of the invention is to provide at least a new method and/or related means to solve how to coat a substrate area to be coated with the fine plasma without particulate fragments either at all or without fragments larger in size than the ablation depth to which the plasma is generated by ablation from said target, i.e. to coat substrates with pure plasma originating to practically any material.

A fourth objective of the invention is to provide a good adhesion of the coating to the substrate by said fine plasma, so that wasting the kinetic energy to particulate fragments is suppressed by limiting the existence of the particulate fragments or their size smaller than said ablation depth. Simultaneously, the particulate fragments because of their lacking existence in significant manner, they do not form cool surfaces that could influence on the homogeneity of the plasma plume via nucleation and condensation related phenomena. In addition, in accordance with the fourth objective, the radiation energy in the ablation event is transformed to the kinetic energy of the plasma effectively by minimizing the heat affected zone by using preferrably short pulses of the radiation pulses, i.e. in the picosecond range or shorter pulses in time duration, with a pitch between two successive pulses.

A fifth objective of the invention is to provide at least a new method and/or related means to solve a problem how to provide a broad scanning width simultaneously with fine plasma and high quality and broad coating width even for large bodies in industrial manner.

A sixth objective of the invention is to provide at least a new method and/or related means to solve a problem how to provide a high repetition rate to be used to provide industrial scale applications in accordance with at least one of the objectives of the invention mentioned above.

A seventh objective of the invention is to provide at least a new method and/or related means to solve a problem how to provide fine plasma for coating of surfaces to manufacture products according to at least one of the objectives from the first to sixth, but still save target material to be used in the coating phases producing same quality coatings/thin films where needed.

An further objective of the invention is to use such method and means according to said at least one of the first, second, third, fourth and/or fifth objectives to solve a problem how to cold-work and/or coat surfaces for such products of each type in accordance with the objects.

The objects of the invention are achieved by a radiation-based surface treatment apparatus which includes in its radiation transmission line a turbine. scanner according to an embodiment of the invention.

Then, using the surface treatment apparatus according to the invention, the removal of material from the surface treated and/or the yield for coating can be raised to a level required by high-quality coating, yet with sufficient speed and without unreasonably limiting the power of the radiation used.

A surface treatment method according to the invention is characterized in that which is presented in the characterizing part of the independent claim directed thereto. A surface treatment apparatus according to the invention is characterized in that which is presented in the characterizing part of the independent claim directed thereto. A turbine scanner according to the invention is characterized in that which is presented in the characterizing part of the independent claim directed thereto. A coating fabrication method according to the invention is characterized in that which is presented in the characterizing part of the independent claim directed thereto. A printer unit according to the invention is characterized in that which is presented in the characterizing part of the independent claim directed thereto. A copying unit according to the invention is characterized in that which is presented in the characterizing part of the independent claim directed thereto. The use of the method according to the invention is characterized in that which is presented in the characterizing part of the independent claim directed thereto. An arrangement according to the invention for controlling the radiation power of a radiation source in a radiation transmission line is characterized in that which is presented in the characterizing part of the independent claim directed to the arrangement.

Other embodiments of the invention are also presented in the light of examples given in dependent claims. Embodiments of the invention can be combined where applicable.

Embodiments of the invention can be used to make products and/or coatings where the materials of the product can be chosen rather freely. For example, semiconductor diamond can be produced, but in a manner of mass production, very large amounts, with low cost, good repeatability and in high quality.

In a group of embodiments of the invention the surface treatment is based on laser ablation, whereby it is possible to use almost any laser source as a source of radiation for the beam to transmitted in a radiation transmission line along which there is a turbine scanner. Applicable are then such laser sources as CW, solid-state, and pulse laser systems; with picosecond, femtosecond, and aftosecond pulses, the last three of which represent lasers used in the so-called cold ablation methods. The source of radiation is not, however, limited in the embodiments of the invention.

Let it be clarified that below, atom level plasma also means a gas at least partly in an ionized state which may also contain parts of an atom still containing electrons bonded to the nucleus through electrical forces. So, once-ionized neon, for example, could be considered atom level plasma. Naturally, also particle groups comprised of electrons and pure nuclei as such, separated from each other, are counted as plasma. Pure good plasma thus contains only gas, atom level plasma and/or plasma, but not solid fragments, for instance.

Let it be noted about using pulses in pulsed laser deposition (PLD) applications that the longer the laser pulse in PLD, the lower the plasma energy level and atom speeds of the matter vaporized from the target as the pulse hits the target. Conversely, the shorter the pulse, the higher the energy level of the vaporized matter and the atom speeds in the jet of matter. On the other hand this also means that the plasma obtained in the vaporization is more uniform and homogeneous, without precipitations and/or condensation products, such as fragments, clusters, micro- or macro-particles, of the solid or liquid phase. In other words, the shorter the pulse and the higher the repetition frequency, provided that the ablation threshold of the material to be vaporized is exceeded, the better the quality of the plasma produced.

The effective depth of the heat pulse from a laser pulse hitting the surface of a material varies considerably between laser systems. This affected area is called the heat affected zone (HAZ). The HAZ is substantially determined by the power and duration of the laser pulse. For example, a nanosecond pulse laser system typically produces pulse powers of about 5 MJ or more, whereas a picosecond laser system produces pulse powers of 1 to 10 μJ. If the repetition frequency is the same, it is obvious that the HAZ of the pulse produced by the nanosecond laser system, with a power of over 1000 times higher, is significantly deeper than that of the picosecond pulse. Furthermore, a significantly thinner ablated layer has a direct effect on the size of particles potentially coming loose from the surface, which is an advantage in so-called cold ablation methods. Nano-sized particles usually will not cause major deposition damages, mainly holes when they hit the substrate. In an embodiment of the invention, fragments in the solid (also liquid, if present) phase are picked out by means of an electric field. This can be achieved using a collecting electric field and, on the other hand, keeping the target electrically charged so that fragments moving with a lower electrical mobility can be directed away from the plasma in the plasma plume.

At the priority date of the present application the applicant is not aware of any other method for producing atomic matter plasma for use in surface treatment and/or deposition according to an embodiment of the invention, than the cold ablation laser method, such as the pico-, femto-, and aftosecond laser system. In embodiments of the invention it is possible to have a turbine scanner in the radiation transmission line, thus achieving a uniform scanning direction and speed and, thereby, controlled ablation at the work spot of the target. According to an embodiment of the invention, it is possible to use, if necessary, additional and/or alternative auxiliary techniques, such as DC or RF plasma discharge etc., in order to produce ionized matter of a certain type.

An apparatus according to the invention includes a radiation source, radiation from which is transmitted along a transmission line to be used in surface treatment, which may mean removal of a surface layer and/or growth of a surface layer, whereby it is possible to use, for example, the said radiation for ablating the material to be ablated from the target, and the radiation transmission line to transmit the radiation from the radiation source to the target. In a group of embodiments of the invention there are also means for controlling the matter released from the target, arranged for using the said matter for the coating of a substrate. A scanner is used in the radiation transmission line according to the invention so that the radiation transmission line could withstand the optical powers used in ablation, for instance, whereby the scanner is advantageously a turbine scanner. Such a moving scanner can withstand very high pulse powers without being damaged, facilitating in practice almost an unlimited increase in radiation power.

As was mentioned earlier, the operating principle of present-day scanners dictates that they have to be light. So, they have a relatively small mass into which energy from the laser beam can become absorbed. As mentioned, in turbine scanners according to the invention the energy of the laser beam is absorbed in a larger area because of the high speed of the turbine scanner. Furthermore, the rotating movement facilitates easy cooling of the structure. Also of special importance is the fact that the mass of the mirrors in turbine scanners according to the invention need not be limited. Therefore, the energy absorbed from the laser beams is distributed into a larger mass which further reduces the burning/melting risk for the mirrors.

A scanner according to the invention can be positioned inside the vaporization chamber so that the laser beam directed through the scanner need not be taken to the target via atmospheric air which would degrade it. Such an arrangement according to the invention also avoids the power losses caused by the laser beam being scanned into the vaporization chamber through an optical window. Since the turbine scanner according to the invention has a high speed and uniform velocity, there is, in an embodiment of the invention, no need to expand the laser beam prior to its arrival at the scanner because of the risk of burning/melting to the scanner mirror structures. Unlike in the prior art, in an embodiment of the invention the laser beam can be directed efficiently and without any separate beam expanders straight to the turbine scanner and thence further without a beam expander (collecting lens) to the ablation target.

The apparatus here discussed may include one scanner, advantageously a turbine scanner, or a plurality of them. Turbine scanners as such are commercially available, and currently have a typical speed of about 5000 m/s. According to an embodiment of the invention the rotational frequency of the turbine scanner is about 300,000 revolutions per minute (rpm), but according to another embodiment it is over 400,000 rpm. Apparatuses according to the invention in its particularly advantageous embodiments use a photon laser as their radiation source. In practice, radiation from any laser, suitably pumped and/or pulsed, can be used in an apparatus according to the invention, for example to achieve cold ablation.

The turbine scanner of the invention makes it possible to take the scanning width to an industrially acceptable level. For wide materials or 3D structures to be coated the scanning width may be up to one meter, advantageously from 4 cm to 70 cm, and preferably from 10 cm to 30 cm.

The radiation source for radiation to be transmitted can be implemented using e.g. a radiation source including one or more diode pumped photon lasers the laser beam of which is directed through an optical (from the point of view of the photon energy, without being limited to the visible light) beam expander to the scanner and from there through correcting optics to the work spot. The laser beam may also be a lamp pumped or almost any other laser beam. In an alternative embodiment, however, the radiation need not necessarily be based on laser, but particle jets with sufficient energy can be used, for example.

In the apparatus, the work spot of the target is advantageously a vaporizable material. No limitations are here imposed on the vaporizable material, nor on the material to be coated or on the 3D material to be produced. Such materials may be easily vaporized materials such as organic compounds or materials, or metals vaporized at low temperatures such as aluminum or silicon, for example. The invention also facilitates the ablation of substances and materials which vaporize at high temperatures and have a very low vapor pressure at room temperature. These include several metals and metal alloys and carbon, for example, the vapor of which can be used to fabricate diamonds, for instance. The quality of diamond fabricated from carbon can be controlled, and it can be fabricated in the form of diamond-like carbon (DLC) which is still relatively soft, it can be fabricated into a high-quality coating or 3D material having a high sp3/sp2 ratio, C—Ta, or monocrystalline diamond surface or 3D material. The diamond surface or 3D product fabricated can be dyed with a desired color by adding in the ablated material a certain color-giving element or compound, for example. In some embodiments of the invention the quality of the diamond surface or 3D product fabricated can be controlled by choosing the ablated carbon material on the basis of the structural requirements of the product fabricated. In prior-art solutions the ablated carbon is usually in the form of graphite. In some embodiments of the invention the carbon to be vaporized may be sintered or, more advantageously, pyrolytic carbon. Pyrolytic carbon (pyrolytically treated carbon) is an especially advantageous alternative when manufacturing monocrystalline diamond e.g. as a semiconductor in an embodiment of the invention or as a diamond jewel in another embodiment.

In yet another embodiment of the invention the carbon material is ablated such that the resulting carbon-based material has a structure such that it can be used in fuel cell solutions. One such material is, for example, graphite that has a structure as perfect as possible. The fuel to be stored can be hydrogen or acetylene, for example.

The substance to be vaporized may also be a synthetic carbon-containing polymer, such as polysiloxane, a natural polymer, such as chitin, or a semi-synthetic natural polymer, such as chitosan. It may also be any other carbon compound, such as e.g. carbonitride (C₃N₄) or a compound thereof.

The vaporized material may also be stone or ceramic. Thus it is possible to produce stone-surface solutions with controllable thickness and weight to be used in construction, decoration, and utility articles, for example. Since such structures are very light, these products make it possible to use stone-surface products also in places where it would not be possible either technically or from the point of view or energy efficiency, for instance. In consumer products, stone-surface products can now be introduced in areas where one is not accustomed to see them. Such areas are, for example, stone-surface shells for telecommunications devices, stone-surface furniture, and cladding solutions for various vehicles.

So, the compounds to be ablated may be a single substance or compound, or be comprised of a plurality of substances or compounds. Ablation can also be done in such a gaseous atmosphere that the material ablated reacts with substance(s) or compound(s) brought into the gaseous atmosphere. In an embodiment of the invention a metal oxide is ablated to produce a metal oxide surface or 3D structure, whereas in another embodiment of the invention a metal is ablated in gas phase (advantageously noble gas) containing oxygen in order to produce the metal oxide surface or 3D structure.

According to the invention it is possible to use a plurality of work spots and targets. This facilitates the fabrication of completely new substances yet unknown. Substances can be fabricated as such or they can be used to coat different surfaces once or several times. In embodiments of the invention, especially in embodiments associated with the printing unit, the number of deposition layers is not limited. However, here are some examples of products according to the invention.

Surfaces and/or 3D materials having various functions can be produced in accordance with the invention. Such surfaces include e.g. very hard and scratch-resistant surfaces and 3D materials in various glass and plastic products (lenses, monitor shields, windows in vehicles and buildings, glassware in laboratories and households); various metal products and their surfaces, such as shell structures for telecommunication devices, roofing sheets, decoration and construction panels, linings, and window frames; kitchen sinks, faucets, ovens, coins, jewels, tools and parts thereof; engines of automobiles and other vehicles and parts thereof, metal cladding in automobiles and other vehicles, and painted metal surfaces; objects with metal surfaces used in ships, boats and airplanes, aircraft turbines, and combustion engines; bearings; forks, knives, and spoons; scissors, hunting knives, rotary blades, saws, and all types of cutters with metal surfaces, screws, and nuts; metallic processing means used in chemical industry processes, such as reactors, pumps, distilling columns, containers, and frame structures having metal surfaces; piping for oil, gas, and chemicals; parts and drill bits of oil drilling equipment; pipes for transporting water; weapons and their parts, bullets, and cartridges; metallic nozzles susceptible to wear, such as papermaking machine parts susceptible to wear, e.g. parts of the coating paste spreading equipment; snow pushers, shovels, and metallic structures of playground equipment; roadside railing structures, traffic signs and posts; metal cans and vessels; surgical equipment, artificial joints, and implants; cameras and video cameras and metallic parts in electronic devices susceptible to oxidation and wear, and spacecraft and their cladding solutions resistant to friction and high temperatures.

Yet other products fabricated in accordance with the invention may include surfaces and 3D materials resistant to corrosive chemical compounds, semiconductor materials, LED materials, pigment materials and surfaces made thereof which change color according to the viewing angle, parts of laser equipment and diode pumps, such as beam expanders and the light bar in the diode pump, jewel materials, surfaces of medical products and medical products in 3D shapes, self-cleaning surfaces, various products for the construction industry such as pollution- and/or moisture-resistant and, if necessary, self-cleaning stone and ceramic materials (coated stone products and products onto which a stone surface has been deposited), dyed stone products, e.g. marble dyed green in accordance with an embodiment of the invention or self-cleaning sandstone.

According to an embodiment of the invention, such a photon radiation is used that is directed in pulsed form from its source to the ablation target via an optical path that comprises a turbine scanner which is arranged to scan said photon radiation pulses on to a spot in the ablation area on the target body. According to an embodiment of the invention the ablation depth is smaller than the spot size from which the ablation is about occur within such pulses that have duration which is essentially the same or smaller than the relaxation time of the dominating thermal energy transference mechanism of the target material, in the layer of the target area to be ablated to the ablation depth. According to an embodiment of the invention the pulse duration can be alternatively longer than said relaxation time, provided that there is another mechanism and/or an effect present in the ablation area that prevents the heat affected zone below the ablation depth to form large.

Further products fabricated according to the invention may include anti-reflective (AR) surfaces e.g. in various lens and monitor shielding solutions, coatings protective against UV radiation, and UV-active surfaces used in the cleansing of solutions or air.

In an embodiment of the invention, ablation conducted through a turbine scanner is used in material cutting applications. Such applications include, among others, silicon wafer cutting applications, cutting applications for the vehicle industry, MEMS and NEMS applications as well as other fields of application.

In an embodiment of the invention, the present laser apparatus, which advantageously includes a turbine scanner, can be used in the manufacture of nano and micro particles by ablating (vaporizing) the target material in normal or excess pressure. The quality and size of the nano and micro particles can be controlled by choosing the ablated material(s) and active compounds and/or substances possibly in the gas phase as well as the pressure conditions in accordance with the product particles being fabricated.

In an advantageous embodiment of the invention, radiation in the apparatus is transmitted and/or directed such that the vaporization of material takes place in a vacuum. In that case the surface treatment apparatus is part of a vacuum vaporization apparatus. The vacuum vaporization apparatus is described in the examples of this application. In an advantageous embodiment of the invention both the diode pump(s), scanner(s), correcting optic unit(s) and the material(s) to be vaporized all belong to the vacuum vaporization apparatus. In another advantageous embodiment of the invention the diode pump(s) are located outside the vacuum vaporization apparatus, whereas the scanner(s) and correcting optics and the materials to be vaporized are inside the vacuum vaporization apparatus. Further, in an advantageous embodiment of the invention both the diode pumps and scanner(s) are located outside the vacuum vaporization apparatus, whereas the correcting optics and the materials to be vaporized are inside the vacuum vaporization apparatus. In yet another advantageous embodiment of the invention both the diode pumps and the scanner(s) and the correcting optics are located outside the vacuum vaporization apparatus, whereas the materials to be vaporized are inside the vacuum vaporization apparatus.

The optical beam expander (or alternatively compressor) connected to the diode pump may be integrated in the diode pump. In another embodiment of the invention the optical beam expander is connected to the diode pump through a power fiber. Here, a beam expander refers to a means that alters a form of a bundle of rays arriving to it from narrow into wider along the direction of propagation of the beam, but also to a divider according to an embodiment of the invention which divides a beam in a waveguide means into multiple parts. A beam compressor refers to a means which can be used to perform, on a bundle of rays, operations which are the reverse of those of the beam expander.

In a surface treatment apparatus according to the invention the radiation source is not solely limited to visible light, but other forms of photon radiation can also be used as laser radiation to achieve ablation. Then the waveguide in the radiation transmission line has to be appropriately dimensioned, and the structure of the mirror in the turbine scanner must be suitable for the type of radiation.

However, let it be noted that in embodiments of the invention that use radiation the wavelength of which is clearly shorter than that of UV radiation, the turbine scanner can be omitted and replaced with a direct line from the radiation source to the target. Then, a vacuum line, for example, can be used as a waveguide to transmit radiation. In an alternative embodiment of the invention, a laser based on visible light may use the vacuum of the vacuum line as a waveguide, whereby at least one turbine scanner may be omitted from the waveguide between the radiation source and target. In that case, the radiation power is limited only by the power handling capacity of the apparatus itself and/or by the tolerance for dissipation power directed to the focusing optics.

Unlike in the prior art (U.S. Pat. No. 6,372,103 B1) where the laser pulse can be directed to the ablation target only as either predominately S polarized or, alternatively, predominately P polarized or circularly polarized light, the present turbine scanner can direct the laser pulse to the ablated material in the form of random polarized light.

### LIST OF DRAWINGS

Since FIGS. 18 and 72 illustrate problems associated with the prior art, the description to follow will discuss embodiments of the invention, referring to the drawings which shall be considered as being part of the description in order to illustrate each of the embodiments. One should understand that the embodiments described are merely examples of embodiments of the invention and/or their use, and the description is not meant to limit the invention so as to pertain solely to the examples presented. Thus

FIG. 1 illustrates cold and hot ablation as such,

FIG. 2 illustrates the use of an apparatus according to an embodiment of the invention to deposit a coating on a substrate,

FIG. 3 illustrates a turbine scanner mirror in an apparatus according to an embodiment of the invention,

FIG. 4 illustrates the movement of the ablating beam achieved by each mirror in the example case of FIG. 3,

FIG. 5 illustrates an ablation deposition geometry according to an embodiment of the invention,

FIG. 6 illustrates tape feed of an ablation material according to an embodiment of the invention,

FIG. 7 illustrates an example of the working depth when using the invention to remove a surface layer,

FIG. 8 illustrates an arrangement for feeding the material to be ablated in an apparatus according to an embodiment of the invention,

FIG. 9 illustrates the use of laminae in deposition according to an embodiment of the invention,

FIG. 10 illustrates a multi-layer structure on a substrate, produced with an apparatus according to an embodiment of the invention,

FIG. 11 illustrates an example of a material flow produced by the ablating beam from the work spot in accordance with its movement,

FIG. 12 illustrates a material flow from the work spot of the target,

FIG. 13 illustrates the interdependence between yield, quality and adhesion,

FIG. 14 illustrates positioning of the radiation pulse at certain energy level in an apparatus according to an embodiment of the invention,

FIG. 15 illustrates the organization of a poor-quality ablation material in ablation,

FIG. 16 illustrates the formation of plasma in ablation in an apparatus according to an embodiment of the invention,

FIG. 17 illustrates an example of the positioning of the radiation in a coherent and monochromatic form, focused to a certain working depth, in an apparatus according to an embodiment of the invention,

FIG. 19 illustrates an example of growing monocrystalline diamond in an apparatus according to an embodiment of the invention,

FIG. 20 illustrates a detail of the embodiment of FIG. 19 in an apparatus according to an embodiment of the invention,

FIG. 21 illustrates a sample tube,

FIG. 22 illustrates a pipe structure to be coated using an apparatus according to an embodiment of the invention,

FIG. 23 illustrates the use of an embodiment of the invention to deposit a coating on a glass and/or ceramic object, such as a vessel, for example,

FIG. 24 illustrates the use of an embodiment of the invention to deposit a coating on a fine mechanical part, such as a fixed disk, for example,

FIG. 25 illustrates the use of an embodiment of the invention to deposit a coating on an optical medium, such as a DVD and/or CD disk, for example,

FIG. 26 illustrates the use of an embodiment of the invention to deposit a coating on a metal object, such as a vessel, for example,

FIG. 27 illustrates the use of an embodiment of the invention to deposit a coating on a metal object, such as an industrial vessel, for example,

FIG. 28 illustrates the use of an embodiment of the invention to deposit a coating on various substrates,

FIG. 29 illustrates the use of an embodiment of the invention to deposit a coating on a glass in a vehicle, water- and/or aircraft,

FIG. 30 illustrates the use of an embodiment of the invention to deposit a coating on a first tool or part thereof,

FIG. 31 illustrates the use of an embodiment of the invention to deposit a coating on a second tool or part thereof,

FIG. 32 illustrates the use of an embodiment of the invention to deposit a coating on a surface exposed to abrasion,

FIG. 33 illustrates the use of an embodiment of the invention to deposit a coating on a cylinder in an engine,

FIG. 34 illustrates the use of an embodiment of the invention to deposit a coating on the blades of a turbine,

FIG. 35 illustrates the use of an embodiment of the invention to deposit a coating on a part, such as a valve, in an engine,

FIG. 36 illustrates the use of an embodiment of the invention to deposit a coating on a part, especially the barrel, of a weapon,

FIG. 37 illustrates the use of an embodiment of the invention for producing a bearing surface,

FIG. 38 illustrates the use of an embodiment of the invention in water pipes,

FIG. 39 illustrates the use of an embodiment of the invention in sewer components,

FIG. 40 illustrates the use of an embodiment of the invention in kitchen fixtures, especially in the kitchen sink cover,

FIG. 41 illustrates the use of an embodiment of the invention for achieving a self-cleaning water pipe,

FIG. 42 illustrates the use of an embodiment of the invention for achieving a self-cleaning window,

FIG. 43 illustrates the use of an embodiment of the invention for coating a stone and/or ceramic surface,

FIG. 44 illustrates the use of an embodiment of the invention for coating a metallic structural element,

FIG. 45 illustrates the use of an embodiment of the invention for coating an inner structural element,

FIG. 46 illustrates the use of an embodiment of the invention for coating a lighting element,

FIG. 47 illustrates the use of an embodiment of the invention for coating and/or manufacturing a wing,

FIG. 48 illustrates the use of an embodiment of the invention for fabricating carbon fiber composite material,

FIG. 49 illustrates the use of an embodiment of the invention for coating optical elements, such as lenses, especially eyeglasses and/or protective goggles,

FIG. 50 illustrates the use of an embodiment of the invention for coating a part of a display,

FIG. 51 illustrates the use of an embodiment of the invention for coating electro-mechanical surfaces against wear,

FIG. 52 illustrates the use of an embodiment of the invention for manufacturing an aircraft hull and/or part thereof,

FIG. 53 illustrates the use of an embodiment of the invention for coating an aircraft part subject to extreme wear, such as a landing gear or part thereof,

FIG. 54 illustrates the use of an embodiment of the invention for coating a window of a craft, especially an aircraft,

FIG. 55 illustrates the use of an embodiment of the invention for producing a coating which contains a noble gas compound,

FIG. 56 illustrates a 3D printer according to an embodiment of the invention,

FIG. 57 illustrates a 3D copier according to an embodiment of the invention, and

FIG. 58 illustrates a laser apparatus according to an embodiment of the invention,

FIG. 59 illustrates embodiments of the invention for coating a stone product,

FIG. 60a illustrates a mirror in a triangular turbine scanner according to the invention,

FIG. 60b illustrates a mirror in a quadrangular turbine scanner according to the invention,

FIG. 60c illustrates a mirror in a pentagonal turbine scanner according to the invention,

FIG. 61a illustrates a mirror in a hexagonal turbine scanner according to the invention,

FIG. 61b illustrates a mirror in a heptangular turbine scanner according to the invention,

FIG. 61c illustrates a mirror in an octagonal turbine scanner according to the invention,

FIG. 62a illustrates a mirror in a nonagonal turbine scanner according to the invention,

FIG. 62b illustrates a mirror in a decagonal turbine scanner according to the invention,

FIG. 62c illustrates a mirror in an eleven-cornered turbine scanner according to the invention,

FIG. 62d illustrates a mirror in a dodecagonal turbine scanner according to the invention,

FIG. 63a illustrates a mirror in another triangular turbine scanner according to the invention,

FIG. 63b illustrates a mirror in another quadrangular turbine scanner according to the invention,

FIG. 63c illustrates a mirror in another pentagonal turbine scanner according to the invention,

FIG. 64a illustrates a mirror in another hexagonal turbine scanner according to the invention,

FIG. 64b illustrates a mirror in another heptangular turbine scanner according to the invention,

FIG. 64c illustrates a mirror in another octagonal turbine scanner according to the invention,

FIG. 65a illustrates a mirror in another nonagonal turbine scanner according to the invention,

FIG. 65b illustrates a mirror in another decagonal turbine scanner according to the invention,

FIG. 65c illustrates a mirror in another eleven-cornered turbine scanner according to the invention,

FIG. 65d illustrates a mirror in another dodecagonal turbine scanner according to the invention,

FIG. 66a illustrates a mirror in yet another triangular turbine scanner according to the invention,

FIG. 66b illustrates a mirror in yet another quadrangular turbine scanner according to the invention,

FIG. 66c illustrates a mirror in yet another pentagonal turbine scanner according to the invention,

FIG. 67a illustrates a mirror in yet another hexagonal turbine scanner according to the invention,

FIG. 67b illustrates a mirror in yet another heptangular turbine scanner according to the invention,

FIG. 67c illustrates a mirror in yet another octagonal turbine scanner according to the invention,

FIG. 68a illustrates a mirror in yet another nonagonal turbine scanner according to the invention,

FIG. 68b illustrates a mirror in yet another decagonal turbine scanner according to the invention,

FIG. 68c illustrates a mirror in yet another eleven-cornered turbine scanner according to the invention,

FIG. 68d illustrates a mirror in yet another dodecagonal turbine scanner according to the invention,

FIG. 69 illustrates beam guidance through turbine scanner 60c,

FIG. 70 illustrates beam guidance through turbine scanner 65d,

FIG. 71 illustrates beam guidance through turbine scanner 68d,

FIGS. 72 A,B,C illustrates problems relating to plasma quality in prior art,

FIG. 73 illustrate products relating to the embodiments of the invention.

### DETAILED DESCRIPTION OF A GROUP OF EMBODIMENTS OF THE INVENTION

In the description to follow, a surface should be understood to mean a surface layer having a certain layer thickness independent of the macroscopic shape of the surface, but also independent of the microscopic shape of the surface. Surface shapes and/or structures of atomic scale, substantially below 50 μm, are not regarded as surface structures in the sense in which a macroscopic observer sees the surface of a piece of paper, for example, with his/her own eyes.

In conjunction with some embodiments of the invention, surface treatment refers to the removal of a certain layer of a surface to a certain depth, but also to the growing of a surface to a certain layer thickness by means of a jet of matter. Thus a surface differs from an ideal two-dimensional surface, whereby a surface is associated with a layer thickness. A planar surface as such refers to a material planar part, of non-atomic scale, of an object limited to a certain depth in a direction perpendicular thereto, which depth usually is considerably smaller than the thickness of the object at that point, without, however, being solely limited to the said example. The surface as such may be a planar surface. The surface may also be one which is formed, as it were, by deforming a planar surface, e.g. making it curvilinear. The surface in that case may be e.g. that of a macroscopic object, but also the surface of a microscopic object, or a surface between those two, i.e. not visible to the naked eye as such, but visible in a TEM microscope.

In some embodiments of the invention, the working depth refers to a certain layer thickness, measured from the surface of the object inwards from the ideal surface of the object, at the point of a certain surface element. In embodiments of the invention where material is removed from the surface of an object e.g. by means of ablation, using a first surface-shaping jet, without being limited to certain cold or hot ablation, the layer thickness refers to that thickness of surface material, which is removed from the surface of the object by the radiation used in the ablation. Then, based on the composition and/or structure of the surface of the object, the said thickness can be determined when the wavelength and power of the radiation used in the ablation are known. A surface element refers to an area of the target at a cross-section of the ablating beam, for example, in the shape and/or size thereof. A surface element may thus be shaped as a line, an ellipse, or a circle, but also a polygon in some cases.

In an embodiment of the invention the area ablated is the work spot on the target which, in the form of a surface element, may be point-like or line-like depending on the focusing symmetry for the surface element. Thus, a beam directed to the work spot through a round lens system, for instance, may be point-like. The lens system in the radiation transmission line is not, however, meant to limit the invention. In an embodiment of the invention, focusing is realized through mirrors at least partially. Then, geometries known from reflector telescopes, such as e.g. Newton and/or Cassegrain type geometries, can be utilized in the focusing.

Let it be clarified that in practice, however, a point-like shape is not a point in the geometric sense. Namely, when a beam produced by a round lens or a combination of round lenses hits a surface, especially when the beam is focused in a tapered symmetric manner onto a certain point, the beam meets the surface in a conic section geometry so that the meeting point on the surface may thus advantageously be circular or elliptic. If the surface for which the work spot on the scale defined by the size thereof is not quite ideally in conformity with the planar surface when the ablating radiation is directed to the work spot, the work spot will be shaped according to the slightly deformed conic section surface on the scale defined by the work spot size according to the surface geometry.

In an embodiment of the invention a line-like work spot can be achieved by using in the radiation transmission line a cylindrical lens for focusing. According to an embodiment of the invention the cylindrical lens is of a type that can be cooled, so that it is possible, at least to a certain extent, to compensate for losses caused by high optical power, which losses as such may be small relative to the incoming and outgoing radiation and which are transformed into heat. The cylindrical lens may be a diamond lens which can tolerate mechanical wear, caused e.g. by the flow of a coolant, but also tolerate, without melting, higher temperatures than an ordinary glass lens. According to en embodiment of the invention, the cylindrical lens may be formed of a cylindrical part the material of which may be diamond, for instance, when the radiation used is photon radiation of infrared, UV, and/or visible light. According to an embodiment of the invention, the cylindrical part of such a cylindrical lens is formed of a shell part the function of which is to serve as a coolant container, when the coolant absorbs the losses transformed into heat caused by the passing radiation. According to an embodiment of the invention the coolant is arranged to be circulated, advantageously through a heat exchanger. According to an embodiment of the invention the coolant is liquefied gas, such as e.g. purified air, nitrogen, and/or helium.

Also in those embodiments of the invention in which material is deposited onto a surface of an object e.g. in the form of a jet of matter detached from a surface by means of an another surface-shaping jet, the working depth refers to the layer thickness produced by the jet of matter as it hits the surface. The jet of matter may originate from a phase change of a first substance in connection with ablation, for example, where the jet of matter is composed of a fast-moving group of elements of the material ablated, which elements may be plasma, protons, neutrons, electrons and/or combinations thereof formed of parts of atoms in the jet of matter. When the energy level is high enough, plasma is formed at the work spot, in which case the jet of matter is comprised of the plasma. The speeds of the jets of matter may then be on the order of 1 to 100 km/s, without, however, being solely limited to these speeds. According to an embodiment of the invention such a jet of matter moves at a speed which is 1 to 10 km/s. According to a second embodiment of the invention the jet of matter may move at 5 to 25 km/s. According to a third embodiment of the invention the speed of the jet of matter is 15 to 30 km/s. According to a fourth embodiment of the invention the speed of the jet of matter is 25 to 55 km/s, but according to a fifth embodiment it is 45 to 70 km/s. According to an embodiment of the invention the speed of the jet of matter is 85 to 110 km/s.

According to an embodiment of the invention for surface treatment, an apparatus according to the embodiment of the invention includes for surface treatment at least a source of radiation, a transmission line for the radiation from the source of radiation, at least one target and/or substrate.

Here, a radiation transmission line refers to a line comprised of a waveguide applicable in the transmission of mainly electromagnetic wave motion, but in an embodiment of the invention a transmission line also refers to a line applicable in the transmission of particles comprised of parts of an atom or combinations thereof, without taking any limiting view as regards the wave-particle dualism of the particles transmitted. Thus, a radiation propagation path which is separated by a boundary from the surroundings of the propagation path, is here counted as a transmission line. The separation is advantageously realized using a boundary which, from the point of view of radiation propagation, operates in the optical area of the radiation, unless it is specifically indicated that the radiation propagation path is something else. Furthermore, metallic, ceramic and/or other structures, such as e.g. tubular structures arranged so as to form a vacuum line waveguide, are considered to confine the transmission line in this sense.

Radiation transmitted on a radiation transmission line, or transmission line for short, according to an embodiment of the invention, may comprise various types of radiation based on photon radiation. The waveguide used in the radiation transmission line will pass the radiation through substantially loss-free. IR and/or UV laser radiation, for example, are not necessarily transmitted in the same part of the waveguide in embodiments of the invention which use two or more types of radiation. On the other hand, both types of radiation can propagate substantially loss-free on a vacuum line, for example. Radiation can then be transmitted such that there is present in the radiation transmitted radiation of several different wavelengths so that according to that particular embodiment the radiation as a whole need not be coherent and/or monochromatic.

But according to a first group of embodiments of the invention, it is also possible to transmit radiation containing one or a few monochromatic, substantially monochromatic, and/or coherent wavelength components of photon radiation. According to a first embodiment of the invention, for instance, the transmission line is arranged so as to transmit RF radiation on the transmission line. Then it is possible to use a metal pipe, for example, to define the waveguide as transmission line, and/or paraffin elements, for example, to bend the radiation. The metal pipe may be e.g. filled with gas or contain substantially a vacuum. The gas pressure may vary from conditions corresponding to a vacuum up to atmospheric pressure. Advantageously, however, below 10 atm but, more advantageously, below 3 atm.

According a second embodiment of the invention the transmission line is arranged so as to transmit photon radiation in the infrared (IR) region. According a third embodiment of the invention the transmission line is arranged so as to transmit photon radiation of visible light. According a fourth embodiment of the invention the transmission line is arranged so as to transmit photon radiation of ultraviolet (UV) light. According a fifth embodiment of the invention the transmission line is arranged so as to transmit photon radiation of X- and/or gamma radiation.

In an embodiment of the invention the waveguide of the transmission line is comprised of diamond so that it can be used as transmission line in the band formed of the IR-UV regions. In another embodiment of the invention the transmission line comprises a metal pipe part arranged so as to transmit radiation, which pipe part advantageously is a vacuum pipe at least in part, but according to an embodiment, the transmission line may use, as its medium, gas at a certain pressure, which advantageously is less than 1 atm. According to an embodiment of the invention, the metal in the pipe part is replaced by plastic, ceramic or a combination of the two. According to an embodiment-of the invention, the metal in the pipe part is replaced by a film-like diamond structure.

According to an embodiment of the invention the radiation transmission line has a diamond coating. In an embodiment of the invention the diamond coating may be doped in order to achieve electric conduction properties. In an embodiment of the invention the diamond coating contains dopants that produce magnetic properties. This way, diamond coatings can give electromagnetic properties to the transmission line. A diamond-coated radiation transmission line is especially advantageous when a high degree of purity is desired on the surface of the substrate to be coated. In that case, according to embodiments of the invention, the whole radiation transmission line can be made of diamond so that, at least for critical parts, the surfaces of transmission line parts have a diamond coating if the whole transmission line is not made of diamond, as in an embodiment of the invention.

In another embodiment of the invention, the radiation transmitted contains particles having a certain energy. These particles may be electrons, protons, or neutrons or their ionic combinations. Alternatively, in an embodiment of the invention, the particles may be mesons and/or anti-particles of those mentioned above to a limited extent as dictated by the lifetimes of the particles in question. Then advantageously a vacuum or a very thin gas, having a negative pressure advantageously equivalent of a vacuum, is used in the transmission line reserved for the particle radiation. A vacuum can also be used for the transmission of photon radiation. A technical advantage thus achieved in embodiments of the invention is that the photons and/or particles transmitted have little unwanted interaction with the medium, or the unwanted interaction can be minimized.

In an alternative embodiment of the invention a gaseous component at a certain pressure is used in the radiation transmission line in order to change the wavelength distribution of the radiation transmitted. Then it is possible to achieve, for example, absorption of a radiation component in the said gaseous component, but the radiation transmitted may also be used for the excitation of the energy states of the gaseous component to produce secondary radiation at a second wavelength. The said non-interaction does not cover interaction with constituent parts of the gas resulting from an imperfect vacuum.

In an embodiment of the invention the transmission line may be a combination of two or more transmission lines, referring mainly to a combination having a first transmission line part to transmit a first type of radiation, say, a vacuum line to transmit particle, X-, gamma, UV, IR, RF radiation, and also at least a second transmission line part to transmit a second type of radiation or visible light. For example, if a vacuum line were used for the transmission of a first laser radiation produced from the above-mentioned type of photon radiation to be used in cold ablation, a second part of the line could be used for the transmission of IR radiation e.g. in monochromatic and/or coherent form to heat the material of a spot in the target of cold ablation, in conjunction with the ablation implemented using the said first laser radiation. Then at least one part of the line of this example may be a vacuum line, but a second part may alternatively be a fiber-based line, for instance. The fiber may be an ordinary fiber, where applicable, but it may also be a diamond fiber.

The radiation transmission line, especially in the case of photon radiation, can be implemented alternatively or additionally, where applicable, using a suitable waveguide for each type of radiation transmitted. According to a first embodiment of the invention the waveguide is arranged so as to let each type of photon radiation pass through as loss-free as possible.

According to a second embodiment of the invention the waveguide additionally includes a part in which the photon radiation loss is arranged to be equivalent to the vaporization which corresponds to the chemical composition of the said waveguide part so that photon radiation can be used to vaporize a chemical substance associated with the said part of the waveguide either as vapor, particles or plasma, depending on the absorption of the vaporizing photon radiation in the said waveguide part. The waveguide may then have, where applicable, a partly non-homogeneous structure to direct ablation to a certain part of the waveguide for producing a flow of matter from the said target.

In and/or with the waveguide it is possible to use, where applicable, components that refract photon radiation, such as lenses, lattices, and/or prisms to change the direction of photon radiation and achieve possible interference. The waveguide may also include a mirror to change the direction of propagation of the photon radiation. According to an embodiment of the invention the waveguide includes at least two mirrors to direct the radiation along the transmission line provided by the waveguide. The mirror can be integrated in the vacuum part of the waveguide especially when the waveguide is a vacuum line. There may also be solid and/or liquid particles present in the vacuum as long as they do not generate a disturbing flow of matter.

According to an embodiment of the invention a turbine scanner is used with the waveguide to change the direction of radiation. Such a turbine scanner may be, in an embodiment of the invention, a polygon the faces of which are mirror surfaces. According to another embodiment of the invention, the mirror surfaces of the polygonal structure are realized using planar mirrors, but in a paddle wheel like manner by placing the mirrors at acute angles to the tangent of the perimeter of the paddle wheel.

A carrier substance for a coating according to an embodiment of the invention refers to a composition of matter which also has a certain structure. One simple non-limiting example according to an advantageous embodiment of the invention is monocrystalline diamond at its purest. A carrier substance may also be determined on the basis of the composition of the ablated material on the work spot to achieve a certain surface composition component. A dopant refers to a substance which as such belongs to the structure formed by the carrier substance, but which is brought in the carrier substance as an additive to its composition, e.g. from another source of material, which may have been implemented using a second ablation apparatus according to the invention. In an embodiment of the invention, dopants can be brought onto the substrate in the gas phase, too, so that it would combine/react with other components in the coating in order to produce the coating for the substrate.

In addition to the dopant, other characteristics of the coating can be modified using various other additives so that for some special use, the surface tension of diamond or doped diamond, for example, can be changed using the said additive.

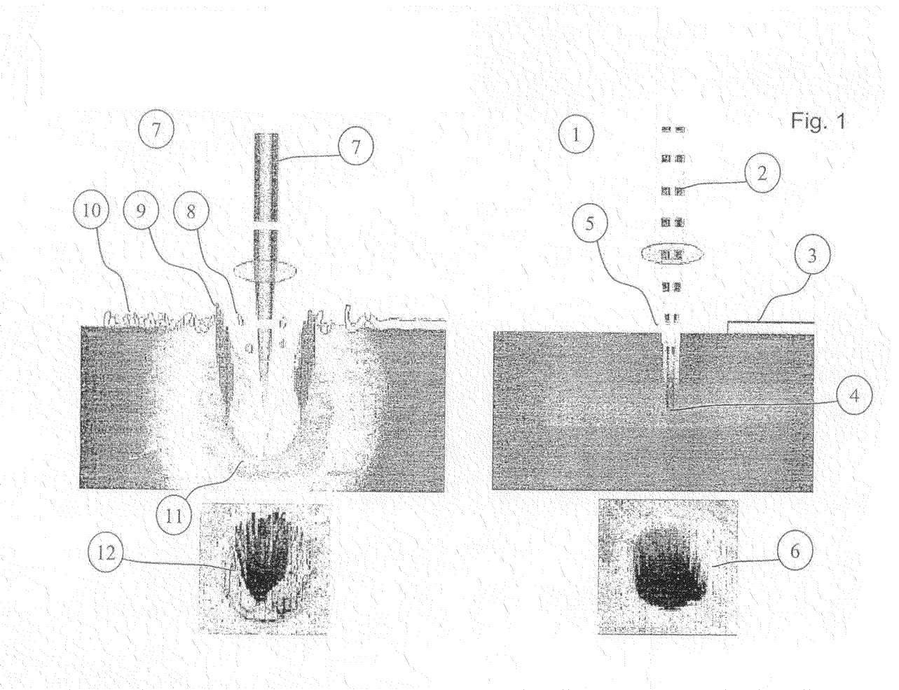

FIG. 1 schematically illustrates the advantages of a picosecond laser system (1). The laser-induced pulses (2) are so short, 1 to 40 ps, preferably 2 to 20 ps, that practically no heat transfer (4) into the material preform will occur, but almost 100% of the energy will go into vaporization, and the material preform (3) to be vaporized will not get damaged in vaporization, subject to provisions discussed later on. In addition, the quality of the plasma remains excellent and (5) hardly any particles will come loose from the fringe region. Thus an essential problem (8) can be avoided which occurs when using a long-pulse laser (7). With a long-pulse laser, the heat transfer (11) into the target is high, which substantially degrades the efficiency. In addition, the surface of the material preform (10), which serves as target, is damaged at a large area, and the wall of the crater (9) is likewise seriously damaged, with a large amount of loose particles (8) becoming detached from it when the laser beam hits it. As said earlier, these systems have substantially different heat affected zones, HAZ.

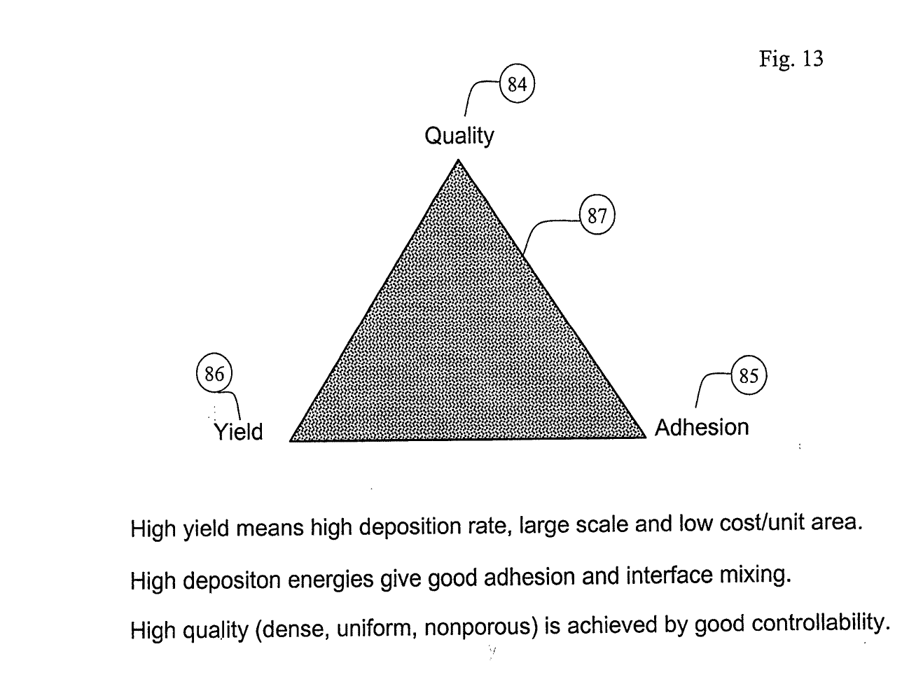

Additionally it should be noted that the energy level and composition of plasma produced by a picosecond laser are much better than those of a long-pulse laser. With a picosecond laser, the speed of atoms/ions is 15,000 to 100,000 m/s, whereas with long-pulse lasers it is less than 15,000 m/s. This is of great significance when a perfect surface is desired, as discussed earlier in conjunction with the description of FIG. 13.

FIG. 1 illustrates cold (1) and hot ablation (7). In hot ablation, the ablating beam 7 is a high-energy one, but the duration of energy produces in the material to be ablated formations at the target 11, in areas larger than the work spot, so that the structure is altered and/or damaged around the work spot, in an area 12 which is unnecessarily large. In addition, the melting matter 9 may produce formations 10 which may also include particles 8 of the broken material. Furthermore, various particles may be produced through nucleation and subsequent condensation as a result of abundant vaporization.

In cold ablation, radiation is brought as short-duration pulses 2 to the target 4 the structure of which remains intact in the neighborhood 6, except for the affected zone 5 up to the working depth of the radiation. The surface 3 formation is then uniform, on the substrate, which in FIG. 1 is numbered 3, but on the same piece as the target.

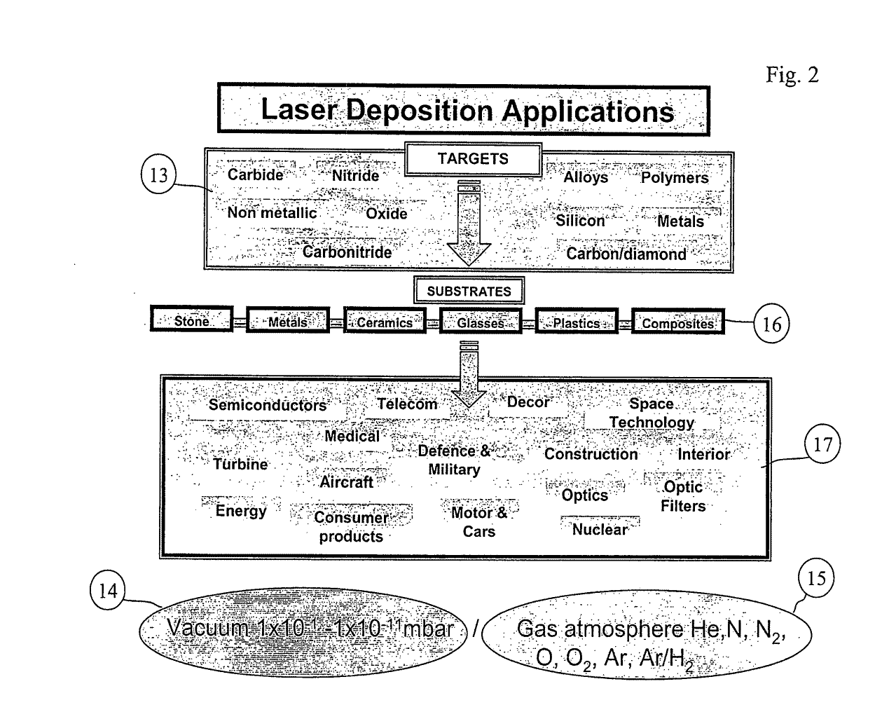

FIG. 2 illustrates the use of an apparatus according to an embodiment of the invention in cold ablation, for using various targets 13 to coat various substrates 16 for diverse uses 17 in certain conditions, say, in a vacuum 14 or additionally or alternatively in a gaseous atmosphere 15. FIG. 2 shows how the new PLD method can be used to vaporize any substance (13) on any surface or material (16), either in a vacuum (14) 0.1 torr to 10⁻¹¹ torr, (15) gaseous atmosphere or in free space.

Examples of targets 13 include metals that are pure. Metal alloys can also be used. In addition, non-metallic materials can be used as targets. Especially, it is possible to use carbides, nitrides, and/or oxides, but also fluorides, silicon, carbon, diamond, carbonitride, but also gaseous compounds, e.g. liquefied to enhance yield, including noble gases, according to an embodiment of the invention. These examples are not intended to limit out any group of substances from the set of substances that can be used as a target in an apparatus according to an embodiment of the invention.

Examples of substrate materials 16 include those composed of stone, ceramic, glass, plastic (synthetic polymer), semi-synthetic polymer, natural polymer, and/or metal. Also wood, for instance, can be coated.

Depending on the material, the said substrate materials can be used for purposes 17 which include objects ranging from the microscopic to the macroscopic scale.

The substrates may be block preforms used in the manufacture of electronics industry components, which, with suitable dopants, using e.g. diamond as carrier substance, can provide insulators, semiconductor structures and/or conductors, both electrical and thermal, as well as certain micro-mechanical switches and/or oscillators.

The said parts can be used both in low-voltage components and in power and/or high-voltage applications. In chip manufacture, both chips and electromechanical parts, semiconductors, for communications devices, can be produced. Mechanical parts which will be under intense stress can also be fabricated on macroscopic scale, say, turbine blades with a certain coating such as diamond, moving or otherwise wear-intensive parts of engines, aircraft wing and/or hull structures, space technology applications, in which it is possible to achieve especially durable structures by means of a diamond coating of sufficient strength, for example. The substrates may also be artificial joints used medically, their attaching means and/or surfaces of the said artificial joints and/or attachment joints coated with a suitable surface material, not limited here, to be used in human spare parts. A diamond coating of a suitable strength, for example, produces a durable structure for the spare part as well as rendering it such that the human body will not reject it.

In weapons technology, for instance, advantages in durability are gained by producing a diamond coating inside the barrel of a weapon. Also other parts of weapons can be diamond coated. Furthermore, projectiles and/or their parts can be either diamond coated or fabricated from diamond so that their hardness and at the same time lightness can be of advantage in applications of weapons technology where munitions have to be transported, in addition to the benefits of a high initial velocity.

A diamond coating can also be used to isolate certain parts of munitions e.g. from gases associated with its firing, but also from the oxidizing effect of air.

According to an embodiment of the invention a deposition apparatus can also be used to fabricate decorative and/or art objects as well as objects for kitchen and/or laboratory use. Also building elements, for instance, both for indoor and outdoor use and/or for support structures can be fabricated using an apparatus according to the invention. In that case it is possible to mass produce, with a certain dopant in a diamond carrier substance, for example, a certain pattern and/or tint on a surface of a piece of furniture, door, or panel. In an embodiment of the invention, diamond can be fabricated in the monocrystalline form to be used in optical fibers, thus achieving higher operating temperatures than with ordinary optical fibers according to the prior art. It is also possible to fabricate wall elements, for example, for utilizing means of diffractive optics to light whole walls and/or parts of walls by means of a light conductor surface.

In addition, where bearing surfaces are under stress because of a high rotating speed and/or loading, such as in various turbine, generator, industrial roller and other bearings, they can be coated using an apparatus according to an embodiment of the invention, e.g. with a diamond coating or even a harder coating, such as carbonitride. For example, in generators and/or blowers used in the electrical power industry, in their moving parts, also other than bearings, it is possible to use coatings fabricated with an apparatus according to an embodiment of the invention. As it is thus achieved a good efficiency for the ablated material, it is possible, where applicable, to replace copper, for instance, by a fiber according to the invention which includes, doped in a diamond carrier substance, a dopant to optimize the electrical conduction characteristics and/or to control mechanical tensions. Thus a whole generator, for example, can be made lighter as its metal parts are replaced with an inexpensive but durable mass produced solid-diamond and/or diamond-coated structure.

In addition, the coating of water and/or gas pipes, for example, from household to industrial scale, can be done using an apparatus according to an embodiment of the invention so that if diamond coating is chosen, it provides protection against corrosion, for instance. Such corrosion may be caused, to name a few examples, by chemical conditions, physical wear, and exceptional temperatures to which materials are exposed. In industry, but especially in nuclear power plants, it is thus possible to use safer pipes so that advantage will be gained e.g. in heat exchangers both in the transfer of heat but also in corrosion resistance in high temperatures.

With a correct choice of coating for an apparatus according to an embodiment of the invention to be used in automotive, aircraft and/or ship-building industry, for instance, it is possible to reduce the risk of corrosion and its disadvantages to the strength of structures, as well as to modify the appearance of visible parts.

According to an embodiment of the invention, ablation as such is arranged to take place in a vacuum 14 or in conditions substantially equivalent to it. Thus the apparatus according to an embodiment of the invention may be located in connection with the vacuum line so that the vacuum achieved may be on the order of 10⁻¹ to 10⁻¹² atm. Some applications, such as fabrication of monocrystalline diamond, advantageously take place at a pressure of 10⁻⁶ atm, for example. Some other applications, such as fabrication of nano and micro particles advantageously take place either near atmospheric pressure or in high pressure. According to an embodiment of the invention, the apparatus is arranged to operate in an orbit in order to take advantage of the vacuum and/or weightlessness found in space in the attachment of the ablated material to the crystal structure being grown.

According to an embodiment of the invention, ablation is arranged to take place in a gaseous atmosphere 15 or in conditions substantially equivalent to it. The composition of the gas may then vary depending on the coating material, but on the other hand also depending on the composition and/or its purity of the ablated material and/or of the end product to be coated/fabricated.

In an embodiment of the invention, the ablated material can be used in 3D printing. 3D printing according to the -prior art known at the priority date of the present application (e.g. brands JP-System 5 of Scroff Development Inc., Ballistic Particle Manufacturing of BPM Technology Inc., the Model Maker of Solidscape Inc., Multi Jet Modelling of 3D Systems Inc., and Z402 System of Z Corporation) utilizes materials the mechanical strength of which is relatively poor. Since an apparatus according to an embodiment of the invention achieves a high efficiency, a fast layer growth rate in a relatively cost effective manner, it is possible, e.g. by ablating carbon either in graphite form or as diamond, to make the ablated material to be conducted, e.g. according to the principle of the ink jet printer, into layers which, slice by slice, correspond to the object to be printed. Thus, when using carbon, for instance, it is possible to fabricate structures hard enough. The embodiment of the invention is not, however, limited to diamond, but other materials, too, can be used in accordance with the choice of the ablated material. Thus an apparatus according to an embodiment of the invention can be used to produce either hollow or solid objects from almost any applicable material, such as diamond or carbonitride, for instance.

Thus it would be possible, for example, to print out, slice by slice, the famous statue of David in diamond layers and then, using ablation, to smooth out potential edges between slices. The statue could be given a certain hue, even separately for each layer, if desired, by suitably doping the diamond. It would also be possible to directly print out almost any 3D piece, such as a spare part, tool, display element, shell structure or part thereof for a PDA or mobile communications device, for example.

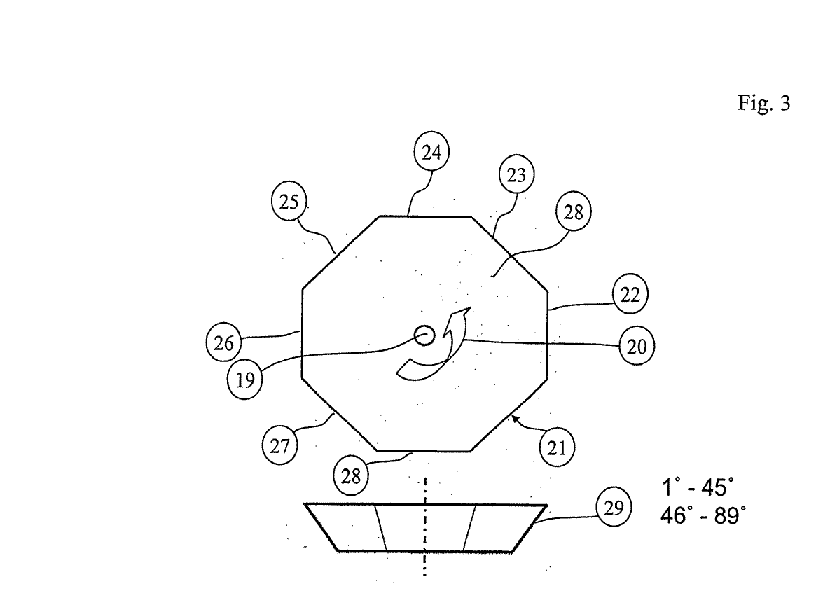

FIG. 3 illustrates a polygonal prism 21 having faces 22, 23, 24, 25, 26, 27, an 28. Arrow 20 indicates that the prism can be rotated around its axis 19, which is the symmetry axis of the prism. When the faces of the prism of FIG. 3 are mirror faces, advantageously oblique in order to achieve a scanning line, arranged such that each face in its turn will change, by means of reflection, the direction of radiation incident on the mirror surface as the prism is rotated around its axis, the prism is applicable in an apparatus according to an embodiment of the invention, in its radiation transmission line, as part of a turbine scanner.

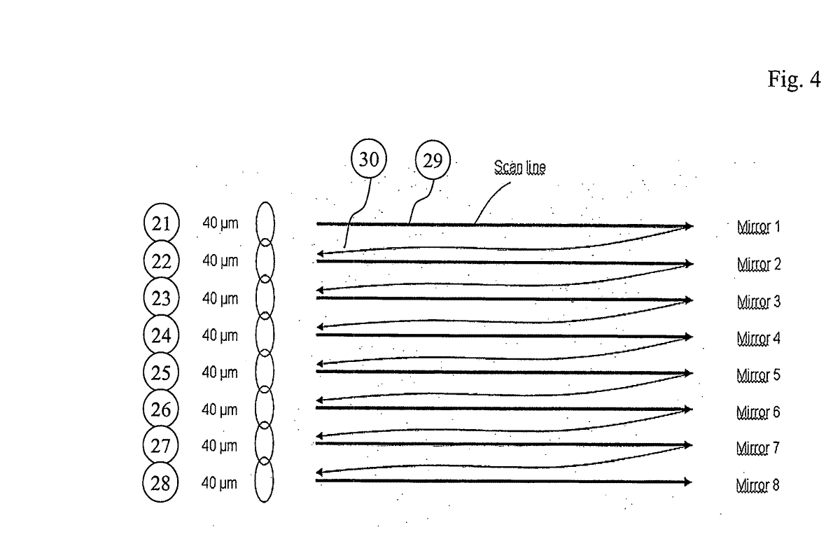

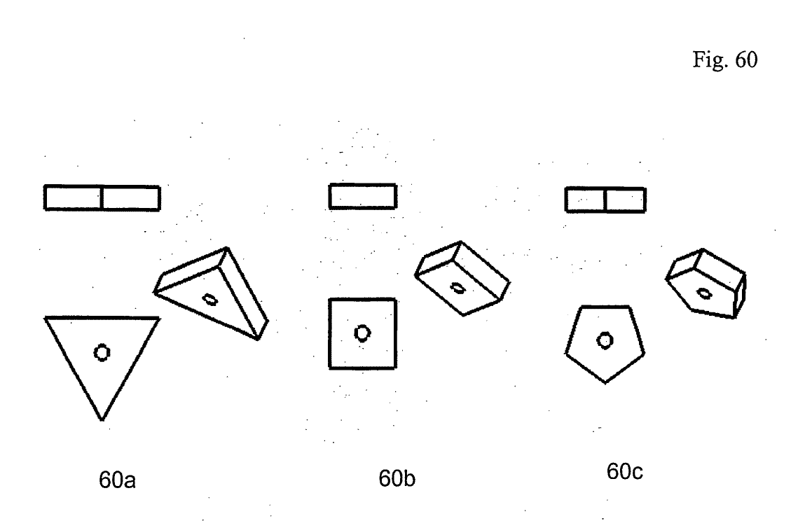

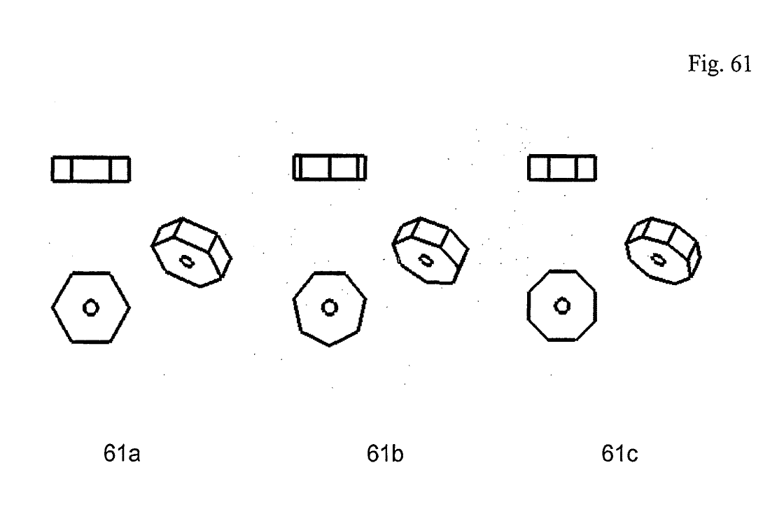

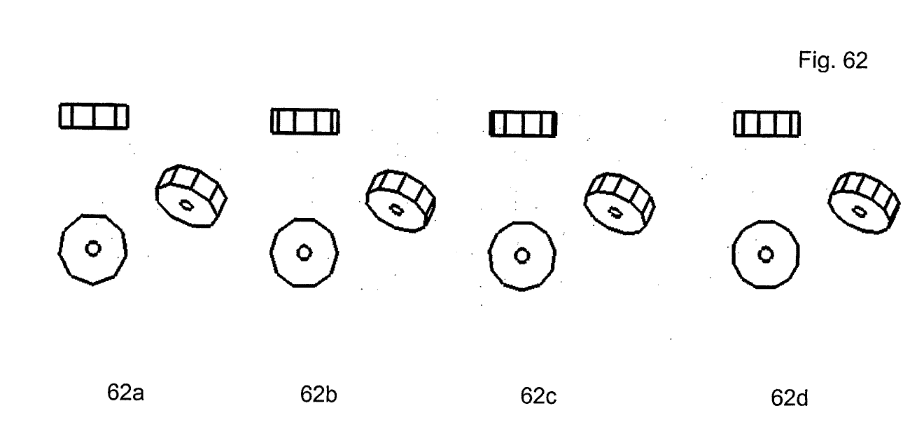

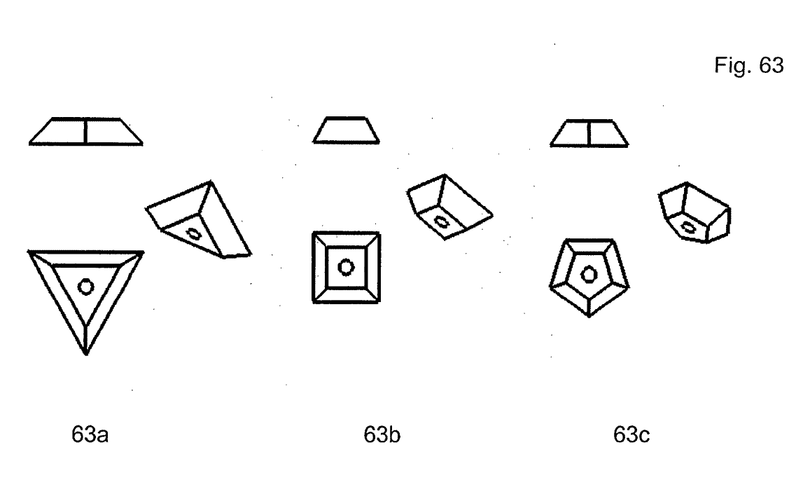

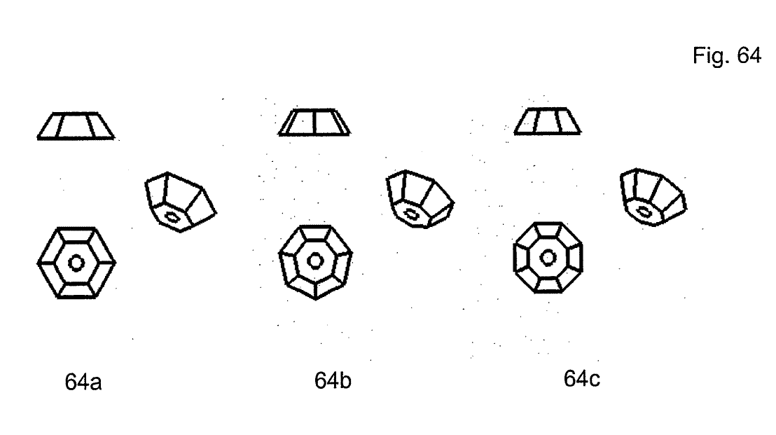

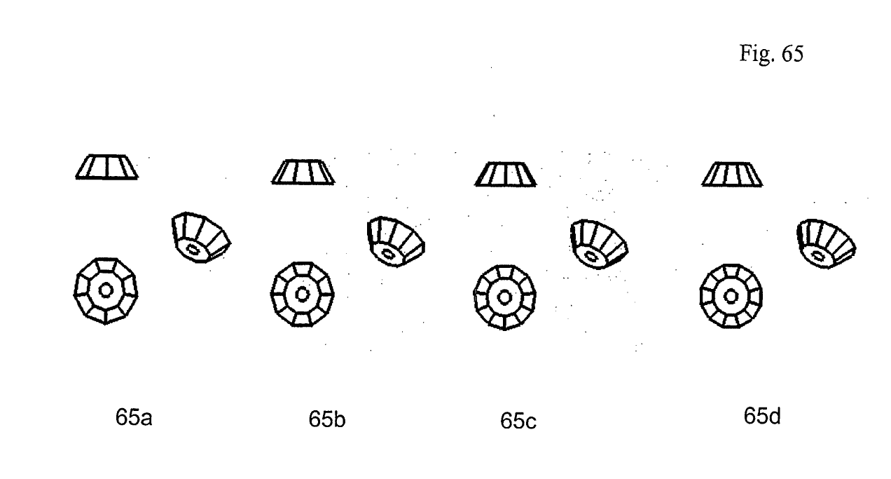

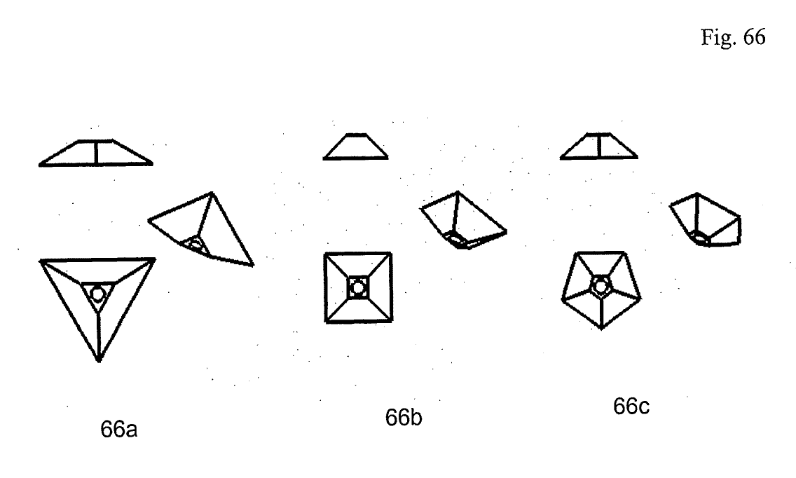

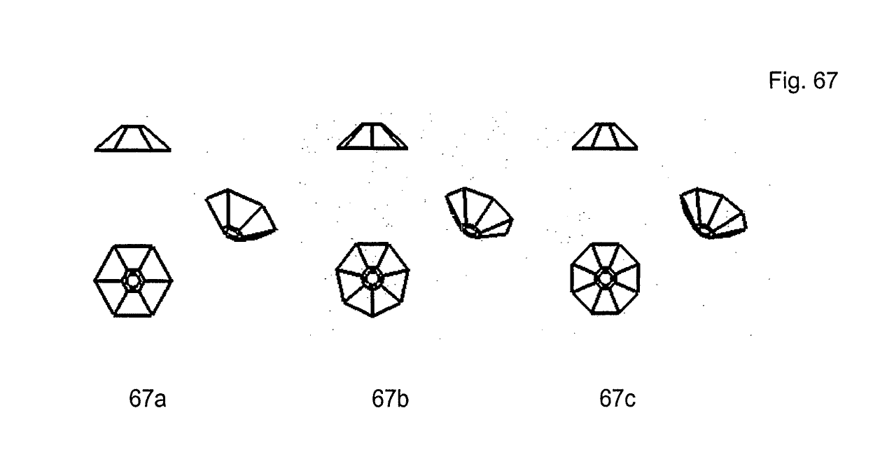

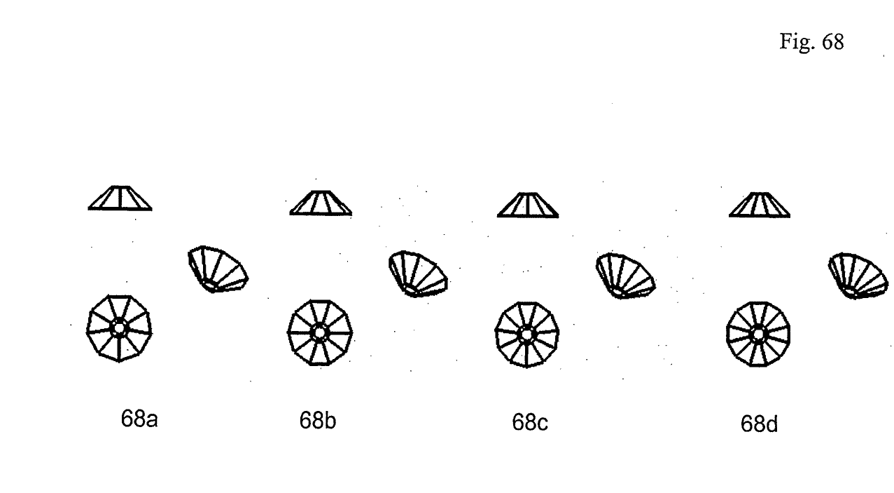

FIG. 3 shows 8 faces, but there may be considerably more faces than that, even dozens if not hundreds of them. FIG. 3 also shows that the mirrors are at the same oblique angle to the axis, but especially in an embodiment including several mirrors, the said angle may vary in steps so that the reflection of the incident radiation will hit a slightly different part of the work spot so that, by means of stepping within a certain angle range, a certain stepped shift of the work spot is achieved on the target, illustrated in FIG. 4, among other things. Also FIGS. 60 through 71 describe various turbine scanner mirror arrangements, not, however, limiting the embodiments of the turbine scanner to those.

Thus is achieved a high scanning speed and a certain repeatable order. The scanning speed may be as high as 2000 m/s, without compromising the constant nature of the scanning speed, meaning that the scanned beam will not be making stops and becoming “stuck” as in the prior art. Thus in an apparatus equipped with a turbine scanner according to an embodiment of the invention, vaporization takes place with a uniform yield.

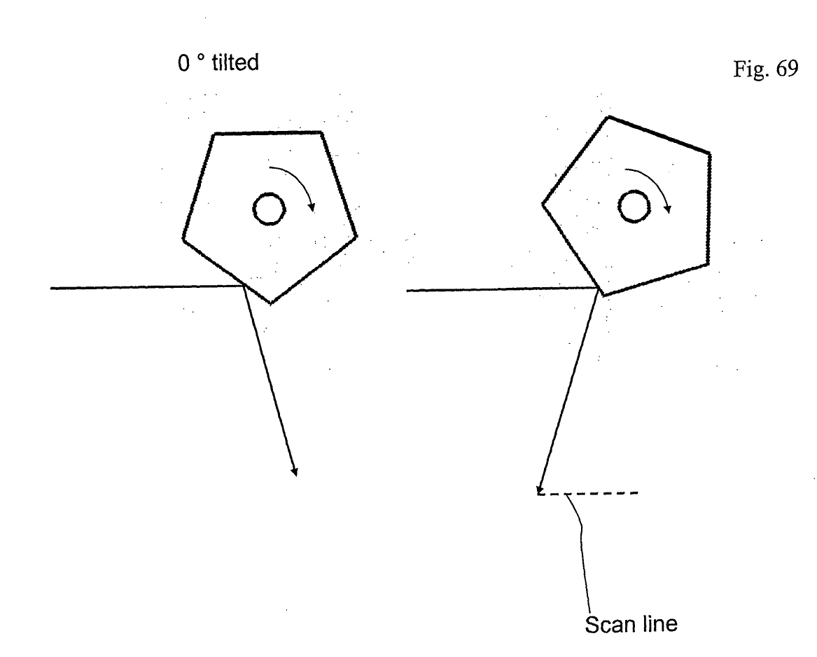

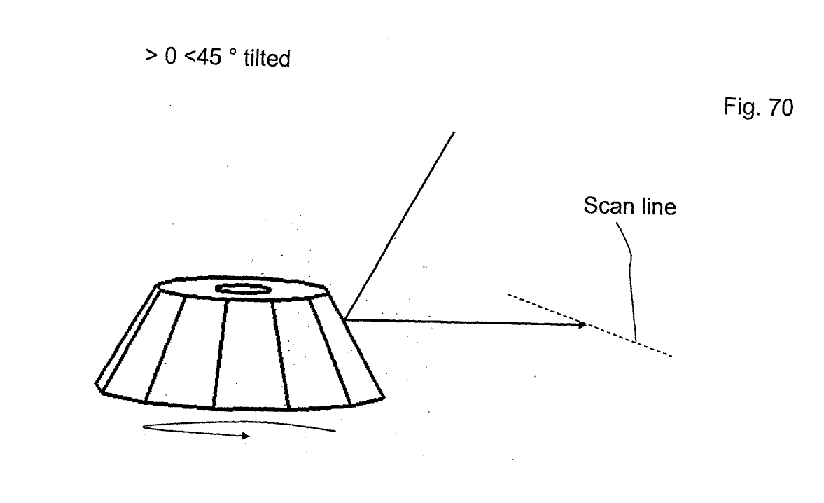

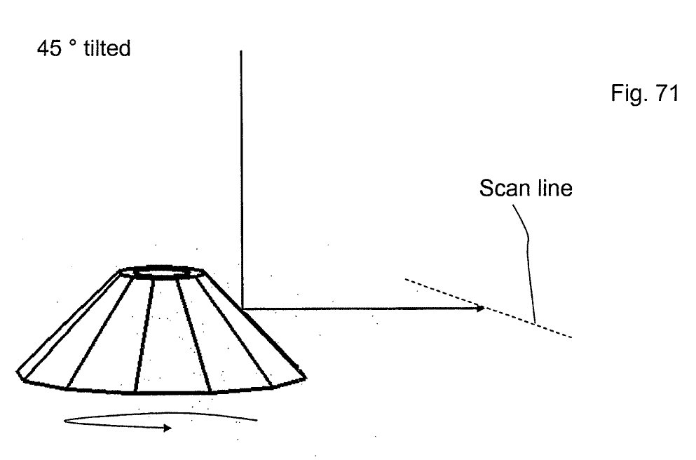

The structure of the turbine scanner, FIG. 3, includes at least 2 mirrors, preferably more than 6 mirrors, e.g. 8 mirrors (21 to 28) positioned symmetrically around the central axis 19. As the prism 21 in the turbine scanner rotates 20 around the central axis 19, the mirrors direct the radiation, a laser beam, for instance, reflected from spot 29, accurately onto the line-shaped area, always starting from one and the same direction (FIG. 4). The mirror structure of the turbine scanner may be non-tilted (FIG. 69) or tilted at a desired angle, e.g. FIGS. 70 and 71. The size and proportions of the turbine scanner can be freely chosen. In an advantageous embodiment it has a perimeter of 30 cm, diameter of 12 cm, and a height of 5 cm.

In an embodiment of the invention it is advantageous that the mirrors 21 to 28 of the turbine scanner are preferably positioned at oblique angles to the central axis 19, because then the laser beam is easily conducted into the scanner system.

In a turbine scanner according to an embodiment of the invention (FIG. 3) the mirrors 21 to 28 can deviate from each other in such a manner that during one round of rotational movement there are scanned as many line-shaped areas (FIG. 4) 29 as there are mirrors 21 to 28.

Especially in laser systems with very high repetition frequencies, such as picosecond laser systems, in which the repetition frequency is over 4 MHz, e.g. 20 MHz, and the pulse energy is over 1.5 μJ, it is advantageous to use a turbine scanner.

This way, at least two advantages are gained; first, if the repetition frequency of the laser system is high, say 29 MHz, and the pulse energy is high, e.g. over 1.5 μJ, the vaporization process at the work spot of the target from the surface element is so fast that the laser beam may go out of focus, especially if the layer of material removed is hundreds of micrometers thick. On the other hand avoided is the risk that should there be several pulses on top of each other, the ablation yield would be reduced because of crater formation and absorption of the incident laser beam by the vaporized material.

As the turbine scanner according to an embodiment of the invention can keep the focus of the ablating radiation constant, also the vaporization yield remains constant, and also the energy of the ablated material is essentially constant. A feedback system according to an embodiment of the invention can then be used to adjust e.g. the waveform and/or power of the pulse if, for some reason, changes are detected in the yield of vaporized material and, hence, in the energy of the plasma. In practice, the yield may easily be reduced to nothing unless the jet of radiation, a first surface-shaping jet, is re-focused on the surface of the worn-out source material. In addition, feedback can be used, at least theoretically, to store in memory the characteristics of every pulse.

FIG. 4 illustrates scanning by a turbine scanner shown in FIG. 3 in accordance with an embodiment of the invention, where the ablating beam shown in FIG. 3 has an effective diameter of 40 μm, and the beam is shot obliquely onto the target surface so that at the point of incidence the beam has an elliptic cross section in this example. The beam moves on the target surface along line 29 when a mirror 1 (Mirror 1) is used to reflect the ablating beam. When the mirror 21 has moved away from a position in which it no longer hits the ablated area 29 on the target, a mirror 22 (Mirror 2) has time to turn into a position in which the beam sweeps alongside line 29 in accordance with the ellipse shown in FIG. 3 and takes the next slice off the target surface, to a working depth according to the beam focus. Mirrors (FIG. 3) 23 (Mirror 3), 24 (Mirror 4), 25 (Mirror 5), 26 (Mirror 6), 27 (Mirror 7) and 28 (Mirror 8) do the same until the turbine scanner has made a full round. In the embodiment example of FIG. 4 the mirrors slightly deviate from one another with respect to the rotation axis of the turbine scanner, which achieves the changing of the ablation spot from one scanning line to the next. According to an embodiment of the invention, this deviation can also be accomplished with mechanical movement which alters the angle of each mirror in a periodic manner. In the example depicted, the direction of the ablation beam during ablation is arranged so as to be from left to right along the ablation line 29, however not excluding embodiments in which the beam moves back and forth during ablation, provided that the movement of the work spot is continuous and experiences no stops.

An apparatus/method according to an embodiment of the invention is advantageously based on a high-power picosecond laser system. Illustrated below is a laser apparatus according to an embodiment of the invention. Although certain power values are given as examples, they are just embodiment-specific examples not limiting the scope of the invention. Furthermore, the turbine scanner example is just an example, as is also the laser example, which are not intended to limit the invention to the embodiment examples presented.

### Embodiment Example of a Laser Apparatus

| | | |
|---|---|---|
| Diode pumped | A | over 10 W |
| full fiber laser | PICOSECOND LASER | adv. 20 to 1000 W |
| system | | high pulse energy |
| | | 2 to 15 μJ |
| | | repetition freq. |
| | | over 1 MHz, |
| | | advantageously |
| | | 10 to 30 MHz |

+

| | | |
|---|---|---|
| Vibration-free, fully | B | speed 0 to 4000 m/s |
| linear beam motion | TURBINE SCANNER | typically |
| velocity, withstands | | 50 to 100 m/s |
| high laser powers, can | | |
| be placed in vacuum | | |

+

| | | |
|---|---|---|
| Repeatability 100%, | C | material thickness |
| superior quality, | FILM OR LAMELLA | a) below |
| enables the use of | FEED | b) equal to or |
| high laser powers | | c) over that portion |
| | | which is inside beam |
| | | focus |

+

| | | |
|---|---|---|
| Layered structures | D | range 0.5 to 15 μJ |
| of one or several | AUTOMATIC PULSE | very fast, max. 1 μs |
| different materials | ENERGY CONTROL | pre-programmable, |
| | SYSTEM | monitoring for |
| | | quality control |

+

| | | |
|---|---|---|
| Integrated in the | E | covers whole work |
| laser system | INTEGRATED | width accuracy 1 |
| | PLASMA INTENSITY | pulse very precise |
| | MEASUREMENT | monitoring |

+

| | | |
|---|---|---|
| The shorter the wave- | F | 1064 nm, |
| length, the better | LASER WAVE- | 293 to 420 nm, |
| the efficiency | LENGTHS | 420 to 760 nm |
| | | other wavelength |

+

| | | |
|---|---|---|
| Operation according | G | Choice based on |
| to embodiment | VACUUM, GASEOUS | purity, reactivity, |
| | ATMOSPHERE, FREE | deposition speed, |
| | SPACE | and/or cost-efficiency |

A picosecond laser system (A)+turbine scanner (B)+film or lamella feed (C) together are prerequisites for an apparatus according to an embodiment of the invention being able to produce large amounts of high-quality surfaces and products, such as a monocrystalline diamond substrate or silicon substrate for the semiconductor industry (6) in a vacuum or gaseous atmosphere.

Any surface, such as metal, plastic or even paper, can be coated. In an embodiment, the thickness of the coating is no more than 5 μm, for example. In that case the semiconductor material can be bent at spots containing silicon or silicon compounds, for instance, which in turn facilitates applications of bendable electronics, for example.

Spots D, E, F, and G serve to help fabrication and, on their part, contribute to the manufacture of high-quality products on an industrial scale, in a repeatable manner, enhancing quality control.

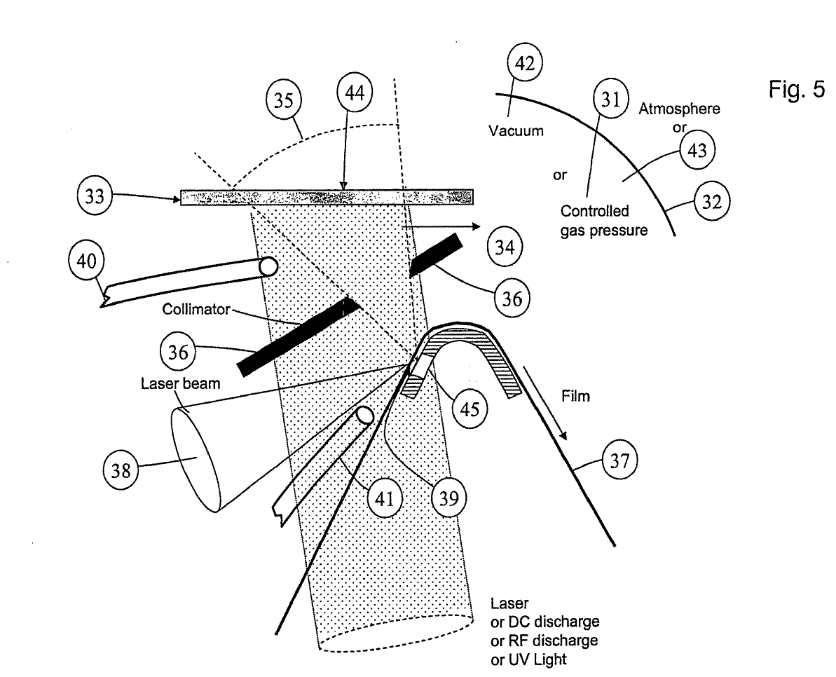

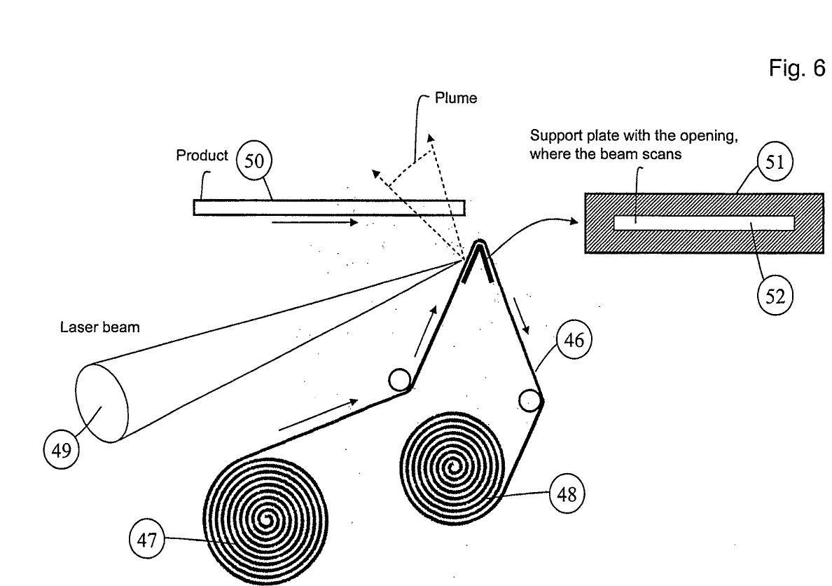

FIGS. 5 and 6 illustrate an application of a method according to an embodiment of the invention, Thus FIGS. 5 and 6 illustrate that any material to be vaporized, e.g. FIG. 2 (13), can be produced in the form of tape/foil (37, 46). The material to be vaporized which is in tape/foil form (37, 46) is wound on a feed reel (47), from which it is fed at a certain speed so that new material always arrives in the vaporization area, at the target, onto which the laser beam (49) is directed, with as little variation in the quality as possible.

FIG. 6 shows an embodiment of the invention, which is based on the foil/tape (46) of FIG. 6 being a) thinner, b) equally thin, or c) thicker than the depth of the focus of the laser beam. In case c), that part of the material which is greater (thicker) than the depth of the focus of the laser beam is collected onto a separate reel (48).

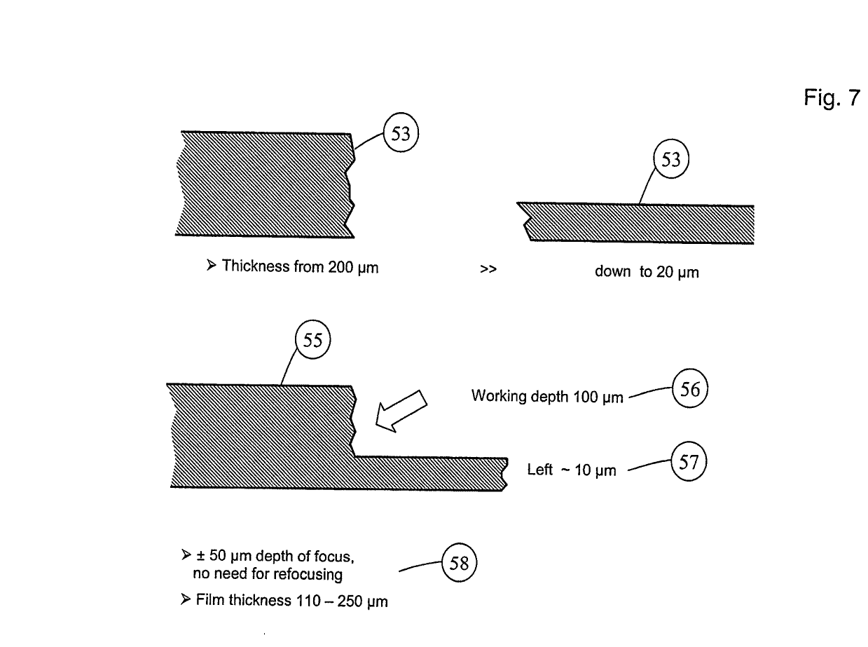

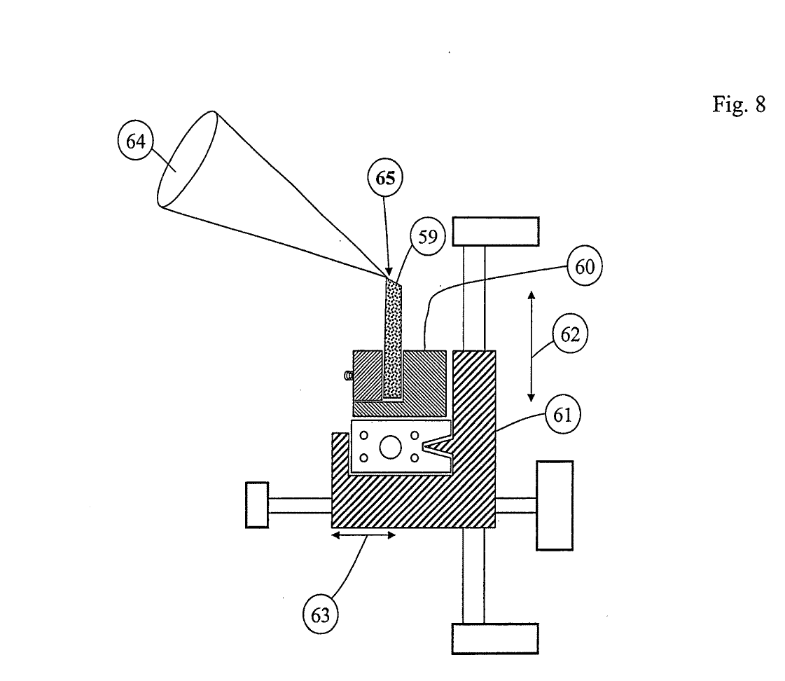

The tape/foil 53 (FIG. 7) is e.g. 200 μm thick or only 20 μm thick, for example. When a certain amount of material (56) has been consumed off the foil (55), a thin foil part (57) may remain, and it can be wound on a reel, FIG. 6 (48).

At the spot (FIG. 6) where the laser beam (49) arrives, i.e. where the vaporization process takes place, it is advantageous that there is an aperture (52) in the substrate so that no significant heat transfer into the background will occur and the vaporizing conditions remain always constant.

FIG. 6 furthermore illustrates that the above-mentioned tape feed system does not in any way change the basic function of the embodiment, i.e. the product (50) travels through a plasma cloud in the coating process just as before.

In an apparatus according to a an embodiment of the invention a film can be fed, in which case the surface topography and structure of the target has no time to substantially change when only a thin layer is vaporized and, at the starting point, there's always a new, virginal surface to be used.

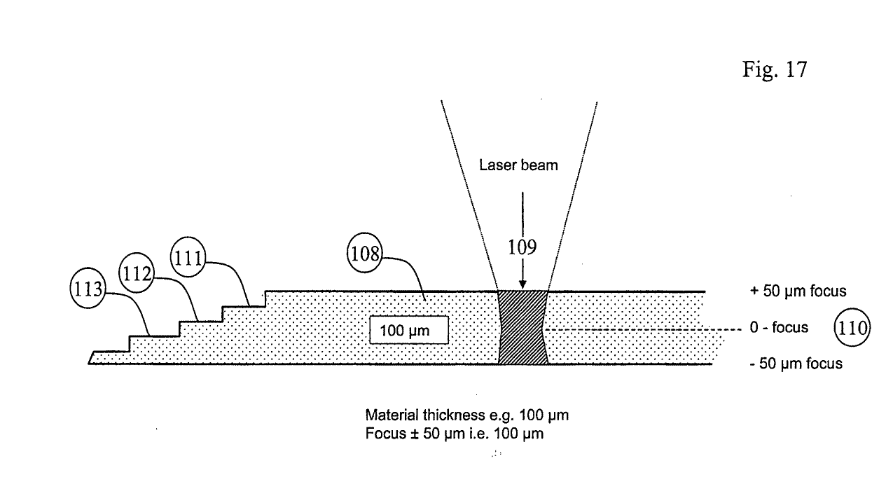

In a coating apparatus according to an embodiment of the invention there is no need for a focus adjustment mechanism, so in a foil/film vaporizing method according to an embodiment of the invention there is no need for a focus adjustment step as such. The mechanism as such is not needed when the virginal surface of the film feed serves as a target, because the foil/film stays in focus by a fixed adjustment. Only that part of the material which corresponds. to the depth of the focus of the laser beam (FIG. 17) is used of the film.

FIG. 5 illustrates a detail of the film/foil vaporizing system in an apparatus according to an embodiment of the invention, where the film/foil (37) is arranged to travel on top of a platform and the laser beam (38) has been just directed to the area (39) which has an aperture (45) in the platform to eliminate a background effect on the vaporization process especially as regards heat transmission.

A previous product (33) travels through a plasma plume (35), and limiters prevent the fringe areas of the plasma plume (35) from hitting the sample to be coated. In the fringe areas (“veil”) of the plasma, its properties are not as good as in the central jet and, furthermore, there are also more impurities from the residual gas in the fringes.

The method according to en embodiment of the invention is well suited for vaporization processes in which the material vaporized is metal or in which oxides (through oxygen) or nitrides (through nitrogen) are produced from a metal source material by means of a gas phase. According to an embodiment of the invention it is advantageous that the oxygen gas or nitrogen gas is rendered atomic and reactive in a plasma reactor (e.g. RF discharge nozzle, atomizer) so that it is highly reactive and easily combines with metal, for instance, thus advantageously producing large amounts of high-quality oxides from the metal. In the case of FIG. 5, the gas is conducted through a pipe (41) in the vicinity of the vaporized material preform (39) and/or through another pipe (40) in the vicinity of the growing thin film surface (33).

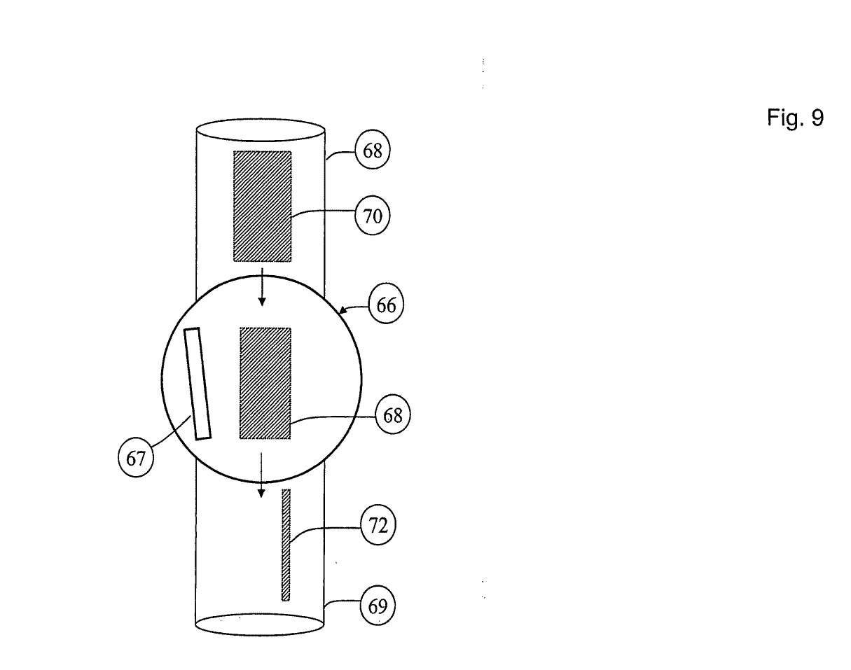

FIG. 9 relates to the use of lamellae (68) in deposition. In this case, a new lamella-like target is fed for the deposition of each new object (67). This technique is well suited for aluminum oxide ceramic plates, for example, which are nowadays routinely used for fabricating thin, small, smooth plates. Fabrication of large targets is usually laborious and expensive.

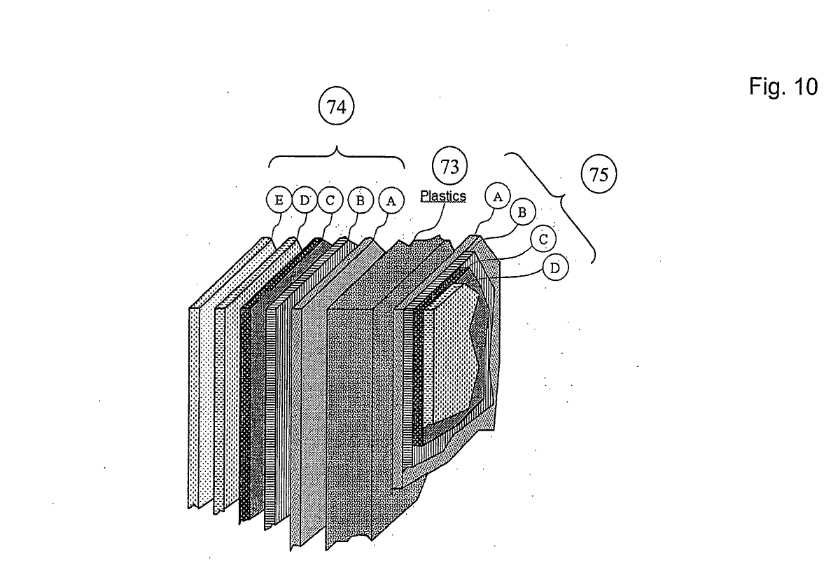

FIG. 10, which was already discussed, relates to the fact that the LPD method according to an embodiment of the invention can be used to very advantageously fabricate multilayer structures 74 and 75 A to E on top of any material (73), e.g. plastic, glass, metal or ceramic.

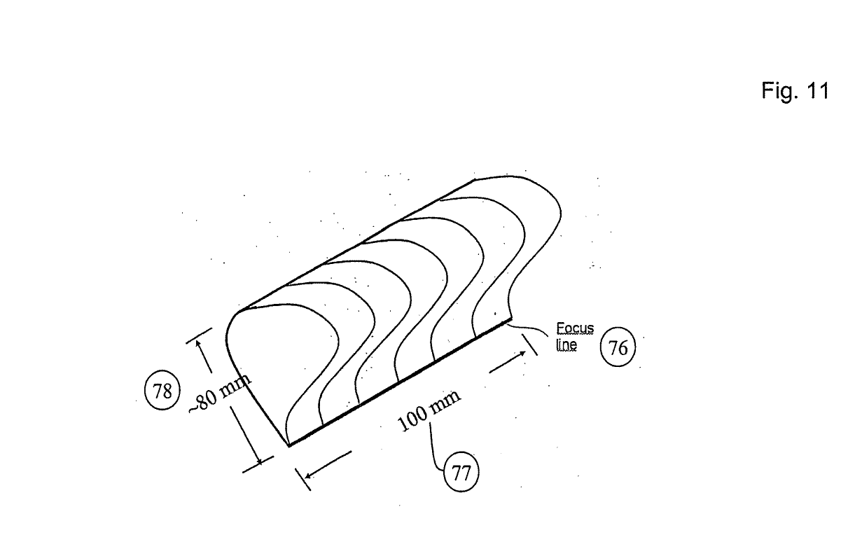

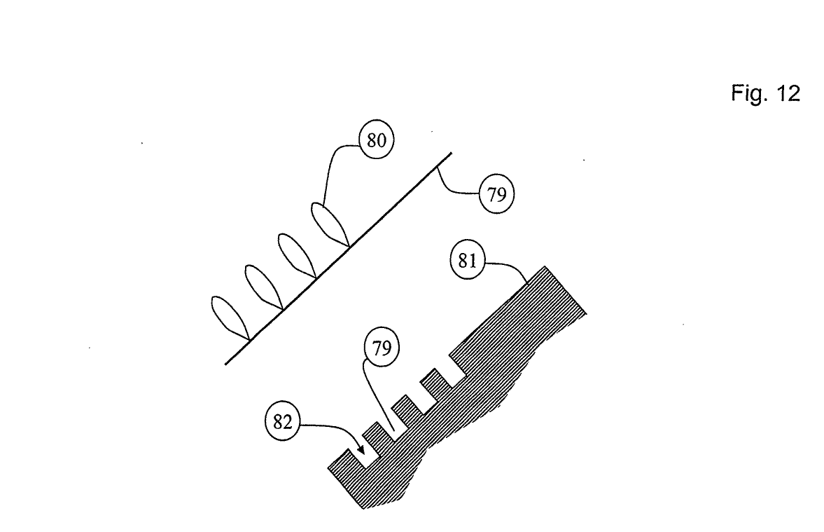

FIG. 11 shows a situation in the new method by means of which it has been produced an oblong plasma plume (77) of uniform quality with a straight and linear focusing line, where the height of the plasma plume can be adjusted with a) the work level b) the pulse energy level. To produce a wider plume front, a plurality of synchronized picosecond laser depositions units can be connected in parallel.

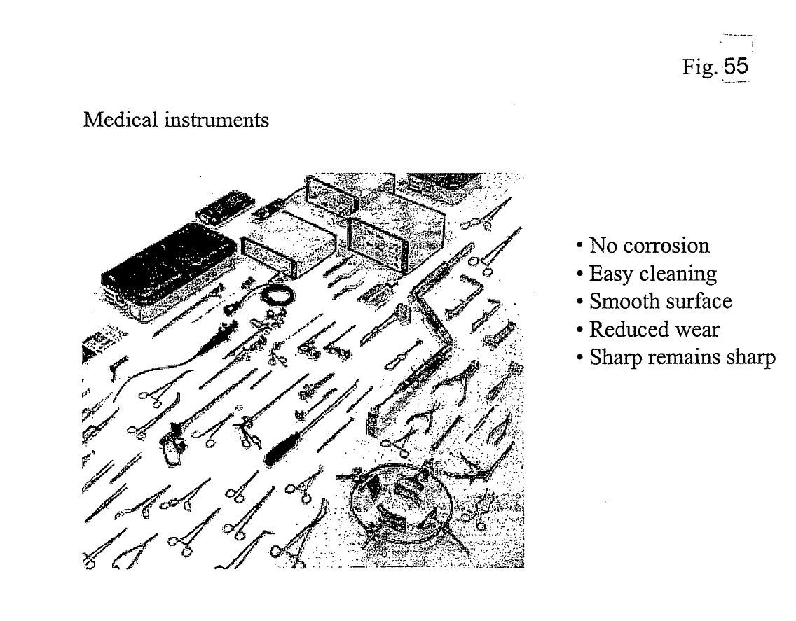

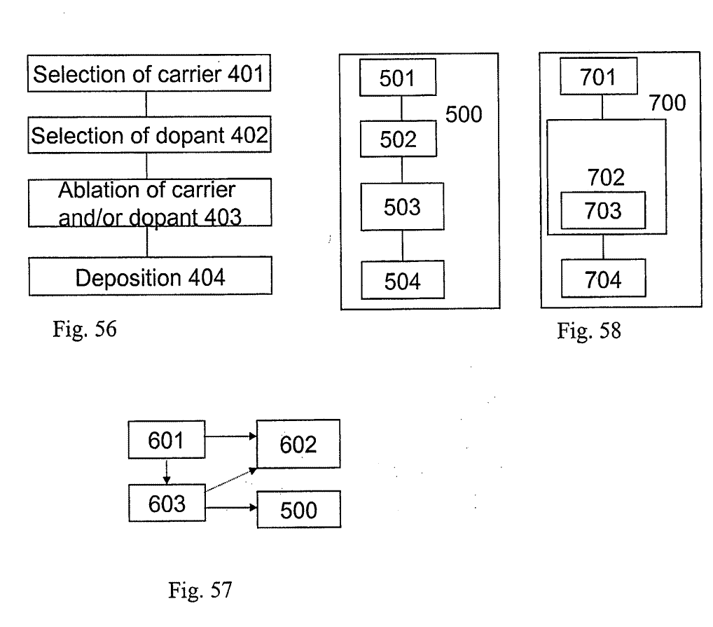

One specific application to use the film/tape feed of FIGS. 5 and 6 to produce spot-like micro-plasma is the coating of instruments (FIG. 55), bone drills, screw-cutting tools and bone screws (FIG. 56) or implants (FIG. 57). Varied shapes are typical to these applications, and a micro plasma jet can be directed in just the correct angle to the surface to be coated and, on the other hand, by suitably moving either the micro-plasma jet or the target, a sufficiently smooth surface of homogeneous quality can be produced.

In the above example the film/tape (79) may be e.g. 100 mm wide, but it is vaporized in the longitudinal direction (80) only, and the laser beam scans, only in the transverse direction, an area of sufficient width, and only the film/foil (79) moves forward.

The film/foil (79) is then in the reel form, as shown in FIG. 5. When the tape has been first longitudinally vaporized from beginning to end along the width (82) of the laser plume, the tape/foil (81) is moved e.g. to a side to such an extent that a completely new track (83) can be formed. This can be continued until the foil/film (81) is completely used up in the direction of the breadth. The essential idea of this system is that the vaporization result is always constant and of top quality because the source material remains constant.

FIGS. 10, 13, and 14 illustrate advantages of fast adjustment of pulse energy. This is described in FIGS. 10, 13, and 14. FIG. 13 shows a triangle (87) with quality (84) at one corner, adhesion (85) at another, and yield (86) at the third. Adhesion (85) is achieved through oversized pulse energies but then especially the quality (84) will mostly suffer even if the yield (86) were good. Better quality (84) is usually achieved through lower pulse energies than those (85) which give the best adhesion. On the other hand, with smaller pulse energies there's still a long way to the optimum (85) adhesion. The yield per bombardment energy used (86), in turn, depends for the most part on the focus of the laser beam being optimal and on the energy density of the pulse on the surface being optimal.

FIG. 10 illustrates a concrete example of the use of a deposition apparatus according to an embodiment of the invention, where a multilayer coating has been grown from oxides on top of a plastic work piece (as substrate), such as a display, eyeglasses, sunglasses, goggles, window glass etc. Typically, the objective is to add some additional properties to the product, such as anti-reflective (AR) properties, scratch-free (SC) surface, UV blocking, ID blocking, reflective surface or a pleasing look. It is also possible to produce photo-catalytic layers e.g. on top of a window glass, to cite one example. In an embodiment of the invention it is then possible to coat e.g. the windows of a greenhouse and/or building with a solar cell material which lets visible light pass through, but on one side of the glass there is an UV-based solar cell and/or on the opposite side an IR-based solar cell, for instance, so that, as an additional effect, the loss through the window is limited, but furthermore, in summer, the incoming radiation can be limited and at the same time electricity can be generated.

On a general level it can be said that even if it is just one deposition layer (74A) that is grown on top (73) of the plastic, glass, metal, ceramic etc., we are still dealing with the same process as in multilayer deposition.

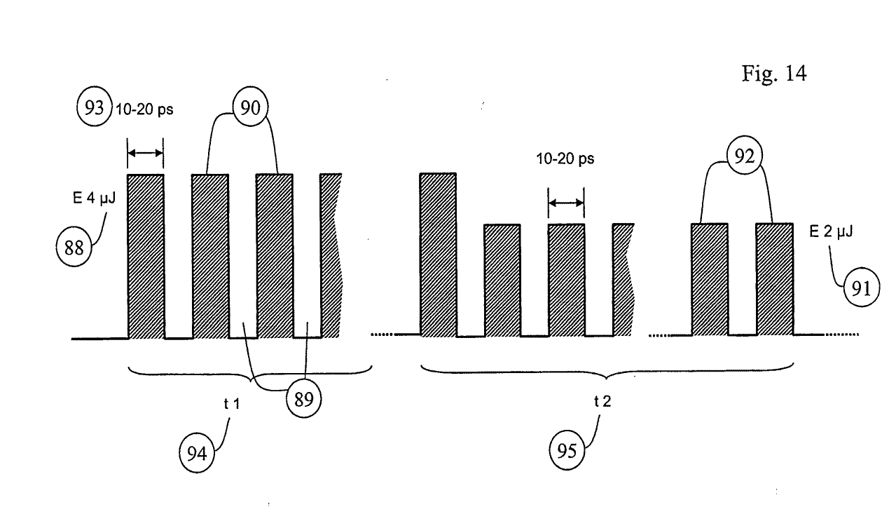

As was shown in FIG. 13, the best quality (84), adhesion (85), and yield (86) for the coating is mostly achieved with different pulse energies. FIG. 14 shows a set of typical parameters used in depositing a coating on a cold surface, i.e. more than 10 μs (microseconds) from the previous deposition pulse, during which time the outermost layer of the coating has had time to cool down. The example presented is not, however, meant to limit the invention to the said parameters.

The energy levels (88) of the pulses (90) are at first at 4 μJ (94) t1 for 1.25 seconds, after which they (92) drop to 2 μJ (95) t2 for 15 seconds when the repetition frequency, total power and pulse length (93) are static, i.e. are non-varying constants. Thus, adhesion has been first achieved FIG. 13 (85) but naturally the surface is not of top quality with a high pulse energy (FIG. 14) 90, 88, and the quality (84) and yield (86) have been achieved with lower pulse energies, FIG. 14, 92, 91. Generally, the need for high-energy plasma (FIG. 14) (88), (90) is temporally shorter and possibly also lower in its energy level than the plasma needed for optimal quality.

So, if one attempts to produce any surface using just one vaporization parameter, it usually is not possible or practical, because one of the properties (quality, yield or adhesion) of FIG. 13 will always suffer.

The pulse power tailoring according to an embodiment of the invention, which was described above in connection with FIG. 14, further enables the use of a target made of several adjacent material layers so that the pulse power is set optimal for each material. In the case of FIG. 4, for instance, each pulse train can be tailored separately and the trains can be directed to different materials. The same principle can be used to implement a target with different source materials. This opens significant new possibilities in the manufacture of composite, multilayer, and superlattice materials! According to an embodiment of the invention, the pulse yield and/or the pulse-induced flux of the ablated material is monitored using a feedback system according to an embodiment of the invention so that the shape and duration of the pulse as well as the interval between two pulses and the pulse energy can be controlled by the feedback. The feedback parameters can be stored in a database, even pulse by pulse, theoretically, so that afterwards it is possible establish whether the feed of material caused any errors in the deposition.

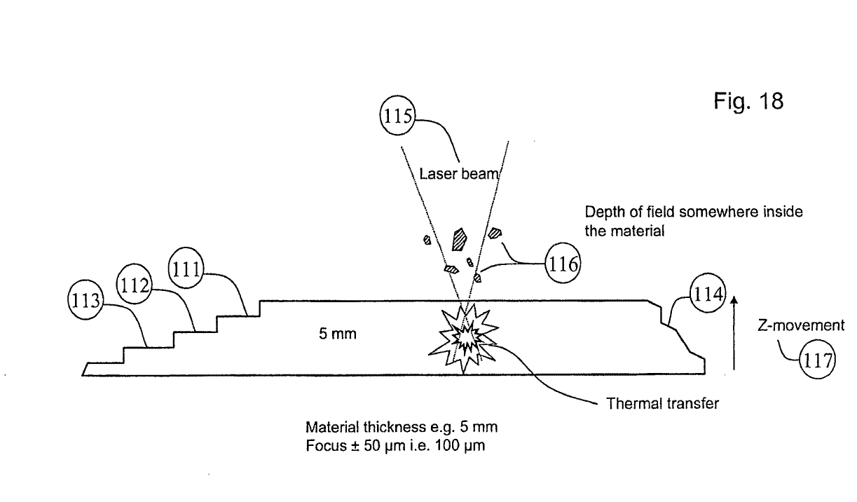

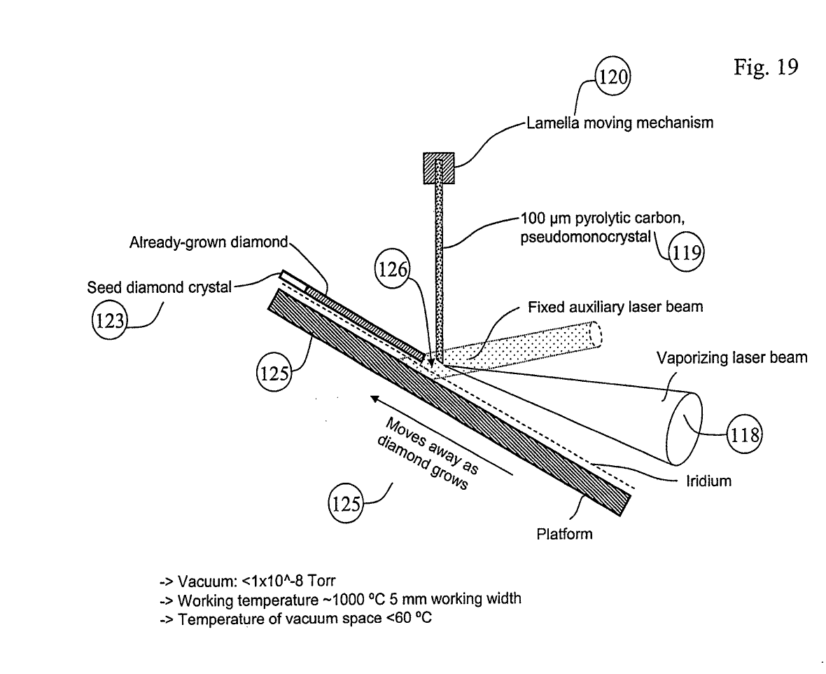

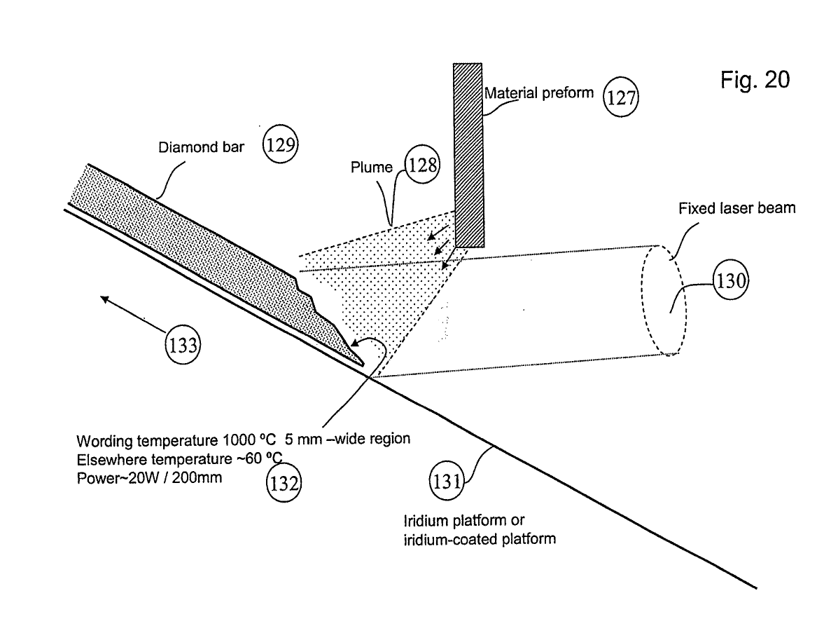

Let it also be noted that a turbine scanner also facilitates efficient use of high pulse frequencies. According to an embodiment of the invention, only high pulse frequencies (over 30 MHz) can achieve a situation in which the surface will not have had enough time to cool down before a new deposition pulse arrives on the surface of the growing film. According to another embodiment of the invention, the surface is separately warmed, e.g. by an IR laser which, according to an embodiment of the invention, follows and warms the surface of the substrate to be coated, advantageously synchronized to the depositing material flow but without disturbing it. If the work piece to be coated is warmed, e.g. thermally by IR radiation, by induction heating, CW laser or by some other means, then the time span which in cold deposition was 10 μs, is longer, say 20 ms, enabling the growth of crystalline (even monocrystalline) material (FIGS. 19 and 20).

FIG. 10 shows as an example a multilayer deposition with oxides (74) on top of a plastic lens in order to achieve additional functions such as AR and SC (hard coating). For work efficiency, it would be advantageous to only apply a minimum number of various stages in order to achieve the said functions, e.g. aluminum oxide (Al₂O₃) and tantalum oxide (Ta₂O₅), placed in layers of certain thickness on top of each other as a multilayer structure (74 A-E) and (77 A-E).

Even if the background temperature in the work process, i.e. the temperature in which the products are, had been raised as high as possible, e.g. +125 degrees for polycarbonate, it is almost always advantageous to apply the method illustrated in FIG. 14 to grow the first oxide layer. Considering FIG. 10, in (74) (A) at first a higher energy level is applied, e.g. to the thickness of about 14 nm, and then a lower energy level for the rest of the thickness of the surface, say 52.91 nm. If a result as perfect as possible is desired, a corresponding procedure should be applied to each different surface 74 to 75 (A) to (E) to achieve good attachment between layers.

When growing a coating onto almost any material in a usage example according to an embodiment of the invention, even with a product as simple as TiO₂, titanium dioxide coated Window glass; oxide or diamond on stone, metal or plastic surface, it is advantageous to use the procedure shown in FIG. 14. This is due to the fact that high bombardment energies can produce good adhesion because of interface mixing and/or formation of chemical bonds. High energy bombardment also removes possible weakly bonded surface impurities (water, hydrocarbons, gases). On the other hand, atoms arriving at a low energy (in traditional thermal vaporization, for example) will settle on the surface “lightly”, usually unable to properly form a chemical bond with the atoms of the background matter at a sufficient speed. Thus, a thin film attached through physisorption (low bombardment energies) is about 10 times weaker in its attachment than a thin film attached through chemisorption (high bombardment energies). The former of these will become loose in the so-called tape test, while the latter usually always passes the test. This property can also be utilized in embodiments of the invention in which one of the films is meant to be detachable according to the tape test.

In principle it would also be possible to achieve good adhesion by increasing the surface temperature of the object to be coated. A temperature which is too high adds to the thermal tension between the deposition material and the product when the product is cooled down to a normal room temperature (+20° C.). Often, on the other hand, it is not sensible or even possible to increase the temperature of the product so high that a thermally strong bond would be produced between the deposition material and the product. If there are impurities, say, water, on the surface of the object to be coated, an increase in the working temperature often will have a positive impact on adhesion, although the effect on the quality of the actual film which is grown is usually quite marginal.

The above-described integrated plasma intensity measurement and control system primarily relates to the function of ensuring that the phased pulse energy levels shown in FIG. 14 are always optimal.

In the new deposition and product fabrication method, hereinafter the pulsed laser deposition (PLD) method, it is possible to apply any type of laser system, such as cold ablation systems pico, femto and atto. The SI prefixes above refer to the time scale measuring the duration of the pulse.

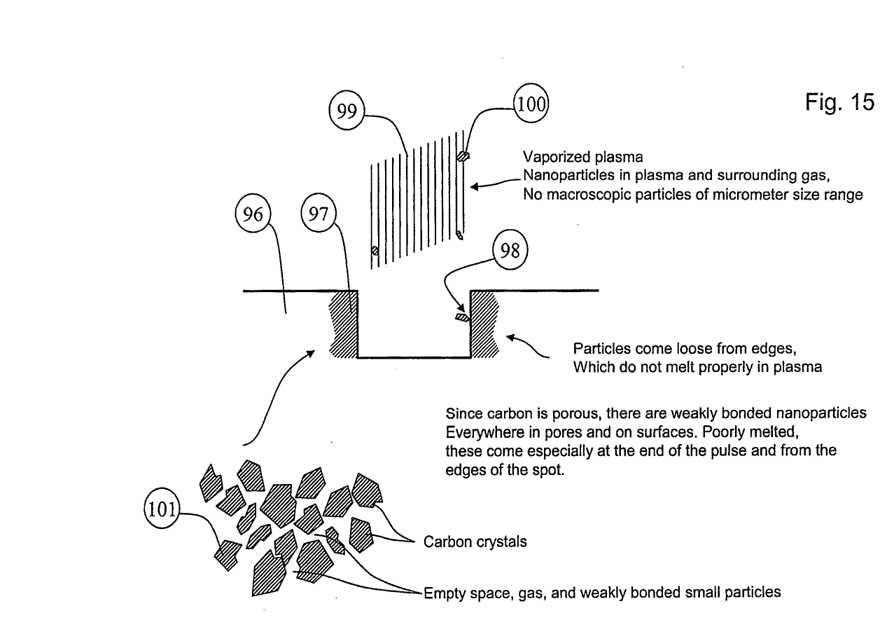

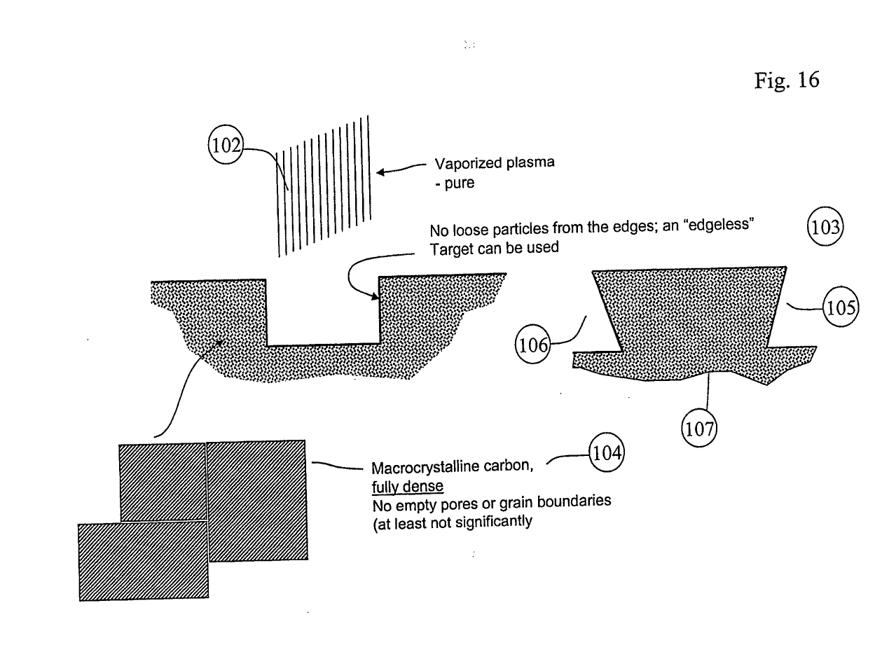

FIGS. 15 and 16 deal with the choice of the material vaporized in a method according to an embodiment of the invention, and how its composition will affect the end result, e.g. in the manufacture of semiconductor diamonds. In FIG. 15 the material to be vaporized is not uniform in quality, which means there is a risk of fragmentation in the process, whereas in FIG. 16 there is material which is homogeneous in its quality at the portion of the target which is to be vaporized, thus producing pure plasma of high quality.

FIG. 17 illustrates the focusing of radiation onto a thin film in accordance with an embodiment of the invention. The thickness of the material 108 to be vaporized can be A) less than the depth of the focus (109), B) equal to, or C) thicker than the depth of the focus, but of the film which contains the material 108 to be vaporized, only that portion is used which corresponds to the radiation working depth, in this example equivalent to the focus depth, e.g. +−50μ, or 100μ (110). Reference numbers 111, 112, and 113 indicate the layers of material in the film to be ablated. A laser system according to the invention and its values are:
power 20 W
repetition frequency 4 MHz
pulse energy 1 to 10 μJ, e.g. 5 μJ
pulse length 10 ps
scanning width 300 mm
scanning rate 60 m/s

A second laser system according to the invention and its values are:
power 80 W
repetition frequency 16 MHz
pulse energy 1 to 10 μJ, e.g. 5 μJ
pulse length 29 ps
scanning width 150 mm
scanning rate 3 m/s

A further example of laser system values in an apparatus according to an embodiment of the invention:
power 10 W
repetition frequency 50 MHz
pulse energy 2 μJ
pulse length 19 ps
scanning width 700 mm
scanning rate 60 m/s

A yet further example of laser system values in an apparatus according to an embodiment of the invention:
power 30 W
repetition frequency 5 MHz
pulse energy 6 μJ
pulse length 22 ps
scanning width 50 mm
scanning rate 100 m/s

Still another example of laser system values in an apparatus according to an embodiment of the invention:
power 120 W
repetition frequency 30 MHz
pulse energy 4 μJ
pulse length 8 ps
scanning width 70 mm
scanning rate 20 m/s

Still another example of laser system values in an apparatus according to an embodiment of the invention:
power more than 100 W, e.g. 300 W
repetition frequency 30 MHz
pulse energy 1 to 10 μJ, e.g. 10 μJ
pulse length 10 ps
scanning width 100 mm
scanning rate 60 m/s

According to the invention, the focus of the laser beam can be changed if necessary e.g. by means of zoom optics placed in the radiation transmission line or alternatively or additionally by changing the position of the material preform in the z direction (FIG. 18), i.e. through mechanical movement.

To facilitate a required adjustment at a sufficient accuracy in order to achieve a correct focus, a feedback arrangement according to an embodiment of the invention can be used to implement the focus adjustment as well as, if necessary, a monitoring and/or measuring system applicable in plasma intensity control.

The embodiment example illustrated in FIG. 17 uses a high-power (over 100 W) picosecond laser system producing high-energy pulses, e.g. 3 to 10 μJ, with a high repetition frequency, e.g. 29 MHz. Each pulse can vaporize, to a depth of about 1 to 2 μm, the area which the pulse hits so that 50 to 100 pulses can be positioned on top of each other at the same spot on the surface before the jet no longer is in focus on the vaporized surface. Thus the energy density of the laser beam is the same or within a very small tolerance at each different vaporization level (111 to 112), whereby the jet of matter applicable in a second, surface-shaping jet, is homogeneous enough in its quality.

FIG. 19 illustrates an example of growing monocrystalline diamond according to an embodiment of the invention. On the platform 125 there is an iridium substrate which is used in diamond growing in this example embodiment of the invention. The growing takes place at first using a seed diamond 123, on the surface of which the diamond is grown. In the example embodiment the radiation source is a laser source to achieve a laser beam 118 by means of which to vaporize, at about spot 126, a target of 100 μm of pyrolytic carbon 119 (which is advantageously of the pseudomonocrystalline type in order to minimize fragments or, even more advantageously, diamond fiber). Target material is fed in synchronism with ablation by means of a lamella moving mechanism 120. In an embodiment of the invention, the platform may be arranged so as to be moving. The movement may be arranged to be away from the ablation spot 126. In the example of FIG. 19, there is a vacuum of about 10⁻⁸ Torr, the work temperature is about 1000° C. for a working width of 5 mm, whereby the temperature of the vacuum space is about 60° C. The ablated spot can be heated by e.g. an IR or other laser beam or heat source (fixed laser beam).

FIG. 20 shows a detail of an embodiment like the one shown in FIG. 19. A fixed laser beam 130 is in this case used to radiate the diamond surface grown. Since the fixed beam 130 is not an ablating beam, i.e. it does not generate a jet of matter 128 from the target 127, the beam 130 can travel through the jet 128. The work temperature is about 1000° C. at a working width of 5 mm, whereby the temperature of the vacuum space is about −60° C. The power of the fixed laser beam is about 20 W/200 mm.

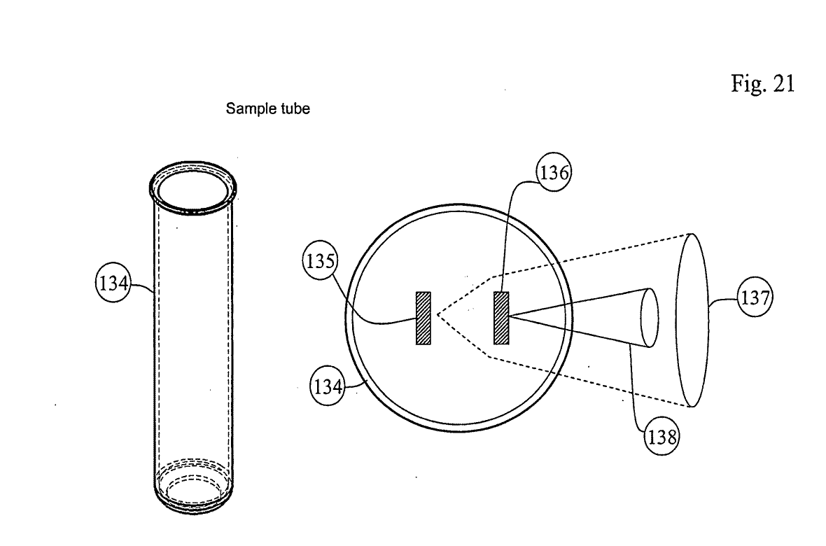

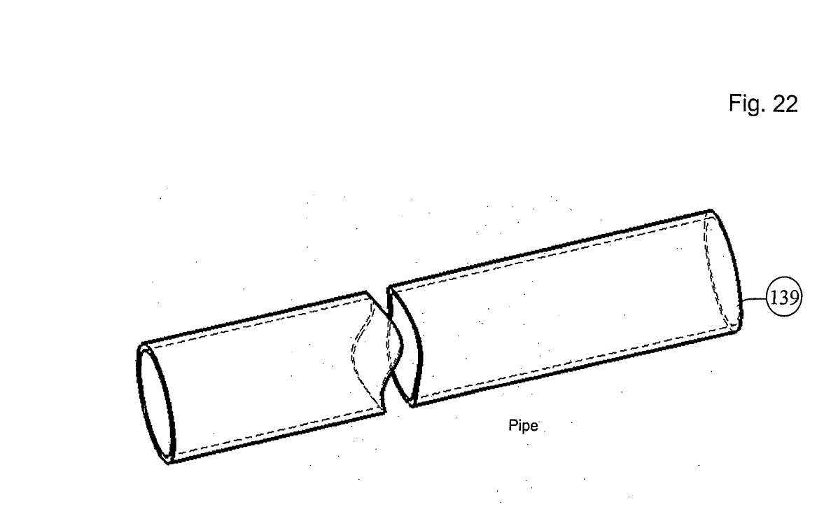

FIGS. 22 to 58 illustrate products coated by means of a method and/or apparatus according to an embodiment of the invention. The surfaces may be inner and/or outer surfaces, where applicable.

FIG. 22 illustrates a pipe structure 139 to be coated using an apparatus according to an embodiment of the invention. The inside and/or outside of the pipe can be coated. The pipe may be a transmission line for some substance, e.g. a water pipe, sewer pipe, gas pipe, oil pipe, the piping in an industrial facility such as a chemical plant, or part of such a pipe. Parts susceptible to wear and/or corrosion, e.g. the applicable surfaces of a heat exchanger, can be coated with resistant deposition materials, e.g. carbonitride and/or diamond using a method according to an embodiment of the invention.

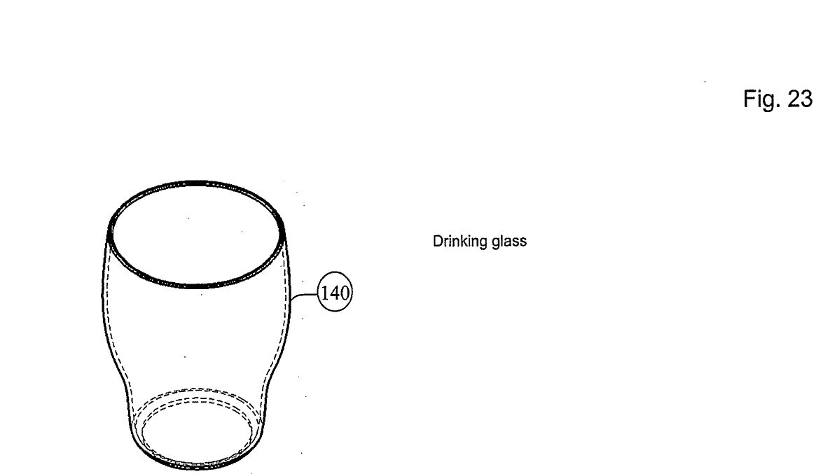

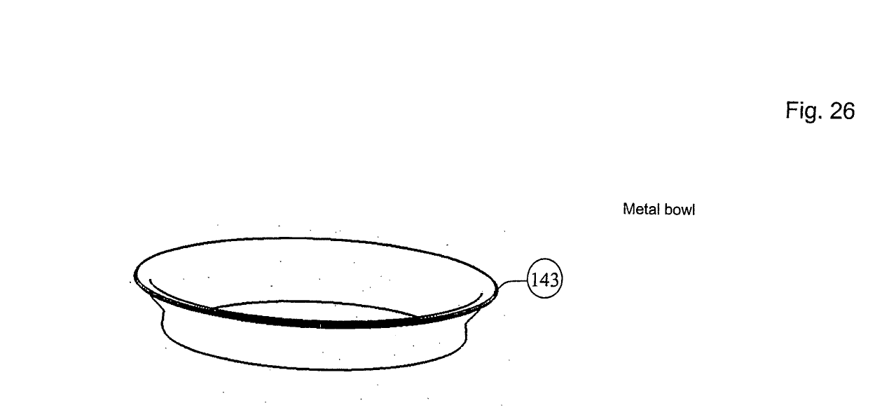

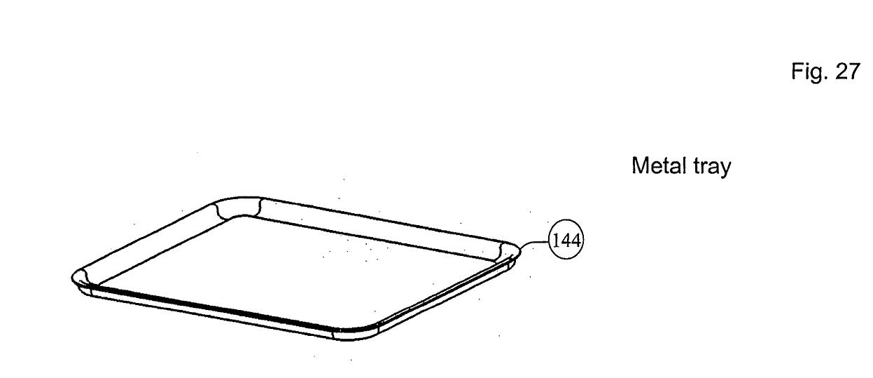

FIGS. 23, 26 and 27 illustrate the use of an embodiment of the invention in the coating of a vessel and/or container. The object may be e.g. a glass 140 used in the kitchen and/or food industry, also in a household, a mug, a candlestick and/or other, e.g. ceramic, vessel. The object may alternatively and/or where applicable, be made of metal. FIG. 26 shows a metal bowl 143, and FIG. 27 shows a metal tray 144. The object may also be an industrial vessel, container, reactor or similar. The embodiments of the invention, e.g. coating, do not limit the material of which the object is made.

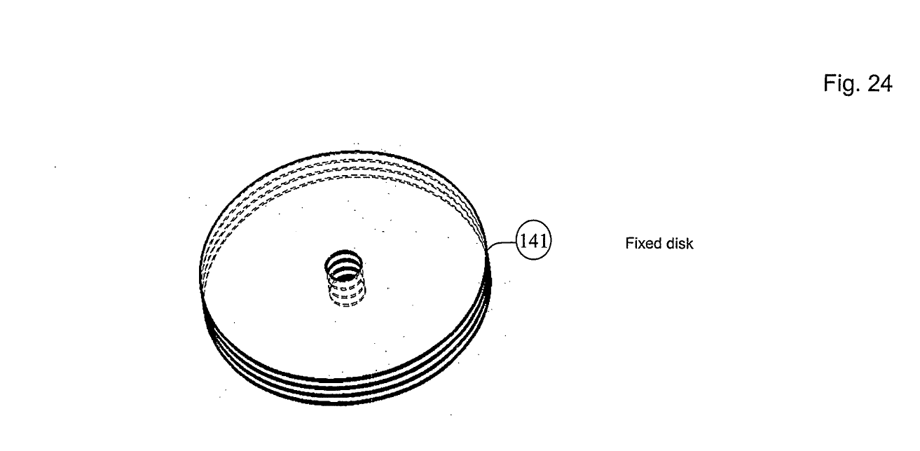

FIG. 24 illustrates the use of an embodiment of the invention in the coating of a fine mechanical part, such as a fixed disk 141, for example. It is furthermore possible to coat the surfaces of micromechanical elements, whether electrical, mechanical or micromechanical. Almost any moving part of a fixed disk can be coated, thus reducing wear. Also the read head, for instance, can be fabricated and/or coated using the method, where applicable.

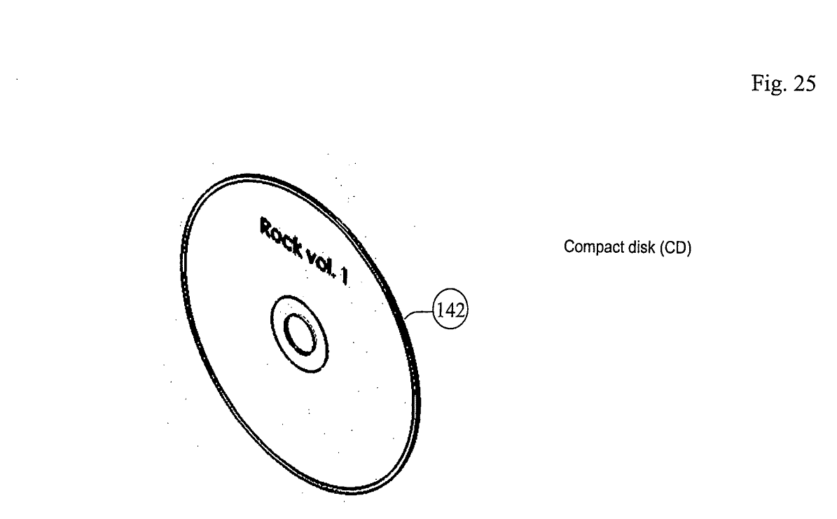

FIG. 25 illustrates the use of an embodiment of the invention in the coating of an optical medium, such as a DVD and/or CD disk 142, for example. The optical medium may also be e.g. a fiber, optical fixed disk, optical connector, lens, prism, lattice or some other object or part based on optics.

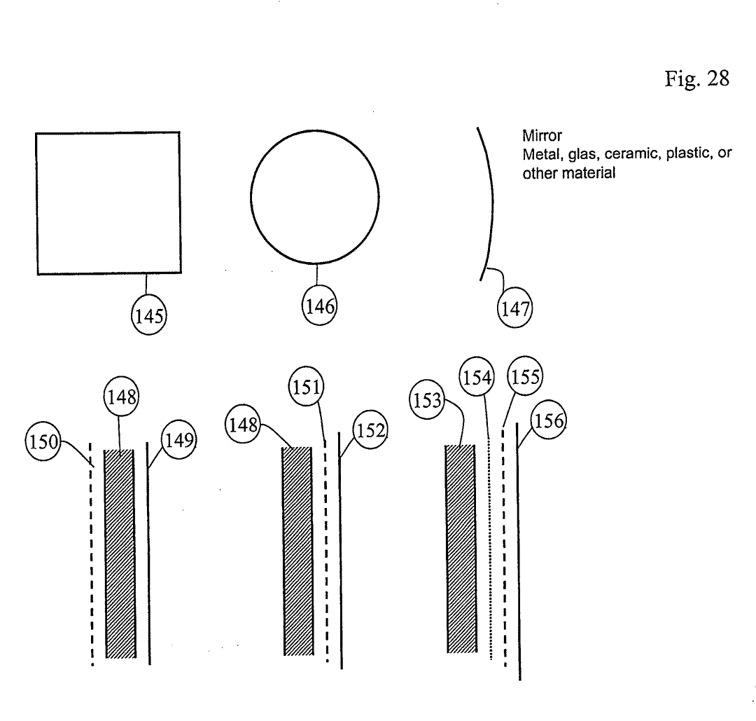

FIG. 28 illustrates the use of an embodiment of the invention to deposit a coating on various substrates. Shown in FIG. 28 is e.g. a window glass or mirror 145 having a layer 148 of glass behind which there is a layer 150 of silver or aluminum, for instance. On the other surface of the layer 148 of glass there may be a layer 149 intended to help keep the object clean, e.g. a diamond coating or a photocatalytic coating. The substrate may also be an object 146 which is metal or some other material shown in FIG. 2. The object 146 may also be coated on one side using a first coating 151 for the object, but also a second coating 152. The object may be e.g. a spectacle lens 147 which is coated using suitable coatings 154, 155, 156 on the surface of the glass layer 153 of the lens.

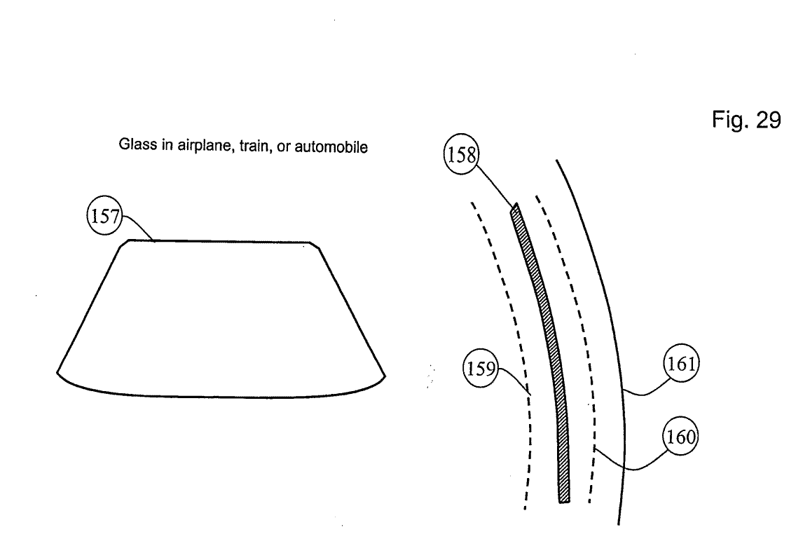

FIG. 29 illustrates the use of an embodiment of the invention for coating glass in a vehicle 157, water- and/or aircraft, and also for coating window glass. The glass can be coated on one side 159 using a first coating, but alternatively or additionally using a second coating 160 on a second side of the said glass 158. The glass may also be coated using a third coating 161, without, however, limiting the number of coating layers. The glass may be coated on one side using e.g. a solar cell material functioning as a solar cell outside the wavelength area of visible light. The word “glass” refers to a window or windscreen, but the material thereof may be glass or plastic or a composite of the two so that the said layers 159, 160 and/or 161 may also be located in a laminated glass structure.

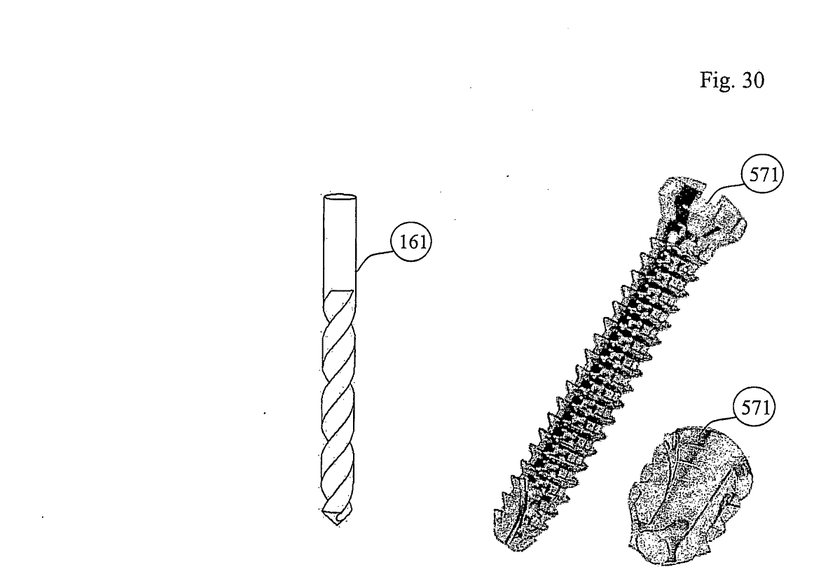

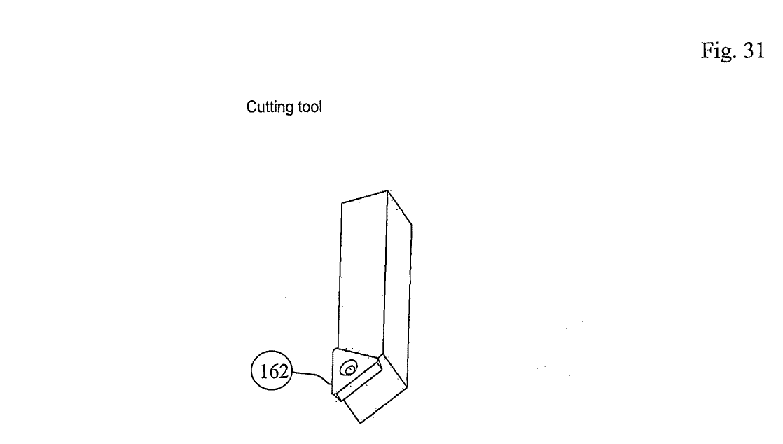

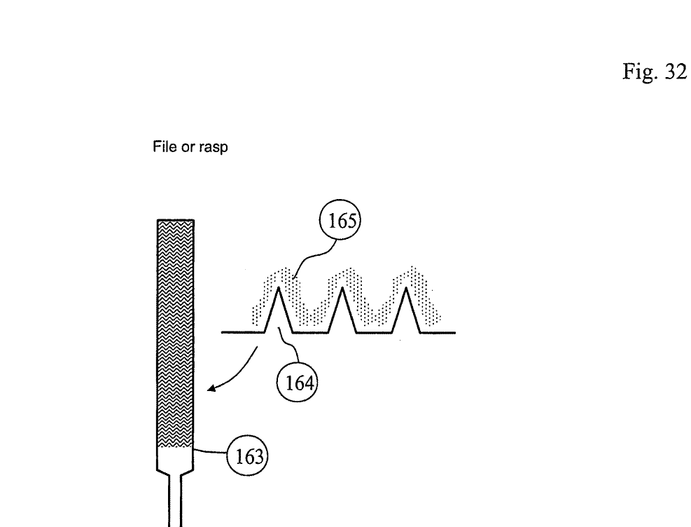

FIG. 30 illustrates the use of an embodiment of the invention for coating a first tool 161 or part thereof. Even though a drill bit is shown, the tool may be a hitting tool, knife, ax, wedge or a saw, also a chainsaw. FIG. 31 illustrates the use of an embodiment of the invention for coating a second tool or part 162 thereof. The tool may be a milling cutter, broaching drill bit, or a lathe tool, for example. FIG. 32 illustrates the use of an embodiment of the invention for coating 164 a tool surface 163 which has to withstand abrasion. Shown in the Figure is the surface of a file 163, but diamond coating can be used also to fabricate various sandpapers and grinding wools made of thread or some other fiber.

FIG. 30 further illustrates various means of attachment 571 in the coating of which it is possible to use certain embodiments of the invention. The means of attachment may be ordinary hardware store items coated against corrosion, but they may also be special means of attachment, supports, angle iron pieces, nails, rivets, screws and/or nuts to be used in spaceships, airplanes and/or ships. According to an example of a use of the invention, the means of attachment 571 are medical prosthesis parts to be attached to bone, for example.

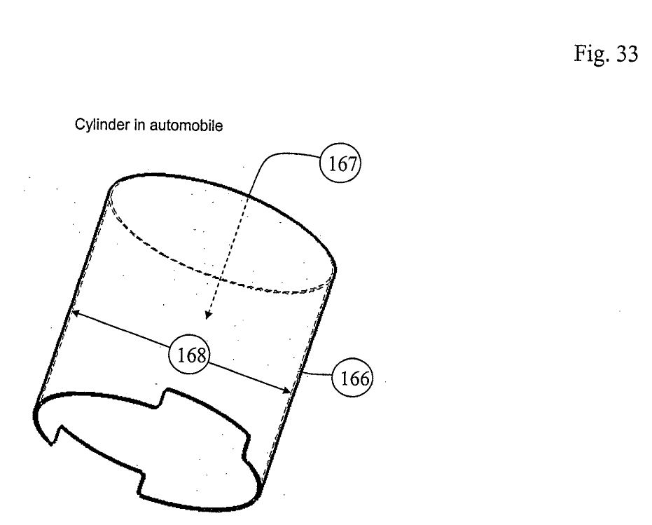

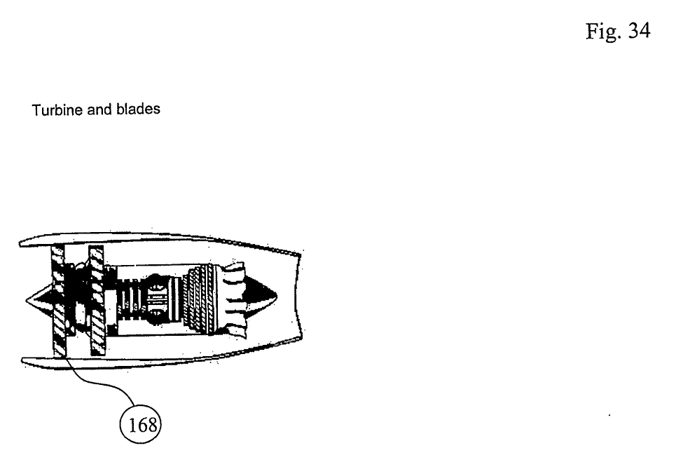

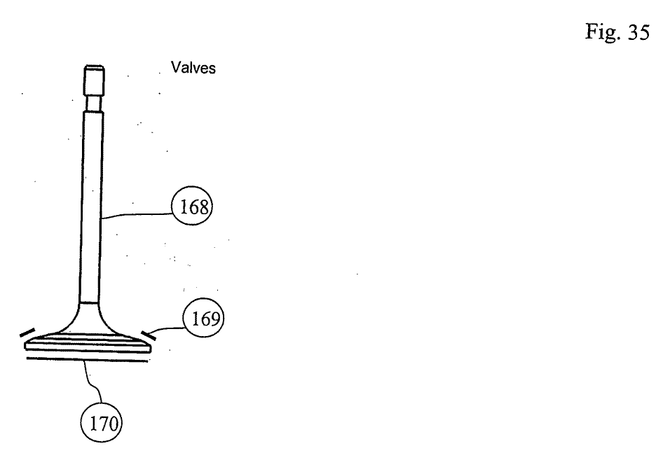

FIG. 33 illustrates the use of an embodiment of the invention for coating a surface 168 of a cylinder 166 in an engine, namely, the surface against which the piston can be considered to move inside the cylinder 167. A diamond coating, for example, which is smooth enough, can significantly reduce friction, and carbonitride, for instance, can restrict surface wear. Alternatively and/or additionally the piston which moves in the cylinder can be coated as well. Combustion chambers of other engines, too, can be coated in order to prevent/minimize corrosion/wear. For instance, a Wankel engine may employ parts coated with a method according to an embodiment of the invention. FIG. 34 illustrates the use of an embodiment of the invention for coating the blades 168 of a turbine. Although the Figure does not show a rocket engine, combustion chambers in a rocket engine can also be coated, where applicable. FIG. 35 illustrates the use of an embodiment of the invention for coating a part, such as a valve, in an engine. Also other parts of engines, such as cams, camshafts and/or crankshafts can be coated. Furthermore, gearwheels, screw wheels and/or silent chains can also be coated against corrosion and/or mechanical wear using a method according to an embodiment of the invention.

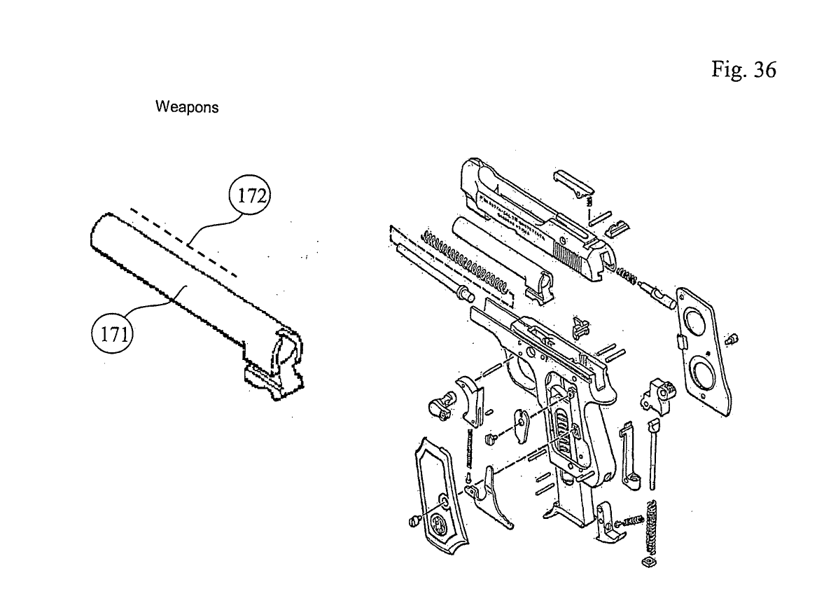

FIG. 36 illustrates the use of an embodiment of the invention for coating 172 a part 171, especially the barrel 171, of a weapon. Although the Figure shows an exploded view of a handgun, the weapon may as well be a rifle, RPG, cannon, machine gun or a mortar, where parts that have to withstand wear can be coated using suitable coatings.

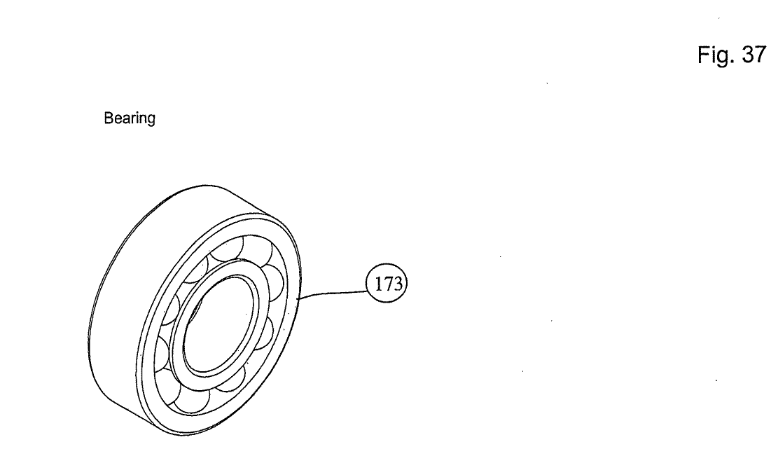

FIG. 37 illustrates the use of an embodiment of the invention to achieve a bearing surface by coating at least one part of the bearing 173. Although a ball bearing is shown, the scope of the invention also includes slide and cylinder bearings as well as possible conic and center point bearings. The material of such bearing surfaces is advantageously well thermally conductive, such as diamond. In addition, at nano level their surfaces are so smooth that surface variation is ±30 nm, advantageously ±10 nm and preferably ±3 nm. On such a surface there are no micro-size particles and advantageously no particles bigger than 70 nm. In an advantageous embodiment of the invention, no extra particles of any type can be found on the surface of the bearing material. All parts of the bearing can be coated with a suitable material and in one embodiment of the invention either some or all structures of the bearing are produced by ablation (3D printing). Such bearings do not necessarily need lubricants, and they are not limited by the maximum rotating speeds characteristic of present-day bearings. Using new bearings according to the invention it is possible to increase the performance, say, rotating speeds, of apparatuses employing now conventional bearings, without any adverse effects on the bearings or apparatuses containing them. One area of application is aircraft engines, the speed of revolution of which can be increased using bearings according to the invention.

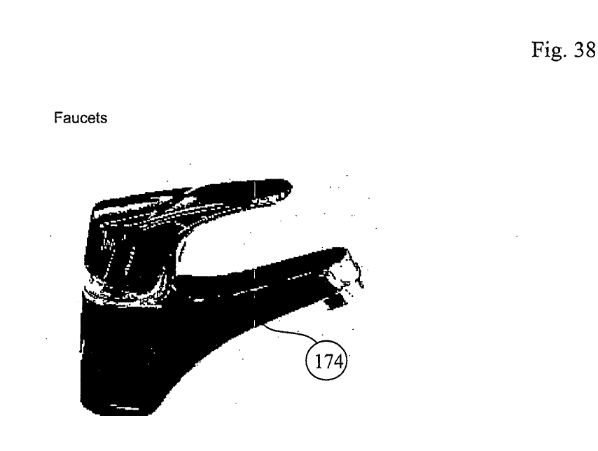

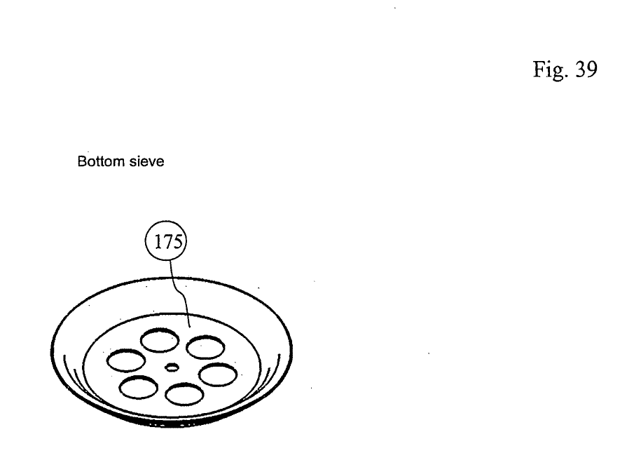

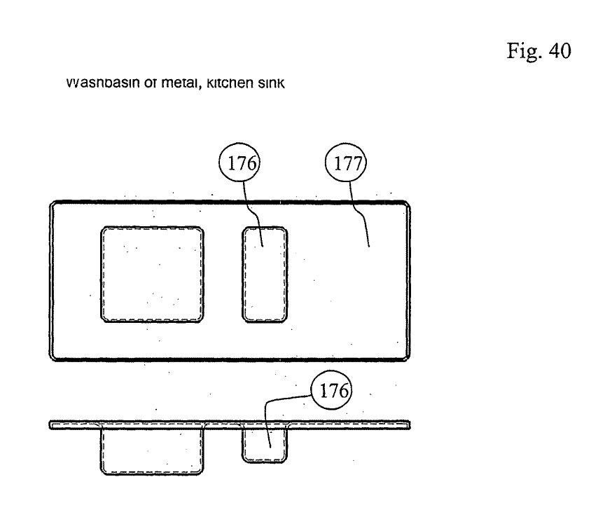

FIG. 38 illustrates the use of an embodiment of the invention in water pipe systems 174. For decorative purposes in the surface structures of faucets, but also in transmission lines for substances in the field of water management. FIG. 39 illustrates the use of an embodiment of the invention in sewer systems 175. FIG. 40 illustrates the use of an embodiment of the invention in kitchen fixtures, particularly on the kitchen sink 177 cover and/or its basins 176.

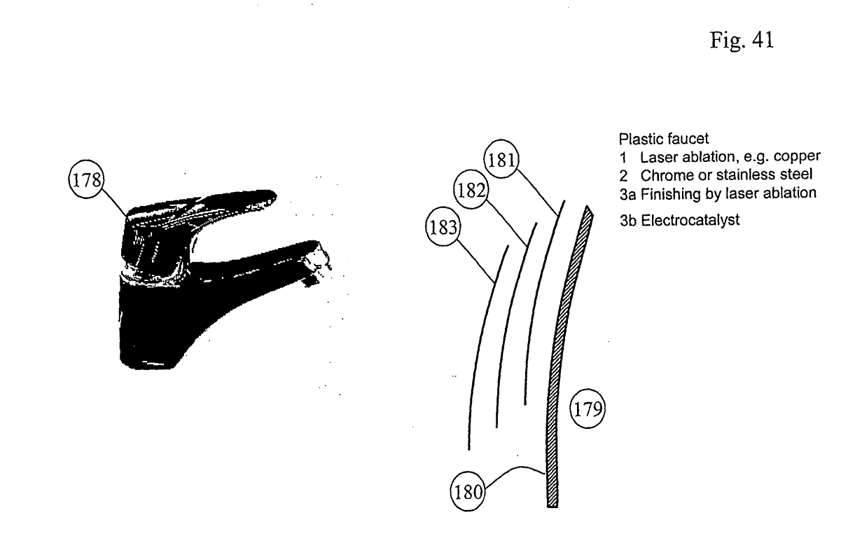

FIG. 41 illustrates the use of an embodiment of the invention to achieve a plastic faucet 178. A copper layer 181, chrome layer or stainless steel layer, for example, can then be ablated on the surface 180 of the plastic object 179 with a final finishing touch being given by means of ablation to the outermost layer 183 which can be either replaced or, where applicable, further coated with an electrocatalyzer in order to achieve a self-cleansing water pipe system and/or to reduce the generation of static electricity.

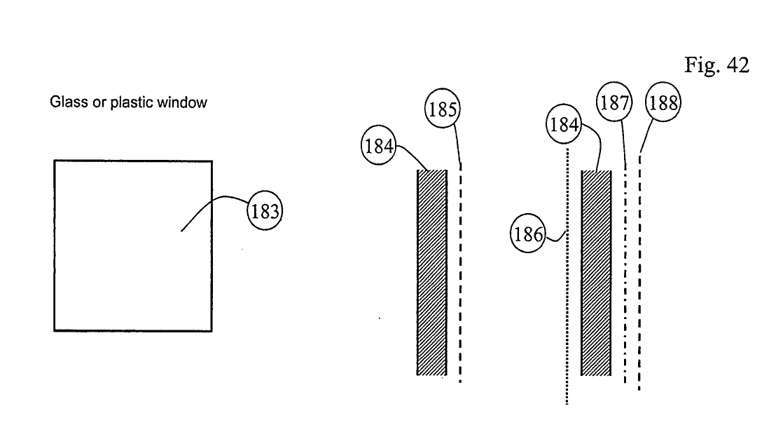

FIG. 42 illustrates the coating of a glass and/or plastic window 183. An embodiment of the invention can be utilized to achieve a self-cleaning window 184. The inside of the window may be coated with an anti-infrared coating 186, for example, and the outside with a coating 187 for tinting the glass, for instance, with the outermost layer being a photocatalytic layer 188.

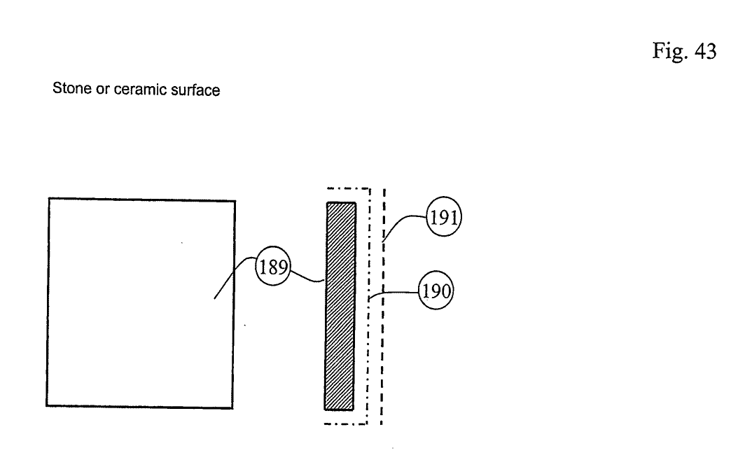

FIG. 43 illustrates the use of an embodiment of the invention for coating a stone and/or ceramic surface 189. The surface may be that of an indoor or outdoor tile, made of marble or synthetic ceramics, for instance, which is first tinted 190 green, for example, and given a diamond surface 191 to maximize the resistance to wear.

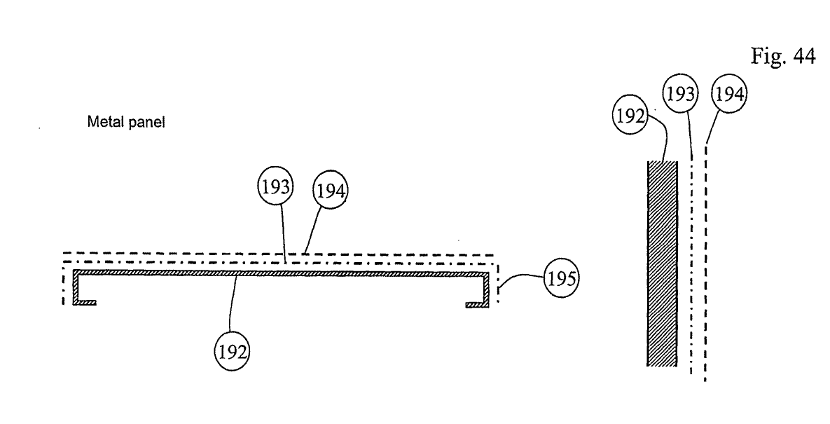

FIG. 44 illustrates the use of an embodiment of the invention for coating a metallic structural element 192. The surface may first be tinted with a layer 195 giving a desired shade of color, after which the surface of the structural element is coated e.g. with a layer 194 of carbonitride and/or diamond to reduce wear-resistance and/or corrosion. The structural element may be an indoor or outdoor element to be used in the cladding of a building, bunker, tank, car, ship, boat, or other vehicle. In military technology it is possible to produce so-called stealth-type coatings to prevent coated structures from being detected by conventional radars.

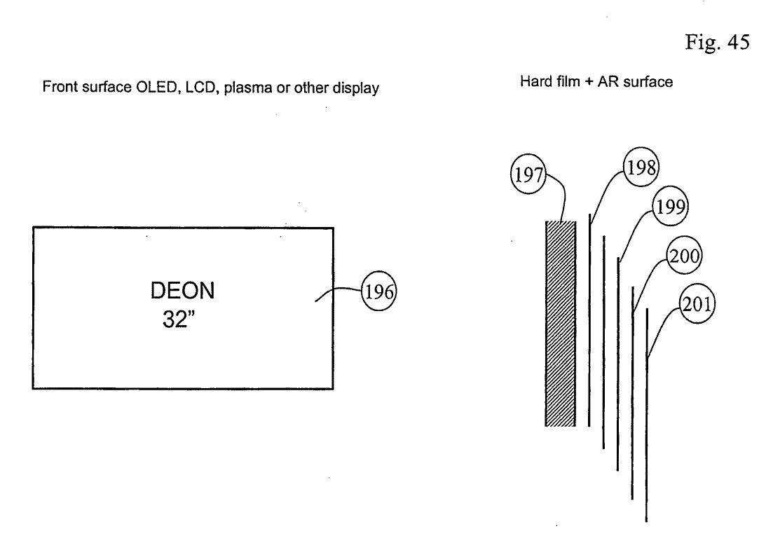

FIG. 45 illustrates the use of an embodiment of the invention for coating a television set 196. Shown in the Figure is a plasma or other television EAD 32″, not, however limiting the television set itself. The television set in the Figure is e.g. a front-surface OLED, LCD or a plasma TV. The coatings 198, 199, 200, 201 of a substrate 197 of the TV screen can be chosen from among conventional coatings, but may also comprise a diamond coating and/or photocatalyst to keep the screen clean. Furthermore, it is possible to coat the surfaces of video recorders, record players and/or radio receivers or other apparatuses in the field of entertainment electronics.

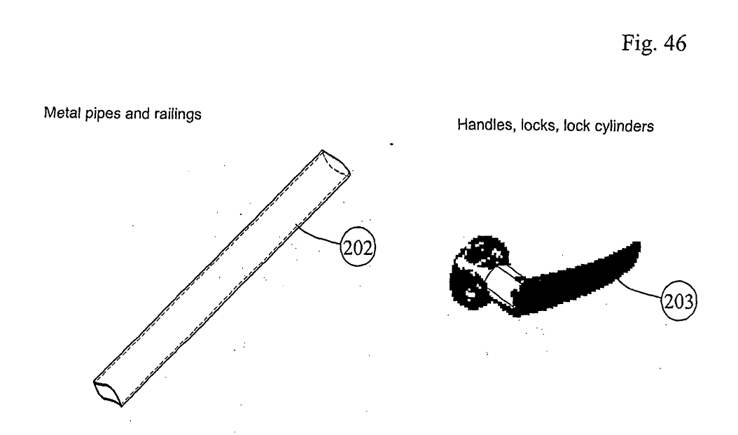

FIG. 46 illustrates the use of an embodiment of the invention for coating railing pipes 202 and/or door handles 203, also other handles and/or doors.

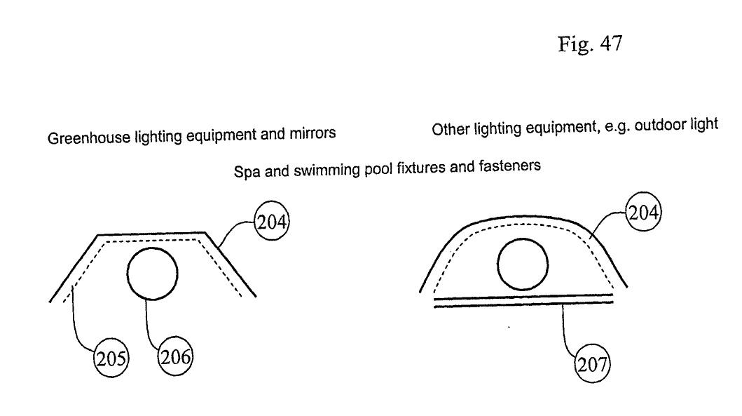

FIG. 47 illustrates the use of an embodiment of the invention for coating lamps and/or parts thereof. A mirror 204 in the lamp can be coated using a suitable tint 205 in order to achieve a certain wavelength distribution e.g. in a greenhouse, but also the shell 206 of the light source itself can be coated. In addition, it is possible to achieve closed lamp solutions in which the protective glass 207 (without, however, limiting the material to glass) can be coated so as to achieve a certain wavelength distribution. It is also possible to use photocatalytic coatings to help keep the surface clean, especially in greenhouse conditions.

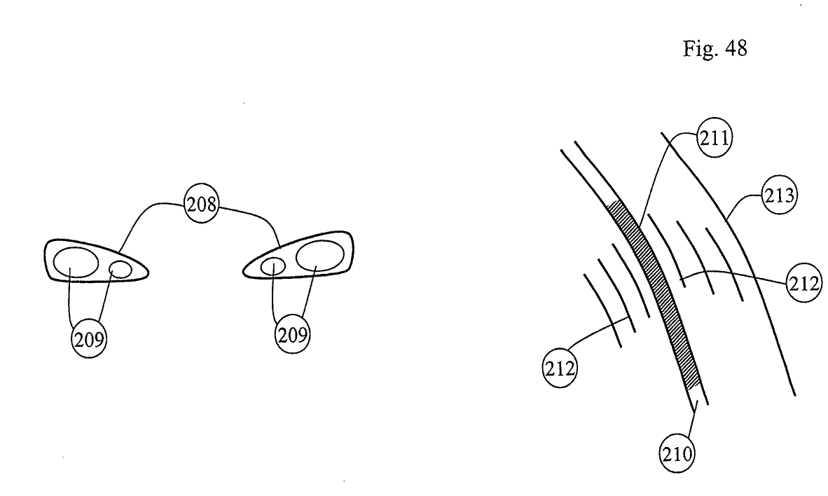

FIG. 48 illustrates the use of an embodiment of the invention for coating and/or manufacturing the outer portions 208 of a wing. Also the inner portions 209 of the wing can be coated. Especially if the inner portions are used for fuel storage, it is advantageous to use antistatic coatings. A smooth layer of coating sufficiently hard and strong reduces resistance of medium but may also make it possible to make the load-bearing structures thinner so that the weight of the wing structure can be decreased, thus enhancing fuel economy e.g. by using diamond coatings and/or laminated structures in order to achieve sufficient hardness and/or toughness.

The structure may be such that the wing frame 210 has a coating 212 on one side and a coating 213, e.g. a diamond coating, on another side. It is also possible to achieve structures that are rigid but will not break at the point of bending 211 even under severe stress.

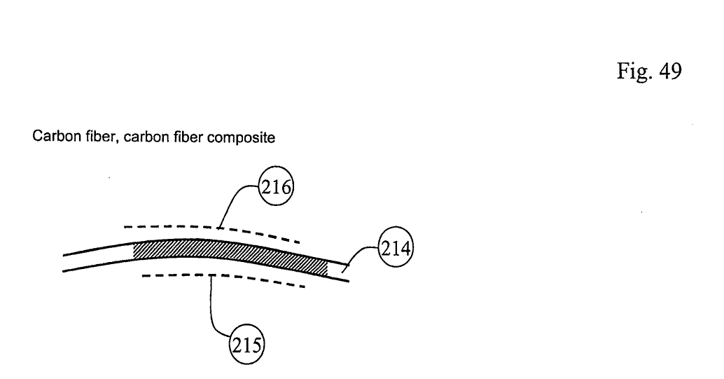

FIG. 49 illustrates the use of an embodiment of the invention for fabricating a carbon fiber composite 214 deposited with coatings 215 and/or 216, e.g. in accordance with FIG. 2.

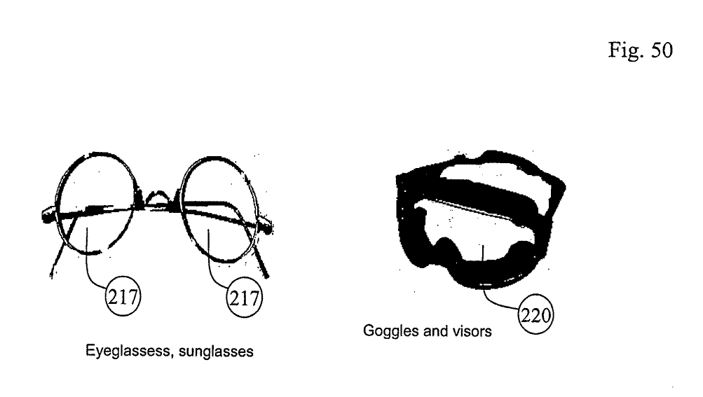

FIG. 50 illustrates the use of an embodiment of the invention for coating optical elements, such as lenses, especially eyeglasses 217 and/or protective goggles 220.

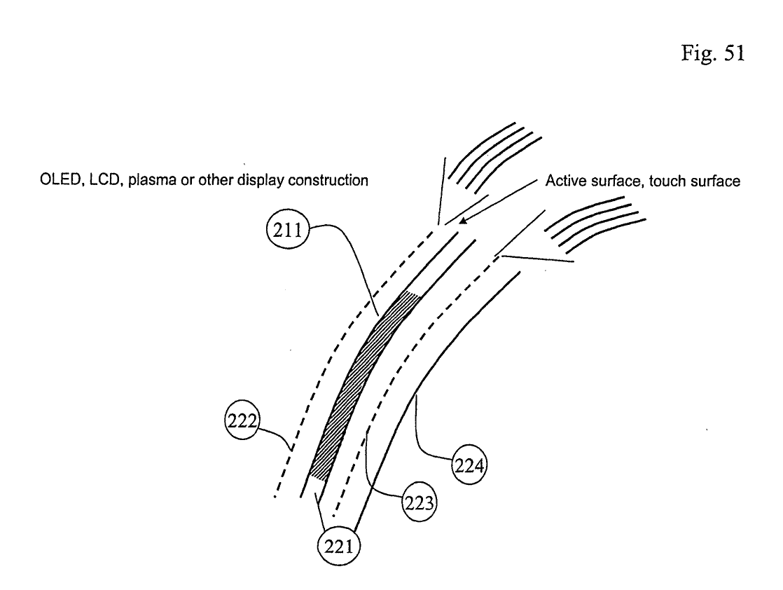

FIG. 51 illustrates the use of an embodiment of the invention for coating a part of a display, where the display can be a flexible paper-like display, for example. It is not, however, the intention of the example to limit the use of the invention to just OLED, LCD, plasma or other displays, implemented in flexible form, but e.g. printed circuit boards can be manufactured according to an embodiment of the invention on a flexible substrate so that it is possible to produce, in an unforeseen manner, e.g. roll- and/or spiral-shaped circuit board solutions. A substrate 221 in that case can be coated e.g. on one side with a layer 222 to produce a PCB pattern and/or on another side with a PCB material 223 to produce a second PCB pattern. These can be, where applicable, protected 224 using e.g. a diamond layer. A touch-screen, for instance, can be implemented by means of a film deposited on the surface of a substrate. With high-quality coatings it is also possible to achieve electronic books, for example, in which the flexible display may also partially function as a solar cell in the UV region, but let visible light pass through in order to show images and/or characters on the display.

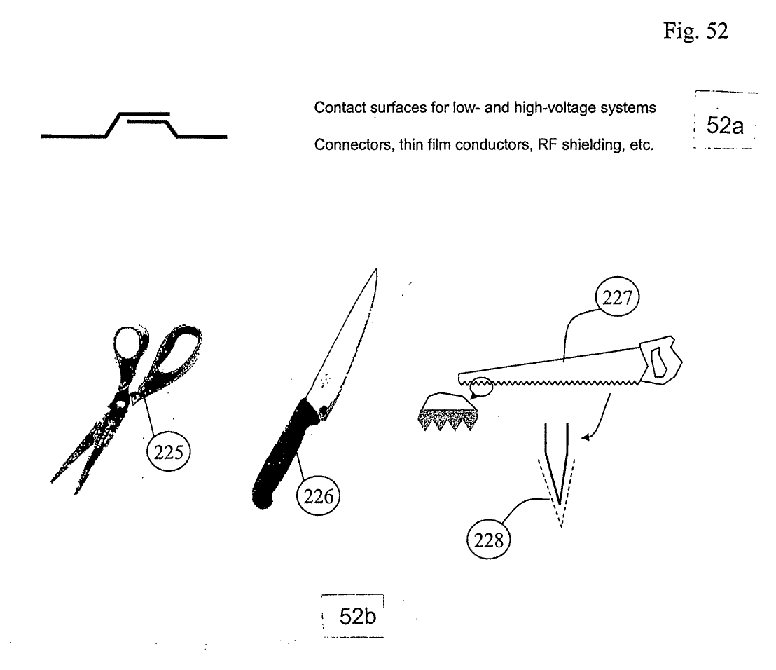

FIG. 52 illustrates the use of an embodiment of the invention for coating electrical and/or mechanical surfaces against wear. For example, scissors 225, knives 226, saws 227, and/or wedges/spikes can be coated. Also, for example, low and/or high-voltage switches and various contactors from micromechanical scale to the biggest switches of a power plant can be thus coated against wear by means of a diamond coating, for example.

Although FIG. 52 shows ordinary scissors and knives, these also represent instruments used in certain special fields, which can be coated against wear on electrical and/or mechanical surfaces in accordance with an embodiment of the invention. For example, medical, surgical or laboratory instruments such as tweezers, scissors, saws, drills, braces, prostheses, artificial joints and/or prosthetic fasteners can be coated e.g. with a diamond coating which, being exceptionally smooth in comparison with previous coatings, produces a better cut, resists wear better, and also enhances surgical hygiene. When a prosthetic bone screw, for example, has a diamond coating, rejection reactions in tissue can be reduced. Furthermore, the screwing friction is lower so that less strength is needed, which decreases risk of damage.

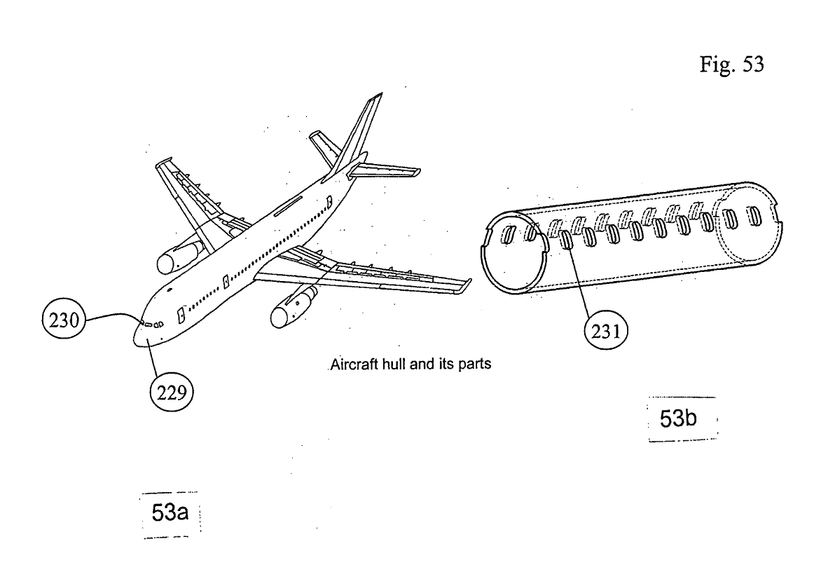

FIG. 53 illustrates the use of an embodiment of the invention for fabricating an aircraft fuselage 229 and/or part 230, 231 thereof, without limiting the invention solely to a window and/or window frame with its seals. Any part can be coated.

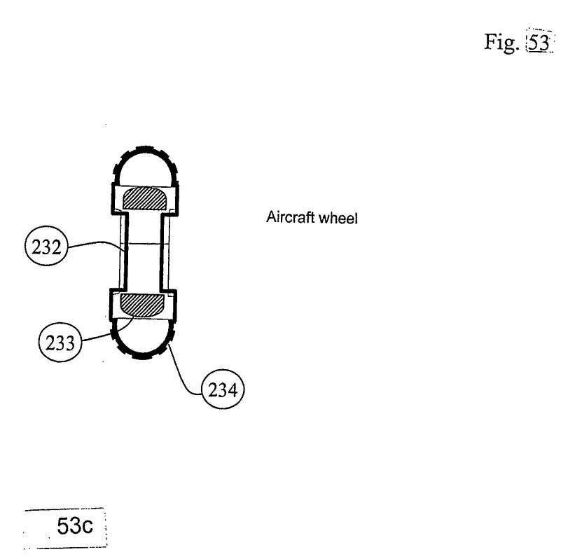

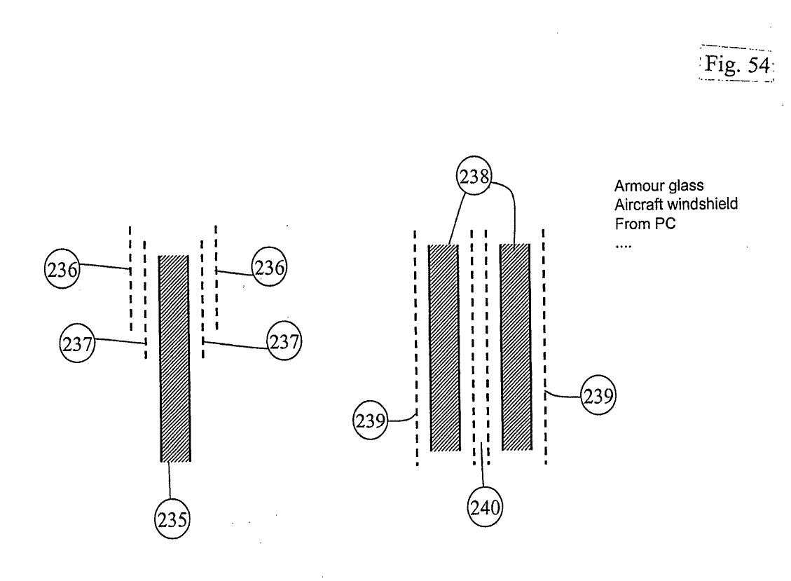

FIG. 54 illustrates the use of an embodiment of the invention for coating an aircraft part subject to extreme wear, such as a landing gear or part thereof, such as a wheel 234 or its rim 232 or part 234 thereof. Furthermore, wheels of trains and/or train tracks, wheel rims and/or tires of automobiles, for instance, can be coated.

FIG. 55 illustrates the use of an embodiment of the invention for coating a window of a craft, especially an aircraft. The glass or window may be of a laminated material so that e.g. a polarizing layer 237 may be deposited thereon to reduce glare, but also e.g. a photocatalytic layer 236 to keep the glass clean. It is furthermore possible to fabricate layered glasses where a diamond layer 239, for instance, is deposited on the surface of the substrate 238, but a plastic layer 240 is laminated between the glasses.

FIG. 56 illustrates the use of an embodiment of the invention for producing a coating which may include a noble gas compound, for example. In this case, a carrier substance 401 is chosen, a dopant 402 is chosen, the carrier substance and/or dopant 403 is ablated, followed by deposition by plasma 404.

FIG. 57 illustrates a printer 500 according to an embodiment of the invention, which includes, for 3D printing, a target holder 501 to subject a surface of the target to a surface-shaping jet to its working depth, 502 means for producing a surface-shaping jet and/or a transmission line for directing the said surface-shaping jet to the target, means 503 for producing a second surface-shaping jet and/or a second transmission line for directing the said surface-shaping jet to a substrate, and a substrate holder 504 to subject a surface of the substrate to a second surface-shaping jet to its working depth.

FIG. 58 illustrates a copier according to an embodiment of the invention, including means 601 for generating information to determine the shape and/or proportions of a three-dimensional object and/or to store it in a file 602, means 603 for trans-forming the information into control commands to control a 3D printer unit 500 according , for example, to FIG. 56.

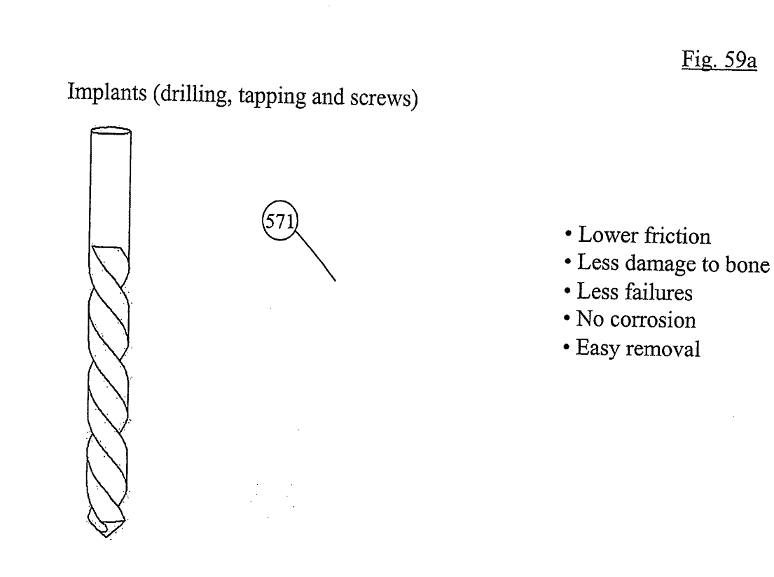

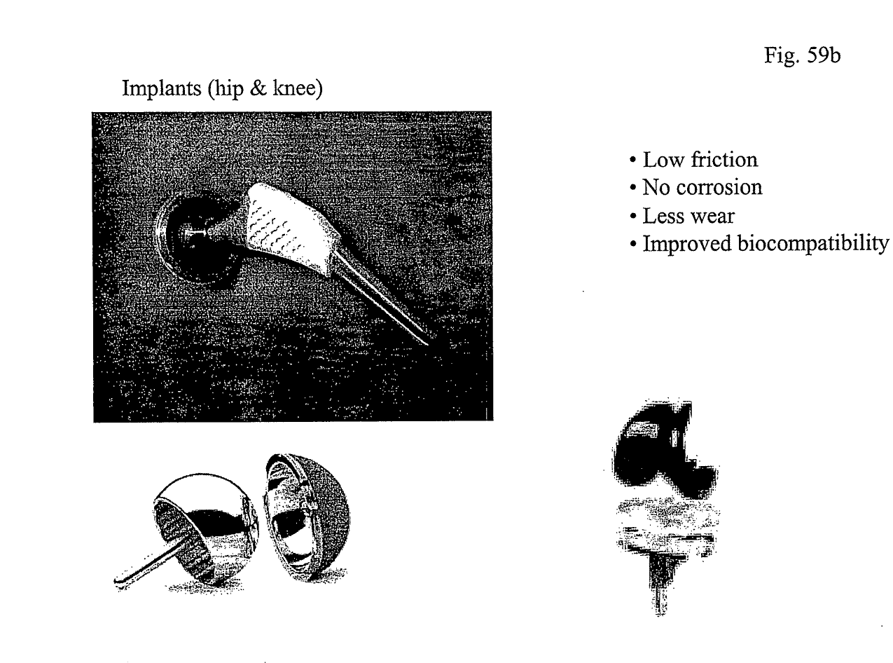

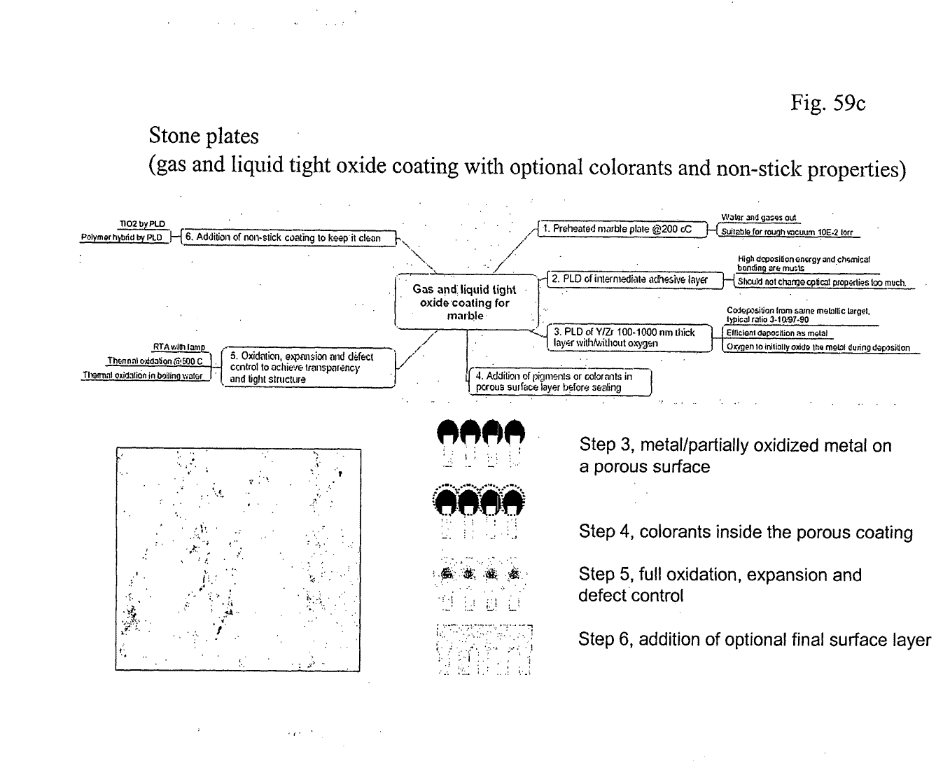

FIG. 59 illustrates a laser apparatus according to an embodiment of the invention, including a radiation source 701 for generating laser radiation to be used in ablation and a radiation transmission line 702 with a turbine scanner 703 to direct the said laser radiation to the portion 704 of the target to be ablated. The radiation source may be arranged in an embodiment of the invention to be comprised of more than one source of laser radiation, which sources are arranged so as to achieve ablation from a target.

### Example

The example deals with a laser apparatus according to FIG. 59. The apparatus can be used for deposition with metals, oxides, borides, nitrides, ceramics, or organic matter directly or in the work process creating new compounds such as oxides, nitrides etc. By combining base materials such as aluminum and oxygen one gets Al₂O₃ which can be then used for coating the work piece. In addition, it is possible to ablate e.g. noble gases to be used in ionized form in the carrier substance as suitable dopants and/or other components. The apparatus is also readily applicable in the production of diamond by directly vaporizing carbon. Furthermore, it is possible to fabricate diamond derivatives, such as nitride diamond which is harder than natural diamond, or other, completely new compounds, earlier impossible to produce, technically or commercially.

The apparatus is applicable to laserizations in the so-called cold ablation region, i.e. pico-, femto-, and attosecond systems, where the pulse power is very high, about 5 to 30 μJ per 30-nm spot, which means the pulse energy is as huge as 200 kW to 50 MW.

In laser ablation, great importance is set on the angle of the laser beam to the surface element of the material preform to be vaporized at the target, because it has an essential effect on the direction of the plasma cloud generated. Typically the material preform to be vaporized may also be round and, additionally, rotate around its central axis.

According to an embodiment of the invention the radiation transmitted is polarized. According to an embodiment of the invention the radiation transmitted is randomly polarized. According to an embodiment of the invention the radiation transmitted is linearly polarized. According to an embodiment of the invention the radiation is circularly polarized. According to an embodiment of the invention the radiation is elliptically polarized. According to an embodiment of the invention the polarization of radiation is left-handed polarization, but according to another embodiment of the invention the polarization is right-handed polarization. According to an embodiment of the invention the radiation transmission line is arranged so as to change the polarization. In that case the waveguide in the radiation transmission line is arranged for that purpose or it includes a part for that purpose.

According to an embodiment of the invention, radiation polarization controls the transformation of ablated material from the target work spot into plasma. If, in an embodiment of the invention, the radiation is photon laser radiation, the laser radiation source can be locked into a certain polarization mode to the keep the laser beam and, hence, the pulse power constant.

### Example to Demonstrate Known Art Problems

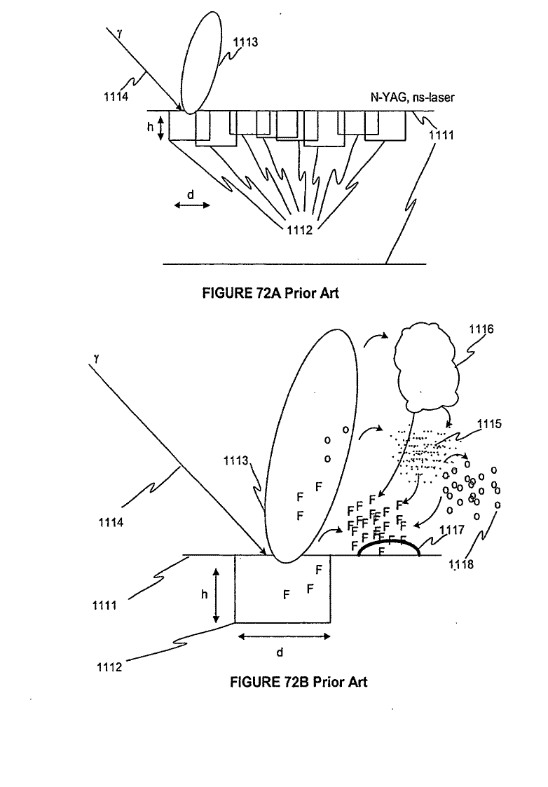

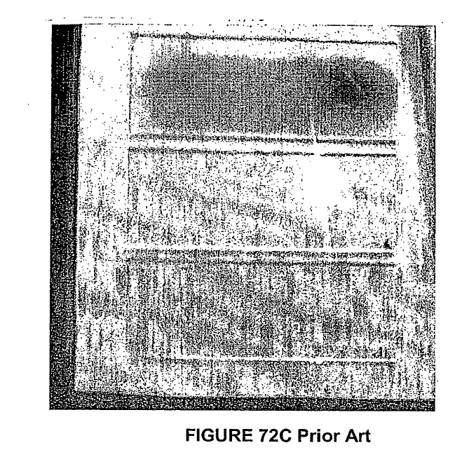

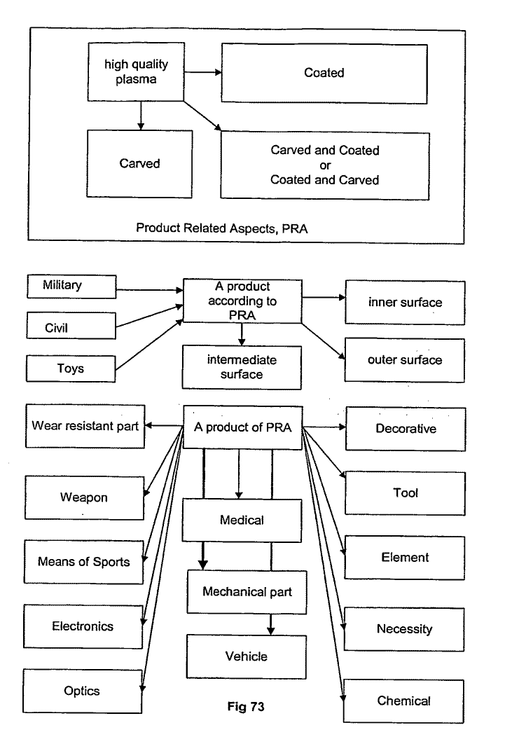

Plasma related quality problems are demonstrated in FIGS. 72A and 72B, which indicate plasma generation according to a known techniques. A laser pulse γ 1114 hits a target surface 1111. As the pulse is a long pulse, the depth h and the beam diameter d are of the same magnitude, as the heat of the pulse 1114 also heat the surface at the hit spot area, but also beneath the surface 1111 in deeper than the depth h. The structure experiences thermal shock and tensions are building, which while breaking, produce fragments illustrated F. As the plasma may be in the example quite poor in quality, there appears to be also molecules and clusters of them indicate by the small dots 1115, as in the relation to the reference by the numeral 1115 for the nuclei or clusters of similar structures, as formed from the gases 1116 demonstrated in the FIG. 72B. The letter “o”s demonstrate particles that can form and grow from the gases and/or via agglomeration. The released fragments may also grow by condensation and/or agglomeration, which is indicated by the curved arrows from the dots to Fs and from the os to the Fs. Curved arrows indicate also phase transitions from plasma 1113 to gas 1116 and further to particles 1115 and increased particles 1117 in size. As the ablation plume in FIG. 112B can comprise fragments F as well as particles built of the vapors and gases, because of the bad plasma production, the plasma is not continuous as plasma region, and thus variation of the quality may be met within a single pulse plume. Because of defects in composition and/or structure beneath the deepness h as well as the resulting variations of the deepness (FIG. 72A), the target surface 1111 in FIG. 112B is not any more available for a further ablations, and the target is wasted, although there were some material available.

FIG. 72C represents example on an ITO-coating (Indium-Tin-Oxide-) on polycarbonate sheet (˜100 mm×30 mm) produced by employing a prior art optical scanner, namely vibrating mirror (galvo-scanner), in different ITO thin-film thicknesses (30 nm, 60 nm and 90 nm). The picture clearly demonstrates some of the problems associated with employing vibrating mirror as an optical scanner especially in ultra short pulsed laser deposition (USPLD) but also in laser assisted coatings in general. As a vibrating mirror changes its direction of angular movement at its end positions, and due to moment inertia, the angular velocity of the mirror is not constant near to its end positions. Due to vibrating movement, the mirror continuously brakes up and stops before speeding up again, causing thus irregular treatment of the target material at the edges of the scanned area. This in turn results in low quality plasma (FIGS. 72A, B) comprising particles especially in the edges of the scanned area and finally, in low quality and seemingly uneven coating result. The coating parameters have been selected to demonstrate uneven distribution of ablated material due to the nature if the employed scanner if selecting parameters appropriately the film quality can be enhanced and the problems becoming unvisible but not excluded.

Such problems are common both with nano-second lasers in general, and present pico-second lasers if they were employing the state of the art scanners.

1-137. (canceled)

138. A surface treatment apparatus characterized in that it comprises in its radiation transmission line a turbine scanner arranged to scan a spot of surface-shaping jet on a target for enablement of cold ablation of the target material, for production of high quality plasma, from set spot up to a working depth from said target, wherein the apparatus further comprises a radiation source to achieve laser radiation to be used for the ablation as the surface-shaping jet.

139. A surface-treatment apparatus according to claim 138, characterized in that it further comprises for producing high quality plasma, in said apparatus:
means for producing a second surface-shaping jet,
means for guiding said second surface-shaping jet to a substrate, and
substrate holder for subjecting a surface, which is to be treated, to a second surface-shaping jet up to its working depth,
wherein said surface treatment apparatus is arranged to form the second surface-shaping jet from the high quality plasma to be produced from the target surface by the ablation.

140. A 3D-printer unit comprising a surface treatment apparatus according to claim 138.

141. A 3D printer unit according to claim 140, characterized in that for producing high quality plasma, said 3D printer unit further includes a means for controlling the printing of the resulting 3D piece slice by slice, the depth of slice corresponding to the working depth, by the said second surface-shaping jet, when it is a jet of matter,

142. A 3D copier, characterized in that
for producing high quality plasma, said copier comprises a 3D printer unit according to claim 140,
said copier comprises means for producing data for determining the shape and/or proportions of a three-dimensional object and/or storing them in a file,
said copier comprises means for transforming data into control commands for controlling a 3D printer unit, arranged to enable producing high quality plasma according to the shape and/or proportions of said three-dimensional object to be copied.

143. A 3D copier according to claim 142, characterized in that in it said means for producing data for determining the shape and/or proportions of a three-dimensional object and/or storing them in a file are optical means, x-ray tomographic means, and/or acoustic means.

144. A surface-treatment method, characterized in that the method comprises:
arranging an object with the target surface into to reach of a surface treatment apparatus for changing a property of the surface by means of a surface-shaping jet directed to the surface at the working depth thereof,
directing the surface-shaping jet to the target surface, and
ablating material by a surface treatment apparatus for producing high quality plasma, from the object surface serving as a target, in order to change a property of the surface by means of the surface-shaping jet at the working depth thereof.

145. A surface-treatment method according to claim 144, characterized in that the said property is the composition and/or structure of the surface at the said working depth.

146. A surface-treatment method according to claim 144, characterized in that the method comprises additionally:
arranging a substrate having a second surface into a reach of a surface treatment apparatus,
forming a second surface shaping jet, from the produced high quality plasma, for the ablated target material to be deposited onto the said second surface by means of the second surface-shaping jet to form a layer as the working depth of the second surface shaping jet.

147. A surface treatment method according to claim 144 characterized in that in the method, said first surface shaping jet is implemented by such a pulsed laser that is capable to a cold ablation, and that the laser has at least one component the wavelength of which falls into the radio frequency range, infrared range, visible light range, ultraviolet range, X-ray range.

148. A surface treatment method according to claim 144, characterized in that in the method, each pulse has a predetermined energy, amplitude, duration, waveform, and/or temporal distance to the next pulse.

149. A method according to claim 14S, characterized in that in the method, the radiation of the pulsed laser is guided by a guidance equipment comprising at least one of the following: waveguide, beam expander, beam compressor, prism, lens, mirror.

150. A surface treatment method according to claim 144, characterized in that for producing high quality plasma, the method comprises:
collecting, material particles detached from the target in solid and/or liquid phase on to a collecting surface by means of an oppositely charged electric field.

151. Use of a turbine scanner in a cold ablation, characterized in that during the use of the turbine scanner, it is utilized in a radiation transmission line of a surface treatment apparatus for cold ablation for producing high quality plasma.

152. A method for producing a coating, characterized in that it comprises a. surface treatment method according to claim 144, and that the method comprises depositing accordingly a first substance and at least a second substance on a surface of a substrate.

153. A method for producing a coating according to claim 152, characterized in that for producing high quality plasma for said coating, in said method, said first and second substances are ablated essentially from the same work spot.

154. A method for producing a coating according to claim 152, characterized in that for producing high quality plasma for said coating, in said method, said first and second substances are ablated essentially from different work spots.

155. A method for producing a coating according to claim 152, characterized in that for producing high quality plasma for said coating, in said method, in addition to those mentioned, at least one other substance is ablated.

156. A method for producing a coating according to claim 152, characterized in that for producing high quality plasma for said coating, the method comprises at least one of the following:
arranging one of the said substances as to a carrier substance for the coating,
arranging one of the said substances as to a dopant of the carrier substance for the coating,
arranging one of the said substances as to a coating additive to achieve a certain extra property for the coating.

157. A method for producing a coating according to claim 152, characterized in that for producing high quality plasma for said coating, the method comprises at least on of the following;
arranging the coating produced to comprise carbon,
arranging a doping into the coating so that the substance to be doped contains at least one of the following:
uranium, an earth metal, a transition element, a lanthanide and/or a noble gas,
alkali metals or hydrogen;
a substance belonging to alkali earths,
a substance belonging to the boron family (IIIb),
a substance belonging to the carbon family (IVb),
a substance belonging to the nitrogen family (Vb),
a substance belonging to the oxygen family (VIb), and
a substance belonging to the halogen family (VIIb).

158. A method according to claim 157, characterized in that, the carbon is in the form of graphite.

159. A method according to claim 157, characterized in that the carbon is in the form of diamond.

160. A method according to claim 159, characterized in that the diamond is monocrystalline.

161. The use of a surface treatment method according to claim 144, wherein the object is at least one of the following: the hull and/or cladding structure of an aircraft, ship, submarine, vehicle or spacecraft, an engine part thereof, tool, a part of a tool, a piece of furniture, a household, industrial fixture, kitchen utensil, a cooking vessel, a reaction vessel, a chemical reactor, transmission line for transmission of a substance, glass plate for a window, a solar cell, a combination of the glass plate and a solar cell, a construction element of a building, a construction element of natural material for a building, a clock/watch, mobile communications device, PDA, computer, display, or the case or some other part of any one of those mentioned, structure based on fiber, threat to fabricate a textile, optical fiber, optical diamond fiber, optical fiber that has a different composition as the coating, fiber filter textile, an industrial fabric, fabric to manufacture a piece of clothing or the like, a piece of sports equipment, a racket, equipment used in skiing, equipment used in slalom, equipment used in snowboarding, equipment used in skating, equipment used in sledding, sports equipment to be thrown, sports equipment to be slid, sports equipment to be rolled, a bicycle, bicycle frame, bicycle chain, bicycle bearing, other part of a bicycle, a decorative piece, a piece of jewelry, an object of art, a copy thereof, micromechanical element, semiconductor, an electrical insulator, a thermal conductor for conducting heat from a source of heat for cooling purpose, an object to be coated with a thermal insulator, spare part of a man, spare part of an animal, spare part comprising a joint surface, rivet as spare part, a means of attachment as a spare part, a rivet as a spare part, screw as a spare part, nut as a spare part, nail as spare part; a part of a radiation transmission line, a radiation transmission line, paper having a product form in sheets, paper having a product form in web, plastic film having a product form in sheets, plastic film having a product form in reel, optical element, lens, window, plate, prism, filter, a mirror, spectacles, security means, payment means, a dish, set of dishes, container for storing substance, hydrogen cell for storing hydrogen, hydrogen cell for discharging hydrogen cell for storing and releasing hydrogen, a hydrocarbon cell for storing hydrocarbon, a nuclear fuel element, part of a nuclear fuel element, toy, part of a toy, a substrate to be coated with an UV-active coating.
